(19) United States
(12) Patent Application Publication
(10) Pub. No.: US 2004/0199456 A1
(43) Pub. Date: Oct. 7, 2004

(54) Method and apparatus for explaining credit scores

(76) Inventors: Andrew Flint, New York, NY (US); Dale Lear, Austin, TX (US); Cheri St. John, Petaluma, CA (US)

Correspondence Address: GLENN PATENT GROUP, 3475 EDISON WAY, SUITE L, MENLO PARK, CA, 94025, US

(21) Appl. No.: 09/790,453

(22) Filed: Feb. 22, 2001

Related U.S. Application Data
(60) Provisional application No. 60/222,205, filed on Aug. 1, 2000.

(51) Int. Cl. G06F 17/60

(52) U.S. Cl. 705/38

(57) ABSTRACT

A Web site is provided that contains an array of informative resources including for-pay services and extranet functions to serve consumers and traditional players in the financial services industry, including financial counselors, mortgage brokers, direct lenders, large national credit issuers, and third-party credit report re-sellers, plus information seekers such as the press, consumer groups, and government agencies. A primary focus is to educate consumers, consumer groups, and the consumer press by offering them access to the exceptionally high-quality information, both general and personal, about the practices of collection, storing, reporting, and evaluating consumer credit data.

### BACKGROUND OF THE INVENTION

1. Technical Field

The invention relates to credit scoring. More particularly, the invention relates to a method and apparatus for explaining credit scores.

2. Description of the Prior Art

Recent events have made it desirable for developers of credit scoring algorithms, such as Fair, Isaac and Company, Inc. of San Rafael, Calif. to move toward offering a service to deliver credit bureau risk scores and explanations directly to consumers and lenders. Consumer advocacy groups and credit counseling organizations have provided positive feedback on these announced intentions. Additionally, credit scoring developers clients, i.e. the credit grantors themselves, have expressed their understanding of the need to pursue this undertaking. Most organizations are comfortable that each credit scoring developer, such as Fair, Isaac, is the only entity in the market that can actively take on the role of credit score delivery and explanation.

A comprehensive score delivery and explanation service should include all of the following pieces:

1. Credit scores delivered to consumers.

2. The primary reason codes that describe why the score was not higher.

3. The consumer's credit bureau report from which the score was calculated to allow them to cross-reference the information with his/her actual credit report.

4. A personalized score explanation that describes to that consumer, in plain language, how their individual score was derived. This explanation service can be further enhanced using data elements present in the consumer's credit report.

Given the desirability of providing such information to consumers, it would be advantageous to provide a method and apparatus for explaining credit scores.

### SUMMARY OF THE INVENTION

The preferred embodiment of the invention provides a Web site containing an array of informative resources including for-pay services and extranet functions to serve consumers and traditional players in the financial services industry, including financial counselors, mortgage brokers, direct lenders, large national credit issuers, and third-party credit report re-sellers, plus information seekers such as the press, consumer groups, and government agencies. A primary focus is to educate consumers, consumer groups, and the consumer press by offering them access to the exceptionally high-quality information, both general and personal, about the practices of collection, storing, reporting, and evaluating consumer credit data.

### BRIEF DESCRIPTION OF THE DRAWINGS

FIG. 1 is a block schematic diagram showing targeted users, access and entry points, and services provided by myFICO.com according to the invention;

FIGS. 2a-2d are display screens showing a new member introduction for a credit score explanation service according to the invention;

FIGS. 3a-3f are display screens showing a new member signup for a credit score explanation service according to the invention;

FIG. 4 is a display screen showing a credit score explanation request in a credit score explanation service according to the invention;

FIG. 5 is a display screen showing a confirmation for a credit score explanation request in a credit score explanation service according to the invention;

FIG. 6 is an example which illustrates several of the pre-processing needs for reason codes according to the invention; and

FIGS. 7a-7d are display screens which include a graph showing a consumer's credit score relative to the national population according to the invention.

### DETAILED DESCRIPTION OF THE INVENTION

The herein described credit score explanation service may be implemented in any of several embodiments, as are described herein. The preferred embodiment of the invention provides a Web site containing an array of informative resources including for-pay services and extranet functions to serve consumers and traditional players in the financial services industry, including financial counselors, mortgage brokers, direct lenders, large national credit issuers, and third-party credit report re-sellers, plus information seekers such as the press, consumer groups, and government agencies. A primary focus is to educate consumers, consumer groups, and the consumer press by offering them access to the exceptionally high-quality information, both general and personal, about the practices of collection, storing, reporting, and evaluating consumer credit data.

The working title of the Fair, Isaac and Company (FICO) Web presence is myFICO (myfico.com) because the most visible elements of the service are aimed directly at consumers who want to learn about their own FICO score.

Although the on-demand receipt of FICO scores is thought to be the primary draw to the site (based on consumer interest and press coverage), the invention also offers access to additional valuable services, such as registration in an opt-in/opt-out database, the ability to initiate requests for credit investigations, the ability to link to consumer credit counseling services should scores be low and represent high risk, and the ability to access multiple reports from different repositories upon request. These services heighten the level of consumer education, and also offer individuals access to information, actions, and preferences they have not had previously.

An additional benefit is to use myFICO.com to supply the consumer with their score and if that score is sufficient to pass the cutoff scores of specific brokers or lenders, the credit scoring developer can pass the consumer's name, application, and credit score on to the lender for consideration. The invention allows the credit scoring developer to build broker networks to refer these applicants to lenders who would approve them. The credit scoring developer can also link the applicants' email address to credit companies who wish to pre-approve and solicit these consumers based on score. This is a much more cost effective origination process (via email) than direct mail today.

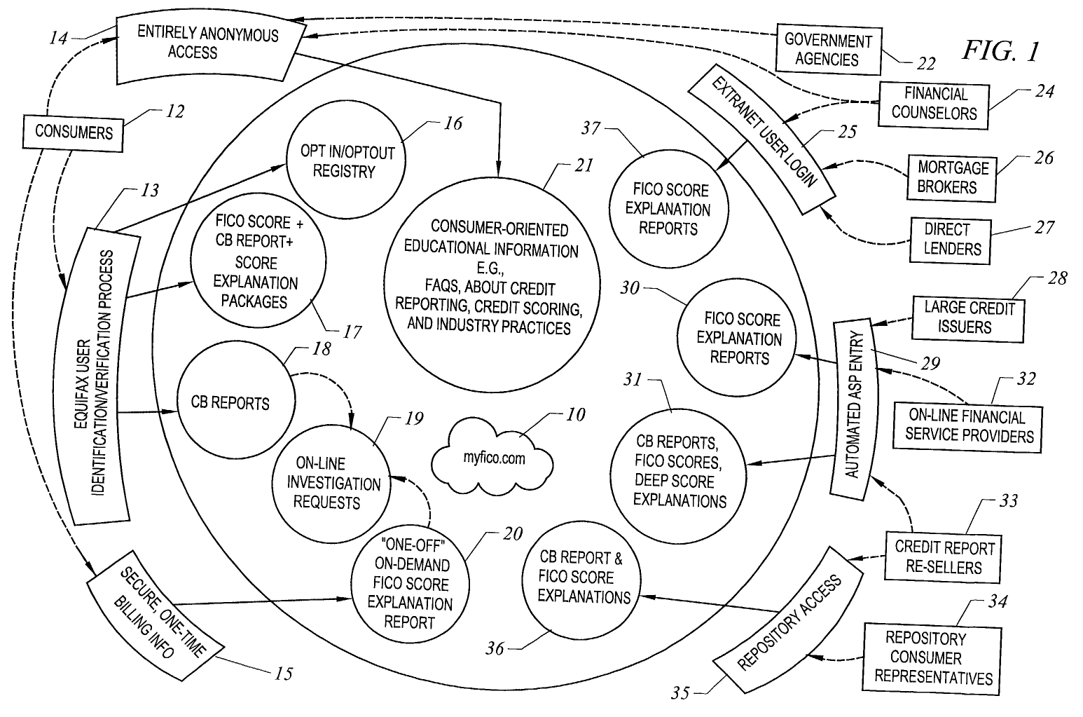

FIG. 1 is a block schematic diagram showing targeted users, access and entry points, and services provided by myFICO.com 10. Access by consumers 12 may be through a credit reporting agency 13, using an identification verification process to access credit score reports 17, for opt-in/opt-out requests 16, to access a report service 18, and to initiated on line investigations 19; through a secure, one time connection 15 for one-off credit score reports 20; or through an entirely anonymous access method 14 (the latter also allows access by government agencies 22) for consumer oriented information 21. The invention also provides an extranet logon facility 25 to credit score reports 37 for such users as financial counselors 24, mortgage brokers 26, and direct lenders 27; an automated application service provider entry 29 to credit score reports 30 and other reports 31 for such users as large credit issuers 28, on line financial service providers 32, and credit report resellers 33; and repository access 35 to credit score reports and other reports 36 for repository consumer representatives 34 and credit report resellers 33.

Score Explanation Service

A first embodiment of a Web-based score explanation service requires only the, credit bureau identifier, credit score and up to four reason codes as input. A proprietary algorithm is used to provide an explanation of the primary factors influencing the score. This algorithm can be enhanced depending upon the amount of input data available although the use of the enhanced algorithm itself is optional and not considered to be a key element of the subject invention. Accordingly, one skilled in the art may substitute any appropriate mechanism for explaining credit score results, such as selecting reason codes based upon the credit score range and reason codes supplied with the credit report. In addition, the system furnishes suggestions about how the individual's credit standing can be improved over time. The result of the service is an explanation report that is provided to the requester over the Web.

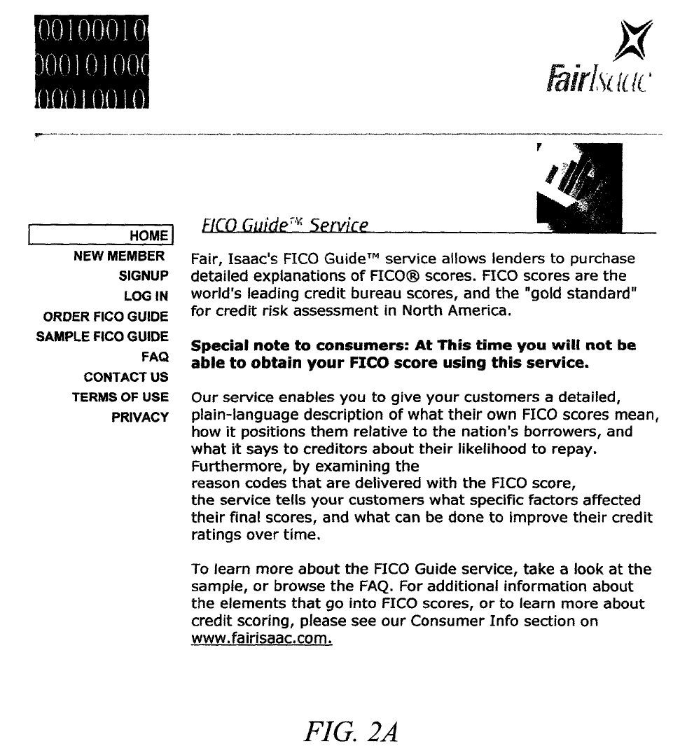

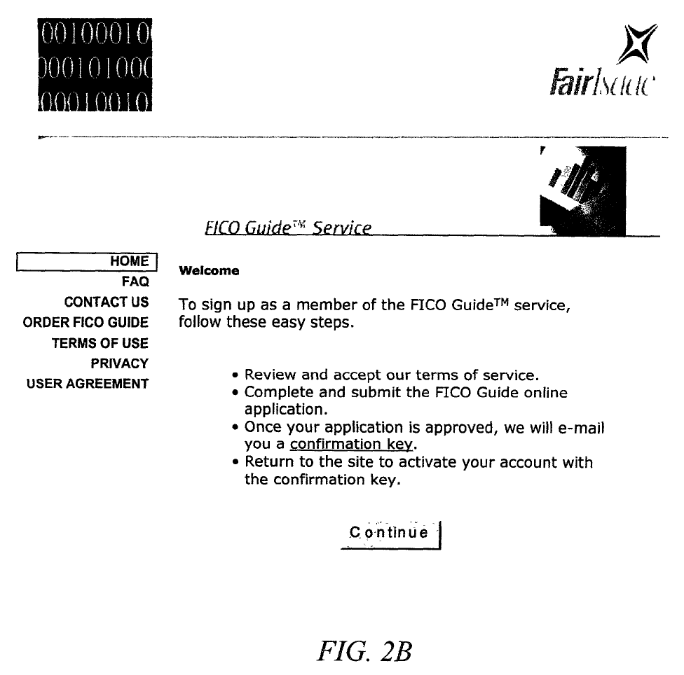

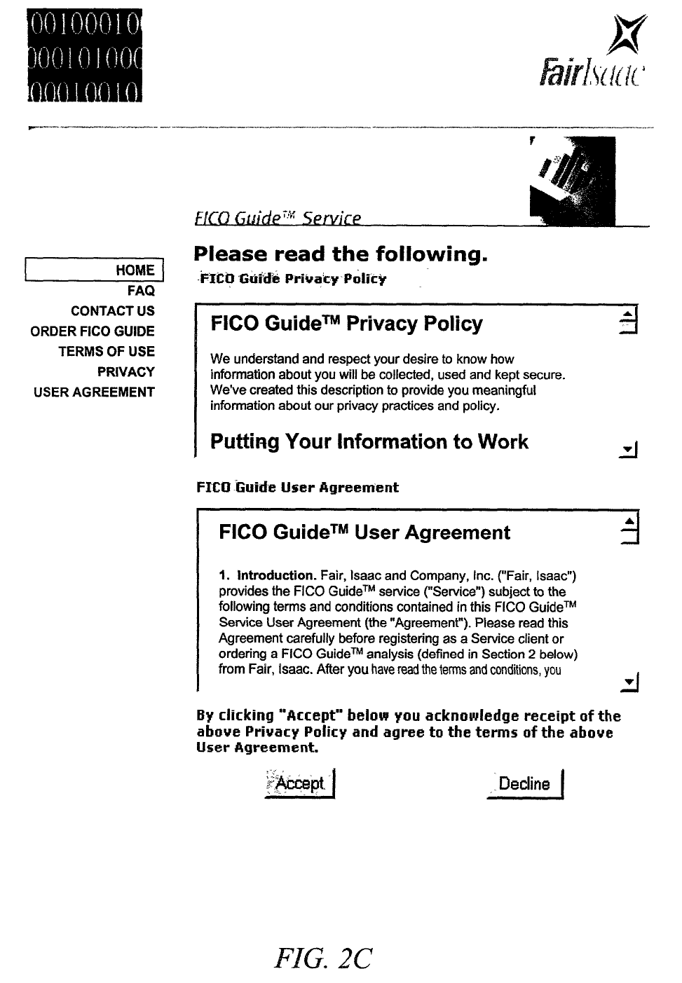

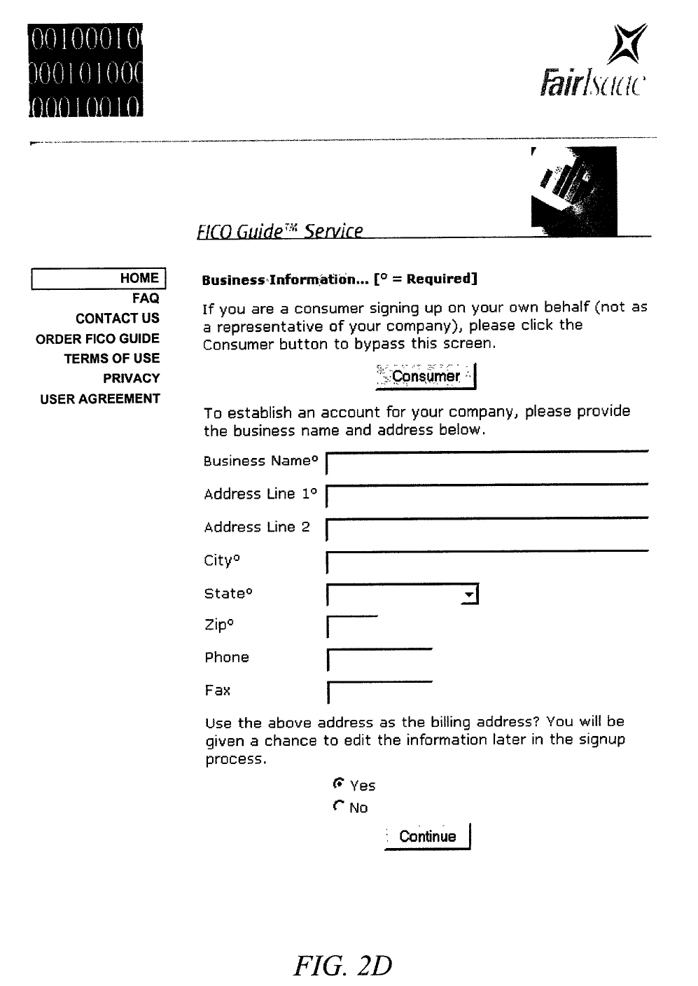

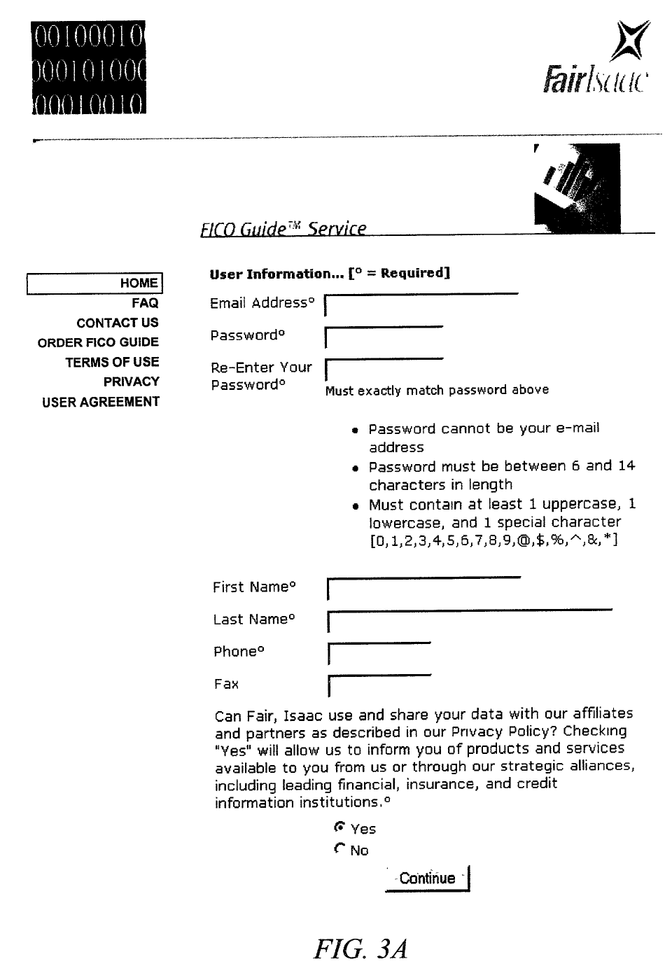

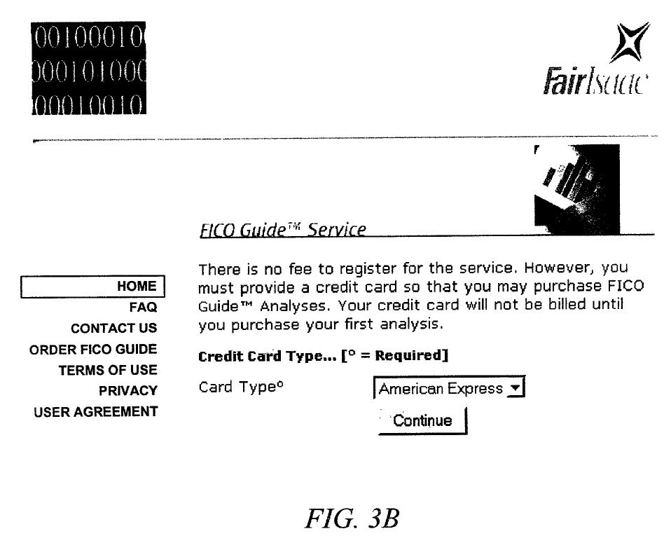

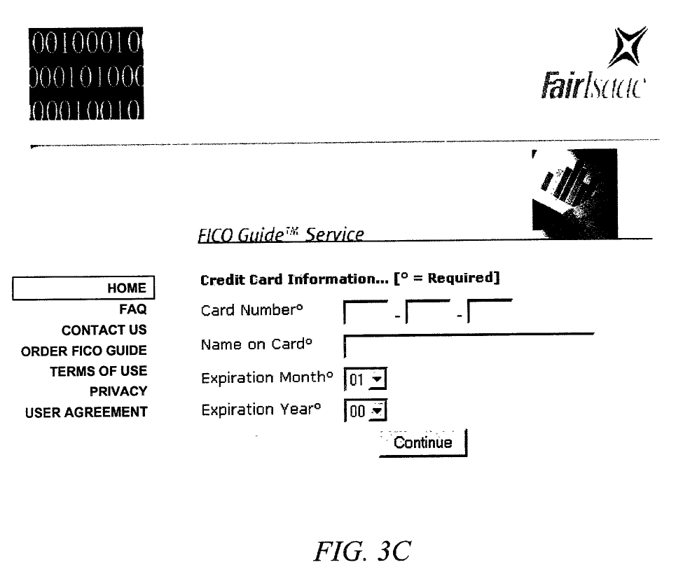

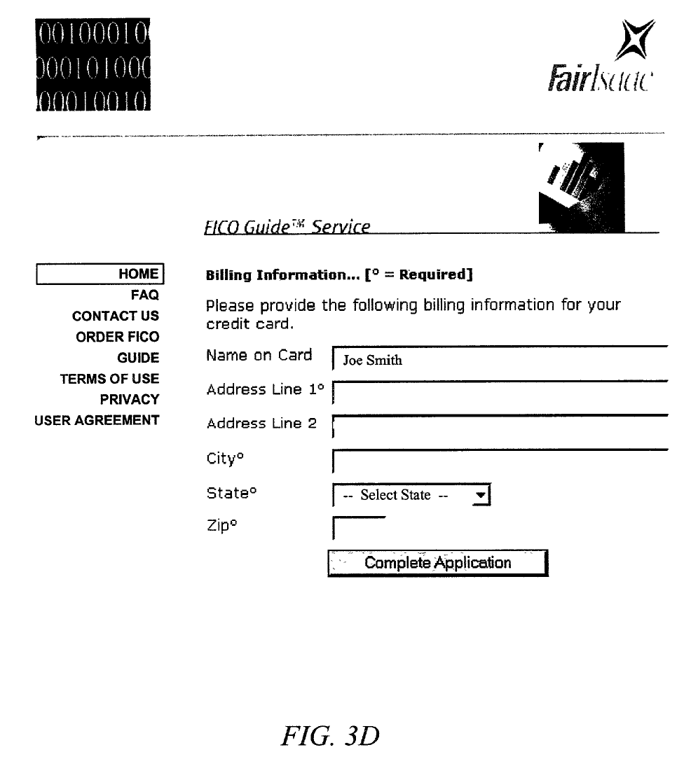

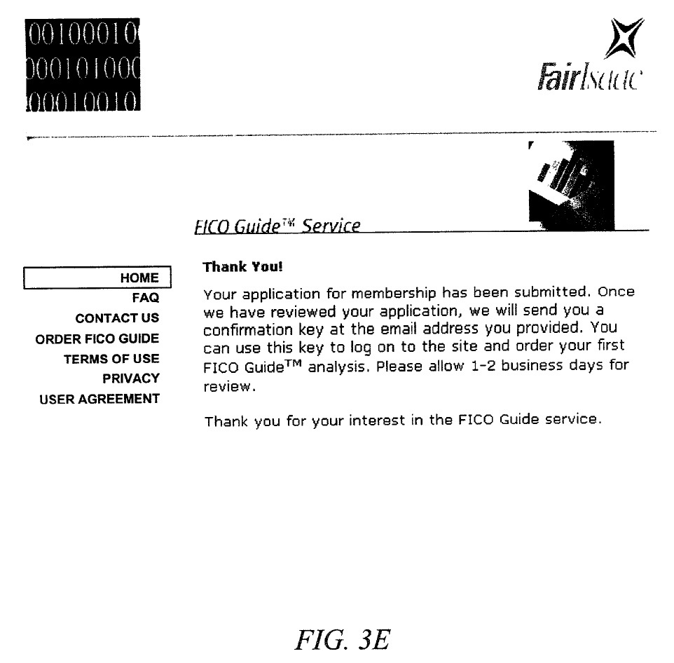

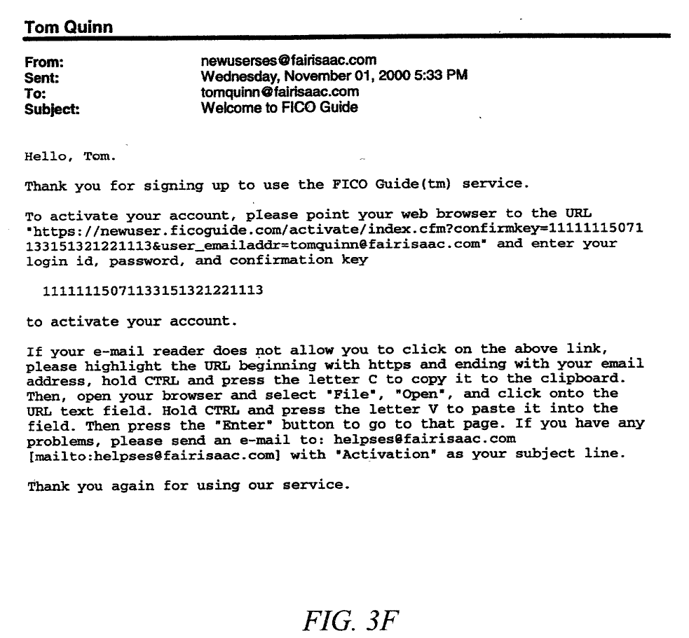

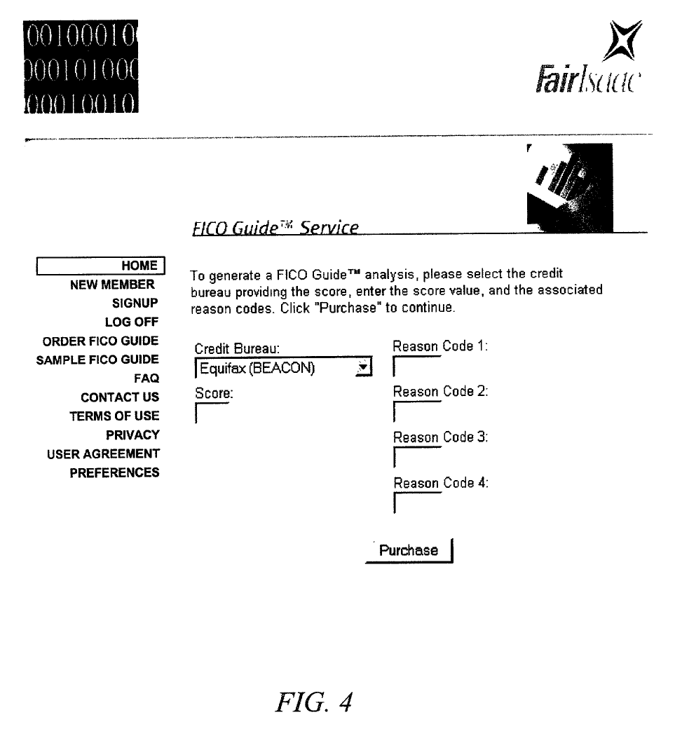

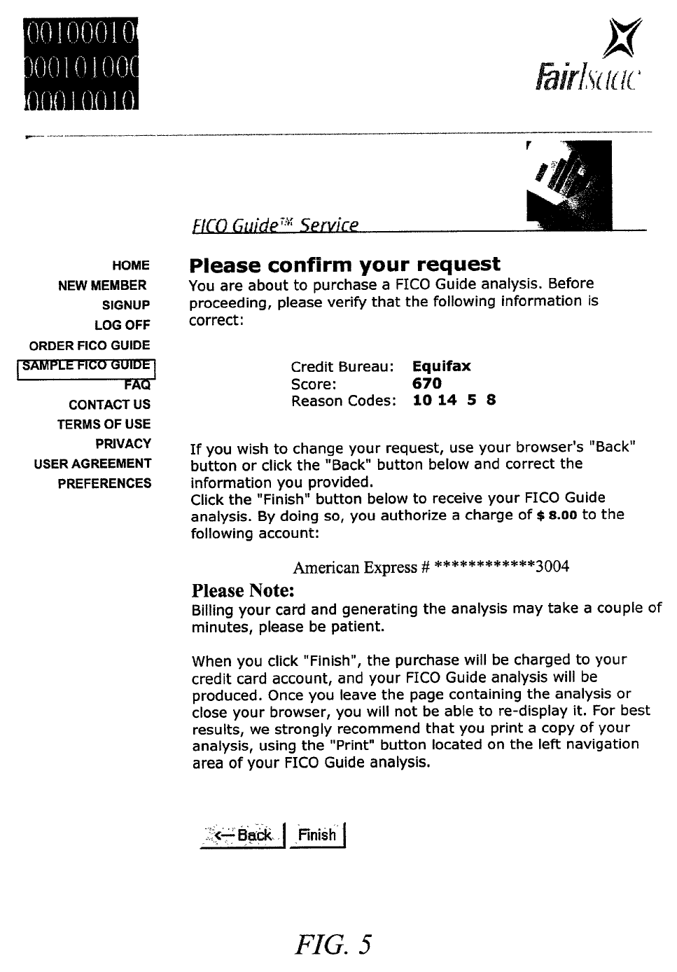

FIGS. 2a-2d are display screens showing a new member introduction for a credit score explanation service according to the invention; FIGS. 3a-3f are display screens showing a new member signup for a credit score explanation service according to the invention; FIG. 4 is a display screen showing a credit score explanation request in a credit score explanation service according to the invention; and FIG. 5 is a display screen showing a confirmation for a credit score explanation request in a credit score explanation service according to the invention. An example of a credit score explanation report is provided below.

The target audience for the score explanation service is lenders and brokers, although consumers who have been provided their score plus the reason codes by a broker can access it directly as well.

Enhanced Score Explanations

To enhance the richness of the explanation contained in the report, additional information is required. A credit bureau risk score development database is used to develop benchmark characteristics, and to enhance further the explanation algorithm. These characteristics (score and other credit report attributes) provide a national/regional basis upon which to compare individual score and attribute information. The requester of the explanation service is better served if the information provided in the explanation is pertinent to the individual versus general information. To the degree that individualized analysis data and recommendations are provided the value of the service offering is enhanced through the use of an enhanced algorithm.

Score, Report, and Explanation Delivery Service

This offering is targeted directly to the end consumer. This is a bundled service offering providing the credit score, the credit report from which the score was calculated, and a score explanation service. The explanation is further enhanced, using an enhanced algorithm to identify the specific information on the consumer credit profile that gave rise to the score and provides more precise actions for improving the credit risk profile and the credit score over time.

Score, Report, and Explanation Delivery Service From Multiple Credit Reports

This offering is targeted directly to the end consumer, most probably contemplating or in the midst of a mortgage shopping experience where multiple bureau reports and scores are accessed by lenders. This is a bundled service offering providing the credit score from all credit repositories, the credit reports from all credit repositories, and score explanations for all three scores. This also includes a discussion about why the scores are different across credit repositories and (optionally) the sources of those differences.

Enhancements

Other services, such as registration in the opt-in/opt-out lists, on-line requests to initiate investigations of credit report data elements, links to consumer credit counseling or to lenders are provided as enhancements of the offering. Also, explanations and delivery of other credit bureau scores, including insurance bureau scores, and even other developer scores can be included.

Access

Access to the service is preferably through the Web and preferably through a dedicated site, such as the Fair, Isaac Web site myFICO.com.

Users of the Service

This service is preferably offered to the financial services and direct to consumer markets, including:

Lenders;

Consumers;

Other Credit Repositories; and

Third Party Distribution Channel (e-ports and brokers).

Lenders subscribe to the service by accessing a Web site and entering credit bureau identifier, score and reason code information and receiving a credit score explanation. In other embodiments of the invention, the credit score, reason codes, and the underlying credit report upon which the score was calculated must be transmitted to a Web site, such as myFICO.com. The Web site has an agency agreement with the lender providing permissible purpose to access the consumer file.

Benefits to lenders include:

1) institutions are able to use the score explanation as a means of providing and supporting score disclosure if and when mandated by law; and

2) lenders are able to use the score explanation service as a means of differentiating their service/product offering from that of their competitors.

Consumers have access to a unique offering that includes the credit score, the reason codes, and an individualized score explanation assessment with copies of one or multiple credit reports or credit profiles. An explanation of the credit report may also be incorporated into the delivery package, as could other additional services. Offerings such as annual consumer score update services, providing periodic score updates and or updates when new trade lines appear on the file or the appearance of excessive inquiries in a short period of time, or a fraud alert process may be included. The invention could also provide a multiple bureau solution.

Credit data repositories may also wish to avail themselves of the score explanation service to support legislative or self imposed credit score disclosure efforts. The credit data repositories should access the service provider's Web site, e.g. myFICO.com, for this service. This solution is likely to satisfy most consumer demand and reduce the talk time between consumer assistance staff and consumers on score explanation issues.

Third party distribution channel (e-port and broker) partners can also be pursued. Many of these e-sites can serve as extended distribution channels reaching much deeper more quickly into the Web than the credit reporting agency or credit scoring developer might on their own. The invention provides a way to qualify a selected number of distribution partners and have them push the score delivery and explanation service out to other Web sites through their affiliation networks. Again, the method of access requires linking to the credit scoring delivery Web site. The third party distribution channel partner might also need to provide the score and credit report as input to the Web site to enable explanation, again in an acceptable system-to-system format. It is considered preferable not to allow distribution partners to store any of the information passed back to them as it is for the exclusive use of the consumer for whom it was obtained.

Critical System Needs

To construct such a site, the following technologies and abilities are required by the endeavor:

A system for verifying an individual's identity prior to their request for a credit report and credit score to prevent fraudulent use of the services (security interface).

A payment processing function.

Fast access to the credit file and score.

A reason code pop-up menu to help the user identify the coding associated with the text-labeled reasons provided.

A body of consumer support representatives, to respond individually to consumer questions about their credit reports and credit scores, i.e. overflow from the Web-based solution and because not all transactions can be handled by a Web-based interface.

Software to construct and present the score explanation for the user.

Delivery of the actual credit report used to calculate the credit score in a CPU-to-CPU format to additional software for examining and explaining the score with greater precision.

A critical element of successfully building such a service is to protect against fraudulent attempts to access individual credit reports. Beyond ID verification, the system must use a secure data protocol, such as HTTPS, and the database of consumer information must be well protected behind firewalls.

Process Score Explanation Inputs and Presentation of Output

This is a very high-level description of the basic operation of the score explanation service.

1. Pre-process user-supplied inputs (see below).

2. Verify input data (see below).

3. If there are errors or warnings, return messages to user along with pre-filled form, containing their post-pre-processed responses.

4. If no warnings or errors are detected, proceed to step 6.

5. If no errors are detected, but warnings are produced, e.g. unusually high or low score or fewer than two reason codes, present the warning messages on the data entry screen, offering the user a chance to revise entries. If the user re-submits the form and the same warnings would repeat, i.e. the user wishes to bypass the warnings, allow them to do so, by proceeding to step 6.

6. Present a checkout screen to the user. This should reiterate their inputs in canonized, non-editable form, detail the charge for the service, display the name and partial account number of the credit card to be charged, and a generate report (or purchase) button.

7. When the user hits the purchase button, pass all verified, canonized user input fields and calculated fields to explanation generation functions, which returns the report in a browser window (potentially, a new target window).

8. Present the user with reasonable next step options, e.g. request another report, close the window, go to the score explainer home page, go to the score explainer help/FAQ page, go to the credit scoring developer's home page.

Contents of User-Visible Input Data Stream

The data entry screen takes the following inputs:

a) Bureau/Score, e.g. Equifax/BEACON or Experian/Experian/Fair, Isaac Model, or TU/EMPIRICA, [pull-down menu, initial state blank]

b) Score, e.g. 712, [field width=3]

c) Reason Code 1, e.g. 22, 10, or X, [field width=3]

d) Reason Code 2 [field width=3]

e) Reason Code 3 [field width=3]

f) Reason Code 4 [field width=3]

Pre-Processing of User-Supplied Inputs

In the following discussion, the letter in brackets [ ] refer to the contents of the user-visible input data stream described above.

Strip leading zeros and any blanks from Score [a].

Strip leading zeros and any blanks from reason codes [c-f]. If the arguments consists of digits, canonize to a two-byte, leading zero format. For example, 7 becomes 07, 022 becomes 22, 14 becomes 14, and 003 becomes 03. If the arguments are alphabetic, stripping leading and trailing blanks produces a single-byte character; also, convert to uppercase. For example, <space>X<space>becomes X, and <space><space>k becomes K.

Left-justify the array of Reason Codes [c-f]. Migrate, without permuting their order, non-blank responses upward, shifting blank values to the end of the array, as demonstrated below. For example, if codes 1, 2, and 4 are entered, but 3 is blank, swap the values in 3 and 4, resulting in 1, 2, and 3 having non-blank entries, and field 4 containing the blank. Or if 1, 2, and 3 are blank, but 4 is non-blank, move the non-blank value to field 1, and blank out field 4.

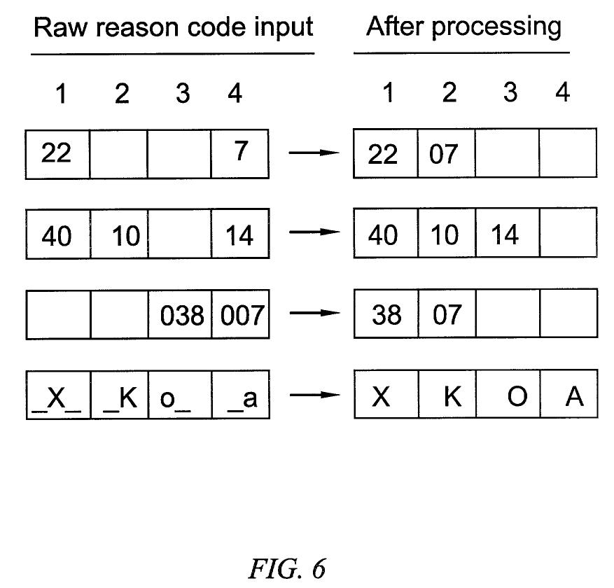

FIG. 6 is an example which illustrates several of the pre-processing needs for reason codes.

In the example of FIG. 2, compute the number of non-blank reason codes. The functions which assemble the score explanation report depend in part on this value. It should be one of {0,1,2,3,4}.

Determine the access mode of the incoming request. The functions which assemble the score explanation report depend in part on this value. If from the data entry screen of a web browser, set Access Mode to H (by-hand entry). If the service is accessed via a system-to-system request, set Access Mode to S. The latter option is intended only for the application service provider mode of this service.

Audit Logic for Score Explanation Primary Data Entry Screen.

When a user submits the form for processing, the following rules should be applied. In the event of inappropriate entry, the interface should provide a textual response, as indicated. If possible, the partially completed form should be presented to the user with specific errors or warnings adjacent to the appropriate field. Unless otherwise noted as a WARNING, exceptions to each rule below constitute an error that should prevent the user from reaching the checkout screen. Warnings, by contrast, having been delivered once, can be overridden the second time.

Validation Rules:

1. HTTP_REFERRER (IP number or domain name of the page containing the form just submitted) must be a member of list Valid Hosts.

2. Login state == verified user, i.e. they have logged in with username/password).

3. Score [a] is non-blank, numeric, and within range Low Score to High Score.

4. Score is within Typical Range. [WARNING]

5. Bureau ID [b] is non-blank, and one of three possible values (1, 2, or 3).

6. Number of non-blank Reason Codes is 2, 3, or 4. [WARNING]

7. Reason Code 1 [c] is blank, or a member of All Codes in Use.

8. Reason Code 2 [d] is blank, or a member of Possible Codes 2-4.

9. Reason Code 3 [e] is blank, or a member of Possible Codes 2-4.

10. Reason Code 4 [f] is blank, or a member of Possible Codes 2-4.

11. No two non-blank Reason Codes [c-f] are allowed to be identical.

12. All Reason Codes [c-f] must be two digits (consecutive numerics or alpha numeric combination), or be one-byte alphabetic codes. Mixing, for example, 22, 07, and 10 with X is not permitted.

In event of validation failures, return following messages:

1. (Unauthorized access/access denied page.)

2. (Unauthorized access/access denied page.)

3. Please enter a score between Low Score and High Score.

4. [WARNING] Most consumers score in the range Typical Range. The score you have entered is possible, but unusually high or low. Please confirm that you have not mistyped the score before requesting an explanation report.

5. Please select a bureau from the pull-down menu.

6. [WARNING] You have entered fewer than two reason codes, which is exceptionally rare for all but the very highest scoring borrowers. Please ensure that you have entered all the reason codes that were returned with the score, in the proper order. The score explanation report will be inaccurate without all of the reason codes. See the FAQ for more information.

7. Not a valid reason code.

8. Not a valid reason code.

9. Not a valid reason code.

10. Not a valid reason code.

11. Reason codes may not be repeated.

12. Reason codes should be either all numeric or all alphabetic

Transaction Data to be Stored

Each time a user hits the submit button on the checkout screen, a transaction entry should be added to the transactions table. Each transaction record should include:

1. Transaction ID (a unique system-generated key)

2. User session ID (if the Web server makes one readily available)

3. Date and time of transaction

4. User ID (presumably, login name, or unique user ID #)

5. Users host domain name or IP address

6. HTTP_REFERRER (URL of page containing the submitted form)

7. Browser identification (MSIE, Mozilla, AOL; v2, v3, v4, v5, etc.; Mac/PC)

8. Access mode (one of {H,S}, where H=entered by hand, S=system-to-system)

9. Transaction status code (0 if successful, one of 1-99 as appropriate by exception numbers listed above)

10. core [1]

11. Bureau ID [2]

12. Reason Code 1[3]

13. Reason Code 2[4]

14. Reason Code 3[5].

15. Reason Code 4[6]

Appendices (Data Dictionary, Lists)

Valid Hosts

fairisaac.com

<score delivery partner(s) are added to this list>

Low Score, High Score, Typical Range

Low Score=250

High=950

Typical Range=300-850

All Codes in Use

Note that there are four different lists: one for TransUnion, another for Equifax, and two for Experian (one alpha, one numeric). Bureau ID is the key to look on the correct list.

Possible Codes 2-4

All Codes in Use, minus the following entries

22, 38, 39, 40

Note: these four codes are identical for Experian, Equifax, and TransUnion (there are a small number of codes that do not have the same meaning across the bureaus). By design, these codes, when applicable, are always returned as the first reason with the (classic) FICO scores. If 22, 38, 39, or 40 appears as the second, third, of fourth codes, something was incorrectly entered or incorrectly presented to the user.

### Table A. Score Explanation Report

Note: The score explanation report below is an example of credit score explanation report that is generated by the invention. It includes statements reflecting the frequency of specific reason codes, plus other benchmarks such as the references to how much a score might be raised in light of a specific reason code being cited with the score, in anticipation of a credit reporting agency's cooperation in using the development datasets for this more detailed and personalized explanation.

Score Explanation Report Jul. 31, 2000

Credit score: 648

Source of score: Equifax (BEACON)

Reason codes: 40, 10, 14, 13

Your BEACON score: 648

The information in your Equifax credit report has been summarized in a BEACON score of 648. Most U.S. consumers score between 580 and 800. Compared to the national average, you are in the 27th percentile of consumers by credit risk. Although every lender has its own strategies, policies, and target markets, this score suggests that you should have little difficulty acquiring new credit, though you will probably not qualify for the very best interest rates on home loans, credit cards, or car loans. In time, you may improve your credit score and present a lower risk to creditors by following the specific guidelines discussed below.

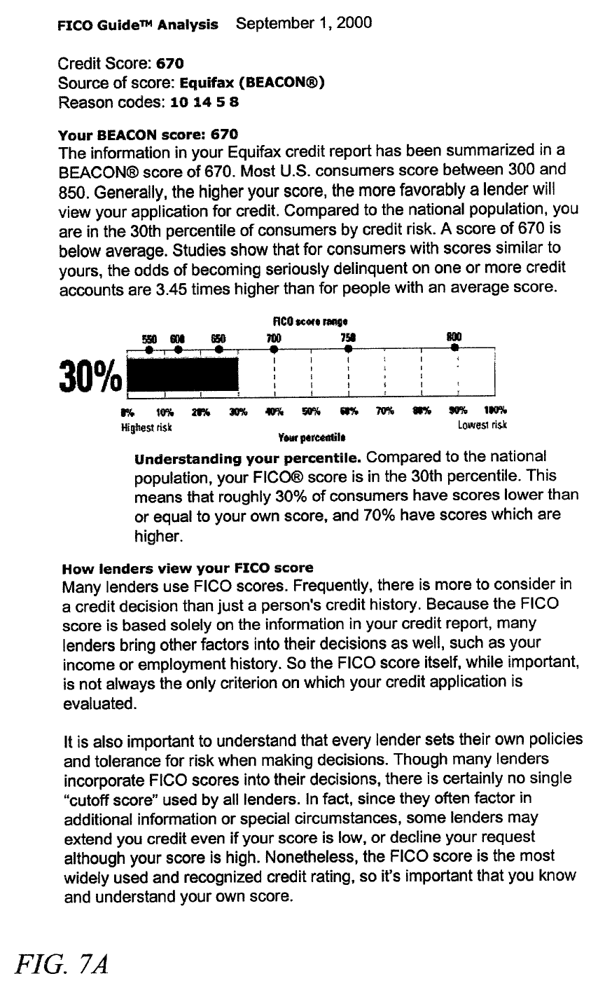

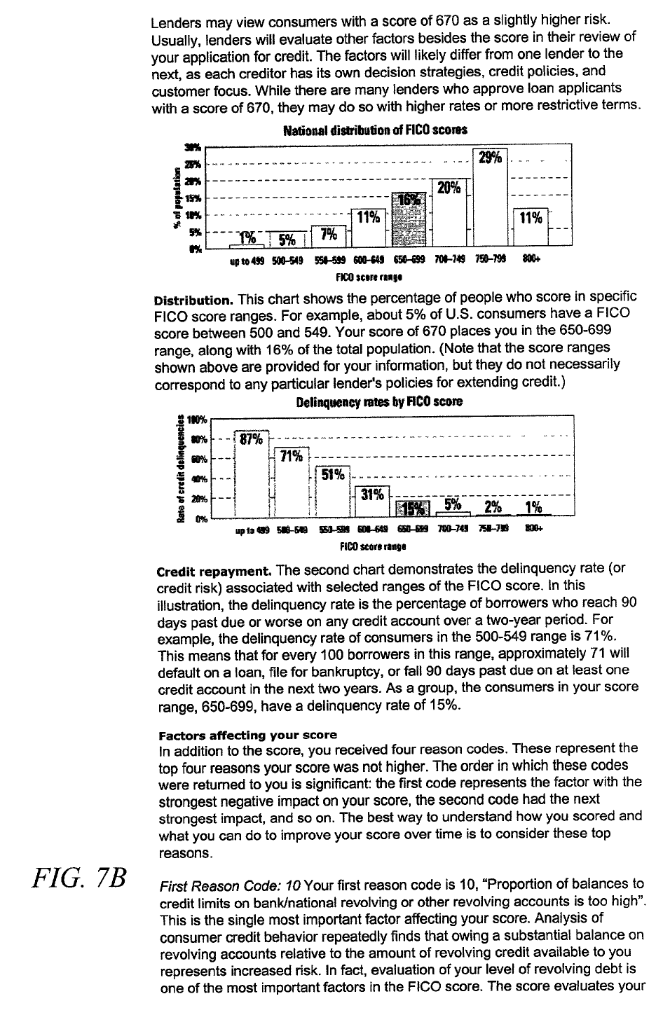

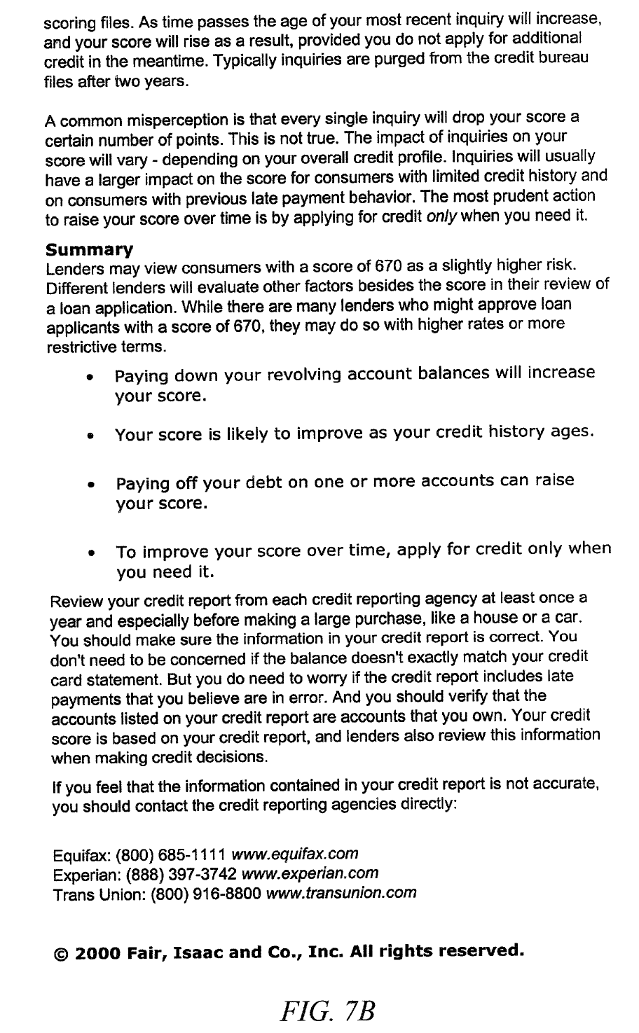

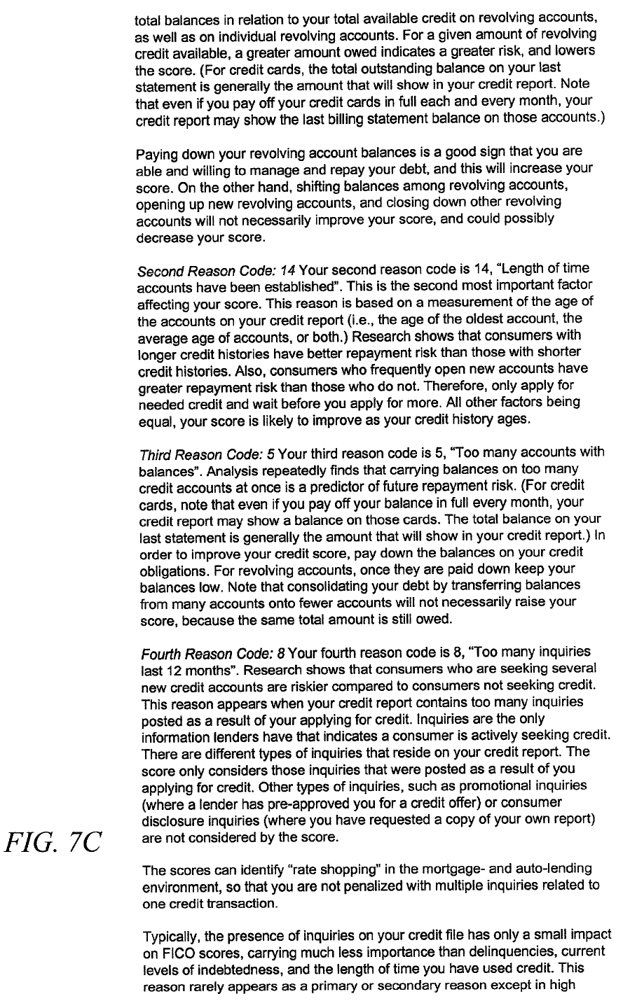

Your Credit Score (648) Relative to the National Population (See FIGS. 7a-7d)

In addition to the score, you received four reason codes. These represent the top four reasons your score was not higher. The order in which these codes were returned to you is significant: the first code represents the factor with the strongest negative impact on your score, the second code had the next strongest impact, and so on. The best way to understand how you scored and what you can do to improve your score over time is to consider these top reasons.

First Reason Code: 40

Your first reason code is 40, derogatory public record or collection filed. This code is triggered by the presence of either a negative public record, such as a filing for bankruptcy, a credit-related judgment, or a tax lien, or a collection account on your Equifax credit report. If you feel this information is in error, you should contact the bureau directly to investigate the item. Presuming that this information is in fact accurate, there is really nothing you can do to improve this aspect of your credit report. As the public record or collection item ages, it will have less and less influence on your credit score. Eventually, this type of negative credit information will be purged from your record altogether. This information may remain on your report for as many as seven years (10 years if it is a bankruptcy) after the time the event took place.

This reason is quite common among U.S. consumers, appearing as the first reason on about 35% of credit files. At the same time, it is possible to achieve a fairly high credit score despite the public record or collection on your report. If the derogatory item or items are at least a few years old, you have no recent history of delinquent payments on your credit accounts, and you maintain very conservative balances on your revolving credit accounts, it is possible to score in the 40th or 50th.

The fact that this reason code was returned first indicates that your score was reduced for this factor more than any other single measure of your credit report.

Second Reason Code: 10

Your second reason code is 10, proportion of balances to credit limits on revolving accounts is too high. Basically, this is a measurement of the degree to which you have utilized the total credit limits on your credit cards, department store cards, and other revolving lines of credit. This reason is very common among U.S. borrowers, appearing 75% of the time in the top four reasons. Statistical studies of consumer credit usage have shown repeatedly a very strong correlation between a consumers revolving utilization and their likelihood of incurring serious delinquencies in the future. People who are approaching their credit limits on one or more credit cards are 12 times more likely to default on their credit payments over the next two years than people who have used up just five or 10 percent of their available credit lines. In straight terms, the lower the utilization, the better. You can improve your credit rating over time by paying down your revolving balances.

Since this is the second reason cited for your score, its reasonable that doing so may improve your credit score by a substantial amount.

Third Reason Code: 14

Your third reason code is 14, length of time accounts have been established. A frequently returned reason, this code appears in the top four reasons of nearly 35% of FICO score calculations. Empirical studies of credit repayment performance show a consistent relationship between the length of borrowers credit history and the likelihood of paying on time. Generally, the longer your history, the more points you are awarded by the FICO score. Your history is measured by examining the dates on which your credit accounts were opened. All other factors being equal, an individual with accounts going back several years will score higher than someone with only a year or two of credit history.

Opening new accounts might lower your score, since it will shorten the average length of time you have held your credit accounts. Other than that, only time will improve this component of your credit rating.

This is the third most significant reason that your score is not higher.

Fourth Reason Code: 13

The final reason code is 13, time since delinquency is too recent or unknown. This reason is cited very frequently, appearing in the top four reasons on 38% of FICO score reports. The appearance of this reason means that there is evidence of delinquent payments on one or more of your credit accounts. Among the group of consumers with some history of late payments, one of strongest predictors of future serious delinquencies is the elapsed time since the most recent late payment status. In rare cases, a delinquency is present but cannot be explicitly dated. This usually has about average risk (better than a very recent delinquency, but not as good as a very old delinquency). In most cases, however, the date of a late payment or payments are known with certainty. Barring other effects, your credit score will improve with time as your delinquency (or delinquencies) become older. Your best course of action is to get current and stay current on all of your credit obligations. Federal law requires that delinquencies remain on your credit report for no more than seven years.

This is the fourth most significant reason that your score is not higher.

Summary

Based on your score, many lenders may view you as a slightly higher risk than their most preferred customers. However, not all lenders are alike each creditor has its own unique strategy and assessment tools for evaluating your repayment likelihood, as well as its own tolerance for default risk. It is likely that you will have little trouble securing credit in the future, although you might not qualify for the very best interest rates on all types of credit. In the future, you may improve your own credit score by following these specific recommendations:

Avoid additional collections, tax liens, credit judgments and filing for bankruptcy in the future. Future instances of these negative events can only lower your score.

Decrease the revolving balances on your credit cards, department store cards, and/or revolving lines of credit. Although consolidating your balances to a single revolving account or loan may simplify your finances and help you keep your status current, such an act is not likely to predictably move your credit score up or down.

Maintain a current rating on all of your credit accounts going forward. Missed payments reported to the credit bureau in the future will almost surely lower your score. Conversely, as your historical delinquencies become older, and all other factors remaining constant, your score will most likely improve.

All other things being equal, your score will likely rise as the length of your credit history grows. Opening new credit accounts might have a negative impact on your score, especially if your credit history consists of relatively few accounts (for example, just three or four accounts).

Above all, you should review your credit reports closely, to verify that the information is accurate and complete. In many cases, your credit history may be the first thing a potential creditor wants to know about you, so its important that the information be accurate. Even if everything appears to be correct right now, its generally a good habit to periodically check those reports, perhaps once a year, to ensure the information continues to be accurate.

If you feel that the information contained in your credit report in not accurate, you should contact the credit reporting agencies directly:

Equifax: (800) xxx-xxxx

Experian: (888) yyy-yyyy

Trans Union: (800) zzz-zzzz

The following provides various examples of outlines, explanations, and codes that are used in connection with the presently preferred embodiment of the invention:

SKELETON: Num Reasons=0

Intro Paragraph

The information in your ______ credit report has been summarized in a ______ score of ______. Most U.S. consumers score between 580 and 800. Compared to the national population, you are in the ______ percentile of consumers by credit risk.

Chart with National Distribution and This Consumer's Score

Consumers with scores in these ranges are “N” times as likely to {default/repay] as people with an average scores.

Based on your score of {very low/low}, many lenders will view you as high risk. But that does not mean that you will be turned down for every loan you apply for. While the types of credit available may be limited, you should be able to find a lender who is willing to approve your loan but at higher rates.

Based on your score of {mod. Low}, many lenders may view you as a slightly higher risk than their most preferred customers. However, not all lenders are alike. Each creditor has its own unique strategy and assessment tools for evaluating repayment likelihood, as well as its own tolerance for default risk. It is likely that you will have little trouble securing credit in the future, although you may not qualify for the very best interest rates on all types of credit.

Based on your score of {Moderate-Mod, High} most lenders may view you as their preferred customer. A wide array of loan products and credit card accounts will likely be available for you at attractive rates. It is likely that your mailbox frequently contains attractive offers, some of which may be suitable for your lifestyle. In summary, you have a very good score and should have no trouble obtaining credit in the future.

Based on your score of {high/very high} you will likely have your choice of credit products assuming that the other factors lenders take into account when approving credit or granting loans. Your score is a very good score. There is no such thing as a perfect score. The factors listed in the specific guidelines below will likely not impact your score by very much. Paying attention to the first and second reasons might raise your score by a few points. But all things being equal, you should have a wide array of credit products available to you.

Summary

Use one of the following:

Based on your score of {very low/low}, many lenders will view you as high risk. But that does not mean that you will be turned down for every loan you apply for. While the types of credit available may be limited, you should be able to find a lender who is willing to approve your loan but at higher rates.

Based on your score of {mod. Low}, many lenders may view you as a slightly higher risk than their most preferred customers. However, not all lenders are alike. Each creditor has its own unique strategy and assessment tools for evaluating repayment likelihood, as well as its own tolerance for default risk. It is likely that you will have little trouble securing credit in the future, although you may not qualify for the very best interest rates on all types of credit

Based on your score of {Moderate-Mod, High} most lenders may view you as their preferred customer. A wide array of loan products and credit card accounts will likely be available for you at attractive rates. It is likely that your mailbox frequently contains attractive offers, some of which may be suitable for your lifestyle. In summary, you have a very good score and should have no trouble obtaining credit in the future.

Based on your score of {high/very high} you will likely have your choice of credit products assuming that the other factors lenders take into account when approving credit or granting loans. Your score is a very good score. There is no such thing as a perfect score. But all things being equal, you should have a wide array of credit products available to you.

Above all, you should review your credit reports closely, to verify that that the information is accurate and complete. In many cases, your credit history may be the first thing a potential creditor wants to know about you, so it's important that the information be accurate. Even if everything appears to be correct right now, it's generally a good habit to periodically check those reports, perhaps once a year to ensure the information continues to be accurate.

If you feel that the information contained in your credit report is not accurate, you should contact the credit reporting agencies directly:

Equifax: (800) 685-1111

Experian: (888) 397-3742

Trans Union: (800) 916-8800

SKELETON: Num Reasons=1

Intro Paragraph

The information in your ______ credit report has been summarized in a ______ score of ______. Most U.S. consumers score between 580 and 800. Compared to the national population, you are in the ______ percentile of consumers by credit risk.

Chart with National Distribution AND This Consumer's Score

Consumers with scores in these ranges are “N” times as likely to {default/repay] as people with an average scores.

Based on your score of {very low/low}, many lenders will view you as high risk. But that does not mean that you will be turned down for every loan you apply for. While the types of credit available may be limited, you should be able to find a lender who is willing to approve your loan but at higher rates.

In time, you may improve your credit score by following the specific guideline listed below.

Based on your score of {mod. Low}, many lenders may view you as a slightly higher risk than their most preferred customers. However, not all lenders are alike. Each creditor has its own unique strategy and assessment tools for evaluating repayment likelihood, as well as its own tolerance for default risk. It is likely that you will have little trouble securing credit in the future, although you may not qualify for the very best interest rates on all types of credit. In summary, your credit score suggest that you represent moderate risk to lenders, but your score can improve if you follow the specific guideline listed below.

Based on your score of {Moderate-Mod, High} most lenders may view you as their preferred customer. A wide array of loan products and credit card accounts will likely be available for you at attractive rates. It is likely that your mailbox frequently contains attractive offers, some of which may be suitable for your lifestyle. In summary, you have a very good score and should have no trouble obtaining credit in the future. You can raise your score somewhat by following the specific guideline below.

Based on your score of {high/very high} you will likely have your choice of credit products assuming that the other factors lenders take into account when approving credit or granting loans. Your score is a very good score. There is no such thing as a perfect score. The factors listed in the specific guidelines below will likely not impact your score by very much. Paying attention to the first and second reasons might raise your score by a few points. But all things being equal, you should have a wide array of credit products available to you.

In addition to your score you entered one reason code. This represents one reason your score was not higher. The first code represents the factor with the strongest negative impact on your score. The best way to understand how you scored and what you can do to improve your score over time is to consider this reason.

First Reason Code: _{—}

Your first reason is

Explanation text

The fact that this reason was returned first indicates that your score was reduced for this factor more than any other single measure of your credit report.

Actionable qualifiers for Reason Code 1 and 2 {add text in quotations at end of reason code explanation}

If score is (<620) and reason is *actionable, “Doing so may substantially improve your score.”

If score is (620-680) and reason is *actionable, “This has the potential to raise your score a good deal.”

If score is (680-720) and reason is *actionable, “This may raise your score somewhat although your score is already very high.”

If score is (GT 720), “You have a very good score and this should not be a concern for you.”

Summary

To improve on your score of ______ try the following recommendation

Pull from the explanations

And the append with one of the following:

Based on your score of {very low/low}, many lenders will view you as high risk. But that does not mean that you will be turned down for every loan you apply for. While the types of credit available may be limited, you should be able to find a lender who is willing to approve your loan but at higher rates.

Based on your score of {mod. Low}, many lenders may view you as a slightly higher risk than their most preferred customers. However, not all lenders are alike. Each creditor has its own unique strategy and assessment tools for evaluating repayment likelihood, as well as its own tolerance for default risk. It is likely that you will have little trouble securing credit in the future, although you may not qualify for the very best interest rates on all types of credit

Based on your score of {Moderate-Mod, High} most lenders may view you as their preferred customer. A wide array of loan products and credit card accounts will likely be available for you at attractive rates. It is likely that your mailbox frequently contains attractive offers, some of which may be suitable for your lifestyle. In summary, you have a very good score and should have no trouble obtaining credit in the future.

Based on your score of {high/very high} you will likely have your choice of credit products assuming that the other factors lenders take into account when approving credit or granting loans. Your score is a very good score. There is no such thing as a perfect score. But all things being equal, you should have a wide array of credit products available to you.

Above all, you should review your credit reports closely, to verify that that the information is accurate and complete. In many cases, your credit history may be the first thing a potential creditor wants to know about you, so it's important that the information be accurate. Even if everything appears to be correct right now, it's generally a good habit to periodically check those reports, perhaps once a year to ensure the information continues to be accurate.

If you feel that the information contained in your credit report is not accurate, you should contact the credit reporting agencies directly:

Equifax: (800) 685-1111

Experian: (888) 397-3742

Trans Union: (800) 916-8800

SKELETON: Num Reasons=2

Intro Paragraph

The information in your ______ credit report has been summarized in a ______ score of ______. Most U.S. consumers score between 580 and 800. Compared to the national population, you are in the ______ percentile of consumers by credit risk.

Chart with National Distribution and This Consumer's Score

Consumers with scores in these ranges are “N” times as likely to {default/repay] as people with an average scores.

Based on your score of {very low/low}, many lenders will view you as high risk. But that does not mean that you will be turned down for every loan you apply for. While the types of credit available may be limited, you should be able to find a lender who is willing to approve your loan but at higher rates.

In time, you may improve your credit score by following the specific guidelines listed below.

Based on your score of {mod. Low}, many lenders may view you as a slightly higher risk than their most preferred customers. However, not all lenders are alike. Each creditor has its own unique strategy and assessment tools for evaluating repayment likelihood, as well as its own tolerance for default risk. It is likely that you will have little trouble securing credit in the future, although you may not qualify for the very best interest rates on all types of credit. In summary, your credit score suggest that you represent moderate risk to lenders, but your score can improve if you follow the specific guidelines listed below.

Based on your score of {Moderate-Mod, High} most lenders may view you as their preferred customer. A wide array of loan products and credit card accounts will likely be available for you at attractive rates. It is likely that your mailbox frequently contains attractive offers, some of which may be suitable for your lifestyle. In summary, you have a very good score and should have no trouble obtaining credit in the future. You can raise your score somewhat by following the specific guidelines below.

Based on your score of {high/very high} you will likely have your choice of credit products assuming that the other factors lenders take into account when approving credit or granting loans. Your score is a very good score. There is no such thing as a perfect score. The factors listed in the specific guidelines below will likely not impact your score by very much. Paying attention to the first and second reasons might raise your score by a few points. But all things being equal, you should have a wide array of credit products available to you.

In addition to your score you entered two reason codes. They represent two reasons your score was not higher. The order in which these codes were returned to you is significant: the first code represents the factor with the strongest negative impact on your score, the second code had the next strongest impact. The best way to understand how you scored and what you can do to improve your score over time is to consider these reasons.

First Reason Code: _{—}

Your first reason is

Explanation text

The fact that this reason was returned first indicates that your score was reduced for this factor more than any other single measure of your credit report.

Actionable Qualifiers for Reason Code 1 and 2 {Add Text in Quotations at End of Reason Code Explanation}

If score is (<620) and reason is *actionable, “Doing so may substantially improve your score.”

If score is (620-680) and reason is *actionable, “This has the potential to raise your score a good deal.”

If score is (680-720) and reason is *actionable, “This may raise your score somewhat although your score is already very high.”

If score is (GT 720), “You have a very good score and this should not be a concern for you.”

Second Reason code: _{—}

Your second reason is

Explanation text

Actionable Qualifiers for Reason Code 1 and 2 {Add Text in Quotations at End of Reason Code Explanation}

If score is (<620) and reason is *actionable, “Doing so may substantially improve your score.”

If score is (620-680) and reason is *actionable, “This has the potential to raise your score a good deal.”

If score is (680-720) and reason is *actionable, “This may raise your score somewhat although your score is already very high.”

If score is (GT 720), “You have a very good score and this should not be a concern for you.”

Else,

Since this is the second reason cited for your score, it's reasonable that following the suggestions to improve your score may over time improve your score by a substantial amount.

Summary

To improve on your score of ______ try the following recommendations

Pull from the explanations

And the append with one of the following:

Based on your score of {very low/low}, many lenders will view you as high risk. But that does not mean that you will be turned down for every loan you apply for. While the types of credit available may be limited, you should be able to find a lender who is willing to approve your loan but at higher rates.

Based on your score of {mod. Low}, many lenders may view you as a slightly higher risk than their most preferred customers. However, not all lenders are alike. Each creditor has its own unique strategy and assessment tools for evaluating repayment likelihood, as well as its own tolerance for default risk. It is likely that you will have little trouble securing credit in the future, although you may not qualify for the very best interest rates on all types of credit

Based on your score of {Moderate-Mod, High} most lenders may view you as their preferred customer. A wide array of loan products and credit card accounts will likely be available for you at attractive rates. It is likely that your mailbox frequently contains attractive offers, some of which may be suitable for your lifestyle. In summary, you have a very good score and should have no trouble obtaining credit in the future.

Based on your score of {high/very high} you will likely have your choice of credit products assuming that the other factors lenders take into account when approving credit or granting loans. Your score is a very good score. There is no such thing as a perfect score. But all things being equal, you should have a wide array of credit products available to you.

Above all, you should review your credit reports closely, to verify that that the information is accurate and complete. In many cases, your credit history may be the first thing a potential creditor wants to know about you, so it's important that the information be accurate. Even if everything appears to be correct right now, it's generally a good habit to periodically check those reports, perhaps once a year to ensure the information continues to be accurate.

If you feel that the information contained in your credit report is not accurate, you should contact the credit reporting agencies directly:

Equifax: (800) 685-1111

Experian: (888) 397-3742

Trans Union: (800) 916-8800

SKELETON: Num Reasons=3

Intro Paragraph

The information in your ______ credit report has been summarized in a ______ score of ______. Most U.S. consumers score between 580 and 800. Compared to the national population, you are in the ______ percentile of consumers by credit risk.

Chart with National Distribution and This Consumer's Score

Consumers with scores in these ranges are “N” times as likely to {default/repay] as people with an average scores.

Based on your score of {very low/low}, many lenders will view you as high risk. But that does not mean that you will be turned down for every loan you apply for. While the types of credit available may be limited, you should be able to find a lender who is willing to approve your loan but at higher rates.

In time, you may improve your credit score by following the specific guidelines listed below.

Based on your score of {mod. Low}, many lenders may view you as a slightly higher risk than their most preferred customers. However, not all lenders are alike. Each creditor has its own unique strategy and assessment tools for evaluating repayment likelihood, as well as its own tolerance for default risk. It is likely that you will have little trouble securing credit in the future, although you may not qualify for the very best interest rates on all types of credit. In summary, your credit score suggest that you represent moderate risk to lenders, but your score can improve if you follow the specific guidelines listed below.

Based on your score of {Moderate-Mod, High} most lenders may view you as their preferred customer. A wide array of loan products and credit card accounts will likely be available for you at attractive rates. It is likely that your mailbox frequently contains attractive offers, some of which may be suitable for your lifestyle. In summary, you have a very good score and should have no trouble obtaining credit in the future. You can raise your score somewhat by following the specific guidelines below.

Based on your score of {high/very high} you will likely have your choice of credit products assuming that the other factors lenders take into account when approving credit or granting loans. Your score is a very good score. There is no such thing as a perfect score. The factors listed in the specific guidelines below will likely not impact your score by very much. Paying attention to the first and second reasons might raise your score by a few points. But all things being equal, you should have a wide array of credit products available to you.

In addition to your score you entered three reason codes. They represent the reasons your score was not higher. The order in which these codes were returned to you is significant: the first code represents the factor with the strongest negative impact on your score, the second code had the next strongest impact, and so on. The best way to understand how you scored and what you can do to improve your score over time is to consider these top reasons.

First Reason Code: _{—}

Your first reason is

Explanation text

The fact that this reason was returned first indicates that your score was reduced for this factor more than any other single measure of your credit report.

Actionable Qualifiers for Reason Code 1 and 2 {Add Text in Quotations at End of Reason Code Explanation}

If score is (<620) and reason is *actionable, “Doing so may substantially improve your score.”

If score is (620-680) and reason is *actionable, “This has the potential to raise your score a good deal.”

If score is (680-720) and reason is *actionable, “This may raise your score somewhat although your score is already very high.”

If score is (GT 720), “You have a very good score and this should not be a concern for you.”

Second Reason code: _{—}

Your second reason is

Explanation text

Actionable Qualifiers for Reason Code 1 and 2 {Add Text in Quotations at End of Reason Code Explanation}

If score is (<620) and reason is *actionable, “Doing so may substantially improve your score.”

If score is (620-680) and reason is *actionable, “This has the potential to raise your score a good deal.”

If score is (680-720) and reason is *actionable, “This may raise your score somewhat although your score is already very high.”

If score is (GT 720), “You have a very good score and this should not be a concern for you.”

Else,

Since this is the second reason cited for your score, it's reasonable that following the suggestions to improve your score may over time improve your score by a substantial amount.

Third Reason Code: _{—}

Your third reason is

Explanation text

This is the third most significant reason your score is not higher.

Summary

To improve on your score of ______ try the following recommendations

Pull from the explanations

And the append with one of the following:

Based on your score of {very low/low}, many lenders will view you as high risk. But that does not mean that you will be turned down for every loan you apply for. While the types of credit available may be limited, you should be able to find a lender who is willing to approve your loan but at higher rates.

Based on your score of {mod. Low}, many lenders may view you as a slightly higher risk than their most preferred customers. However, not all lenders are alike. Each creditor has its own unique strategy and assessment tools for evaluating repayment likelihood, as well as its own tolerance for default risk. It is likely that you will have little trouble securing credit in the future, although you may not qualify for the very best interest rates on all types of credit

Based on your score of {Moderate-Mod, High} most lenders may view you as their preferred customer. A wide array of loan products and credit card accounts will likely be available for you at attractive rates. It is likely that your mailbox frequently contains attractive offers, some of which may be suitable for your lifestyle. In summary, you have a very good score and should have no trouble obtaining credit in the future.

Based on your score of {high/very high} you will likely have your choice of credit products assuming that the other factors lenders take into account when approving credit or granting loans. Your score is a very good score. There is no such thing as a perfect score. But all things being equal, you should have a wide array of credit products available to you.

Above all, you should review your credit reports closely, to verify that that the information is accurate and complete. In many cases, your credit history may be the first thing a potential creditor wants to know about you, so it's important that the information be accurate. Even if everything appears to be correct right now, it's generally a good habit to periodically check those reports, perhaps once a year to ensure the information continues to be accurate.

If you feel that the information contained in your credit report is not accurate, you should contact the credit reporting agencies directly:

Equifax: (800) 685-1111

Experian: (888) 397-3742

Trans Union: (800) 916-8800

SKELETON: Num Reasons=4

Intro Paragraph

The information in your ______ credit report has been summarized in a ______ score of ______. Most U.S. consumers score between 580 and 800. Compared to the national population, you are in the ______ percentile of consumers by credit risk.

Chart with National Distribution and This Consumer's Score

Consumers with scores in these ranges are “N” times as likely to (default/repay] as people with an average scores.

Based on your score of {very low/low}, many lenders will view you as high risk. But that does not mean that you will be turned down for every loan you apply for. While the types of credit available may be limited, you should be able to find a lender who is willing to approve your loan but at higher rates.

In time, you may improve your credit score by following the specific guidelines listed below.

Based on your score of {mod. Low}, many lenders may view you as a slightly higher risk than their most preferred customers. However, not all lenders are alike. Each creditor has its own unique strategy and assessment tools for evaluating repayment likelihood, as well as its own tolerance for default risk. It is likely that you will have little trouble securing credit in the future, although you may not qualify for the very best interest rates on all types of credit. In summary, your credit score suggest that you represent moderate risk to lenders, but your score can improve if you follow the specific guidelines listed below.

Based on your score of {Moderate-Mod, High} most lenders may view you as their preferred customer. A wide array of loan products and credit card accounts will likely be available for you at attractive rates. It is likely that your mailbox frequently contains attractive offers, some of which may be suitable for your lifestyle. In summary, you have a very good score and should have no trouble obtaining credit in the future. You can raise your score somewhat by following the specific guidelines below.

Based on your score of {high/very high} you will likely have your choice of credit products assuming that the other factors lenders take into account when approving credit or granting loans. Your score is a very good score. There is no such thing as a perfect score. The factors listed in the specific guidelines below will likely not impact your score by very much. Paying attention to the first and second reasons might raise your score by a few points. But all things being equal, you should have a wide array of credit products available to you.

In addition to your score you received four reason codes. They represent the top four reasons your score was not higher. The order in which these codes were returned to you is significant: the first code represents the factor with the strongest negative impact on your score, the second code had the next strongest impact, and so on. The best way to understand how you scored and what you can do to improve your score over time is to consider these top reasons.

First Reason Code: _{—}

Your first reason is

Explanation text

The fact that this reason was returned first indicates that your score was reduced for this factor more than any other single measure of your credit report.

Actionable Qualifiers for Reason Code 1 and 2 {Add Text in Quotations at End of Reason Code Explanation}

If score is (<620) and reason is *actionable, “Doing so may substantially improve your score.”

If score is (620-680) and reason is *actionable, “This has the potential to raise your score a good deal.”

If score is (680-720) and reason is *actionable, “This may raise your score somewhat although your score is already very high.”

If score is (GT 720), “You have a very good score and this should not be a concern for you.”

Second Reason code: _{—}

Your second reason is

Explanation text

Actionable Qualifiers for Reason Code 1 and 2 {Add Text in Quotations at End of Reason Code Explanation}

If score is (<620) and reason is *actionable, “Doing so may substantially improve your score.”

If score is (620-680) and reason is *actionable, “This has the potential to raise your score a good deal.”

If score is (680-720) and reason is *actionable, “This may raise your score somewhat although your score is already very high.”

If score is (GT 720), “You have a very good score and this should not be a concern for you.”

Else,

Since this is the second reason cited for your score, it's reasonable that following the suggestions to improve your score may over time improve your score by a substantial amount.

Third Reason Code: _{—}

Your third reason is

Explanation text

This is the third most significant reason your score is not higher.

Fourth Reason Code: _{—}

The final reason is

Explanation text

This is the fourth most significant reason that your score is not higher.

Summary

To improve on your score of ______ try the following recommendations

Pull from the explanations

And the append with one of the following:

Based on your score of {very low/low}, many lenders will view you as high risk. But that does not mean that you will be turned down for every loan you apply for. While the types of credit available may be limited, you should be able to find a lender who is willing to approve your loan but at higher rates.

Based on your score of {mod. Low}, many lenders may view you as a slightly higher risk than their most preferred customers. However, not all lenders are alike. Each creditor has its own unique strategy and assessment tools for evaluating repayment likelihood, as well as its own tolerance for default risk. It is likely that you will have little trouble securing credit in the future, although you may not qualify for the very best interest rates on all types of credit

Based on your score of {Moderate-Mod, High} most lenders may view you as their preferred customer. A wide array of loan products and credit card accounts will likely be available for you at attractive rates. It is likely that your mailbox frequently contains attractive offers, some of which may be suitable for your lifestyle. In summary, you have a very good score and should have no trouble obtaining credit in the future.

Based on your score of {high/very high} you will likely have your choice of credit products assuming that the other factors lenders take into account when approving credit or granting loans. Your score is a very good score. There is no such thing as a perfect score. But all things being equal, you should have a wide array of credit products available to you.

Above all, you should review your credit reports closely, to verify that that the information is accurate and complete. In many cases, your credit history may be the first thing a potential creditor wants to know about you, so it's important that the information be accurate. Even if everything appears to be correct right now, it's generally a good habit to periodically check those reports, perhaps once a year to ensure the information continues to be accurate.

If you feel that the information contained in your credit report is not accurate, you should contact the credit reporting agencies directly:

Equifax: (800) 685-1111

Experian: (888) 397-3742

Trans Union: (800) 916-8800

Explainer Reason Code Explanations

J6 (36) Length of Time Open Installment Loans Have Been Established

, “length of time open installment loans have been established”.

This reason is based on a measurement of the age of the open installment loan accounts on your credit report, i.e. the age of the oldest open loan, the average age of open installment loans, or both.). Research shows that consumers with longer credit histories have better repayment risk than those with shorter credit histories. Also, consumers who frequently open new accounts have greater repayment risk than those who do not. Therefore, only apply for needed credit and wait before you apply for more. All other factors being equal, your score is likely to improve as your credit history ages.

X0 (46) Payments Due on Accounts

, “Payments Due on Accounts

The score measures the payments due on the accounts (revolving and installment) that are listed on your credit report. (For credit cards, the minimum payment due on your last statement is generally the amount that will show in your credit report. Note that even if you pay off your credit cards in full each and every month, your credit report may show the last billing statements minimum payment due on those accounts.) Research has shown that consumers with larger payments due on their credit accounts have greater future repayment risk than those with lower payments due. You can improve your credit rating by paying off your debts. Consolidating or moving your debt around from one account to another will not, however, raise your score, since the same amount is still owed. The best advice is to pay off your debts as quickly as you can.

**A3 (01) Amount Owed on Accounts is too High

, “Amount Owed on Accounts is too High”.

The score measures how much you owe on the accounts (revolving and installment) that are listed on your credit report. (For credit cards, the total outstanding balance on your last statement is generally the amount that will show in your credit report. Note that even if you pay off your credit cards in full each and every month, your credit report may show the last billing statement balance on those accounts.) Research has shown that consumers owing larger amounts on their credit accounts have greater future repayment risk than those who owe less. You can improve your credit rating by paying off your debts. Consolidating or moving your debt around from one account to another will not, however, raise your score, since the same amount is still owed. The best advice is to pay off your debts as quickly as you can.

D6 (02) Level of Delinquency on Accounts

, Level of Delinquency on Accounts.

Research shows that consumers with previous late payment behavior are much more likely to exhibit similar behavior in the future. The score evaluates not only the presence of previous late payments, but also how late the payments were. For example, a payment that was 90 days late represents greater risk than a payment that was 30 days late if they occurred around the same time. But even a 30 day late payment represents substantially greater risk than no late payments at all. There is no quick fix to raise your score if the late payment on your credit report is valid. In order to improve your credit rating over time, you need to pay your bills on time. The longer you pay your bills on time, the better the score. If you have late payments, get caught up on back payments and stay current. As time passes the importance of these previous late payments will gradually lessen and the score will increase—as long as you make your payments on time on all of your credit obligations, and use your available credit responsibly.

R4 (03) Too Few Bank/National Revolving Accounts

, “Too Few Bank/National Revolving Accounts”.

The score evaluates the types of credit in your credit history and will consider your mix of credit cards, retail accounts, installment loans, finance company accounts and mortgage loans. It is not necessary to have one of each, and it is not a good idea to open credit accounts you have no need for, or don't intend to use. You have slightly fewer bankcard accounts (such as Visa, MasterCard, Discover, American Express, Diners Club, etc.) appearing on your credit report than other consumers with similar length credit histories. To improve your score you need to establish a credit history with several types of loan or account relationships and demonstrate that you can manage credit responsibly. Over time you will build a history which demonstrates your ability to manage different types of credit.

**P9 (03) Proportion of Loan Balances to Loan Amounts is too High

, “Proportion of Loan Balances to Loan Amounts is too High”.

Simply having installment loans and owing money on them does not mean you are a high-risk borrower. To the contrary, paying down installment loans is a good sign that you are able and willing to manage and repay debt, and evidence of successful repayment weighs favorably on your credit rating. The FICO score examines many aspects of your current installment loan and revolving balances. One measurement is to compare the total outstanding installment balances against the total original loan amounts. Generally, the closer the loans are to being fully paid off, the better the score. This is because research has shown that loans with more of their original balances remaining represent higher risk than loans which have been paid down more. Compared to other measurements of indebtedness, however, this has relatively limited influence on the FICO score. Your best strategy to improve your score is to pay down your installment loan or loans as quickly as possible.

T2 (04) Too Many Bank/national Revolving Accounts (EQX Only)

Too Many Bank/National Revolving Accounts.

The score evaluates the types of credit in your credit history and will consider your mix of credit cards, retail accounts, installment loans, finance company accounts and mortgage loans. It is not necessary to have one of each, and it is not a good idea to open credit accounts you have no need for, or don't intend to use. Your credit report shows more bankcard accounts (such as Visa, MasterCard, Discover, American Express, Diners Club, etc.) than other consumers with similar length credit histories. Research has shown that consumers with a relatively large number of bankcard accounts appearing on their credit report represent higher risk compared to consumers with a more moderate number of bankcard accounts. Therefore, avoid applying for credit you don't need, or don't intend to use. (Note that closing your existing bankcard accounts will not make them disappear from your credit report immediately; therefore, closing many or all of your bankcard accounts will probably not increase the score.) The best way to improve your credit rating is by managing ALL of your accounts responsibly, and not missing any payments.

F7 (04) Lack of Recent Installment Loan Information (XPN/TU Only)

Lack of Recent Installment Loan Information.

This reason appears when no installment loan accounts appear on the credit report, or all such accounts are closed, or are no longer being reported by the lender. The score evaluates the types of credit in your credit history and will consider your mix of credit cards, retail accounts, installment loans, finance company accounts and mortgage loans. It is not necessary to have one of each, and it is not a good idea to open credit accounts you have no need for, or don't intend to use. To improve your score you need to establish a credit history with several types of loan or account relationships and demonstrate that you can manage credit responsibly. Over time you will build a history which demonstrates your ability to manage different types of credit.

**T1 (05) Too Many Accounts with Balances

, “Too Many Accounts with Balances”.

Research shows that carrying balances on too many credit accounts at once is a predictor of future repayment risk. (For credit cards, note that even if you pay off your balance in full every month, your credit report may show a balance on those cards. The total balance on your last statement is generally the amount that will show in your credit report.) In order to improve your credit rating, pay down the balances on your credit obligations. For revolving accounts, once they are paid down keep your balances low. Note that consolidating your debt by transferring balances from many accounts onto fewer accounts will not necessarily raise your score, because the same total amount is still owed. Paying off your debt is the best way to raise your score.

T3 (06) Too Many Consumer Finance Company Accounts

Too Many Consumer Finance Company Accounts.

Research shows that consumers with consumer finance company loans appearing on their credit report represent higher risk compared to those with no consumer finance loans. Therefore, avoid applying for credit you don't need, or don't intend to use. (Note that after a consumer finance company account is closed, it will not disappear from the credit report immediately. Research shows that the presence of consumer finance company accounts on the credit report, whether open or closed, is still predictive of future repayment risk; and thus they will still be considered by the score.) The best way to improve your credit rating is by managing all of your accounts responsibly, not missing any payments, and not opening new credit accounts you don't need.

A0 (07) Account Pay History is too New to Rate

, “Account Pay History is too New to Rate”.

This reason occurs when, for all recently reported credit accounts in your credit report, none have a measurable account status. Examples of unmeasurable account status include accounts with just a few months history, accounts in dispute, accounts with a missing or blank status field, or accounts with status indicating too new to rate. The score needs history of payments on recently reported credit accounts in order to evaluate the likelihood of future payments being made on time. To improve your score you need to establish a recent history of successfully repaying credit obligations, especially by keeping account balances low and making all payments on time.

T5 (08) Too Many Inquiries Last 12 Months

, Too Many Inquiries in Last 12 Months.

Statistical studies show that consumers who are seeking new credit are riskier compared to consumers not seeking credit. This reason appears when your credit report contains credit inquiries posted as a result of your applying for new credit. Inquiries are the only information lenders have that indicates a consumer is actively seeking credit. There are many different types of inquiries that reside on your credit report. The score only considers those inquiries that were posted as a result of you actively seeking and applying for credit. Other types of inquiries, such as promotional inquiries (where a lender has pre-approved you for a credit offer) or consumer disclosure inquiries (where you have requested a copy of your own report) are not considered by the score.

In addition, the scores can identify rate shopping in the mortgage- and auto-lending environment, so that you are not penalized for inquiries related to one credit transaction.

Typically, the presence of inquiries on your credit file has only a small impact on FICO scores, carrying much less importance than delinquencies, current levels of indebtedness, and the length of time you have used credit. Thus, it is rare for this reason to appear in the top four codes for all but high scoring files. As time passes the age of your most recent inquiry will increase, and your score will rise as a result, provided you do not apply for additional credit in the meantime. Typically inquiries are purged from the credit bureau files after two years.

A common misperception is that every single inquiry will drop your score a certain number of points. This is not true. The impact of inquiries on your score will vary—depending on your overall credit profile. Inquiries will usually have a larger impact on the score for consumers with limited credit history and on consumers with previous late payment behavior. The most prudent action to raise your score over time is by applying for credit only when you need it.

T0 (09) Too Many Accounts Recently Opened

, “Too Many Accounts Recently Opened”.

Research shows that opening several credit accounts in a short period of time represents increased risk for future repayment—especially for consumers who do not have a long established credit history. Therefore, only apply for needed credit and wait before you apply for more. The best way to improve your credit rating is by responsibly managing all of your accounts, including newly opened accounts, and not missing any payments.

**P5 (10) Proportion of Balances to Credit Limits on Bank/National Revolving or Other Revolving Accounts

, Proportion of Balances to Credit Limits on Bank/National Revolving or Other Revolving Accounts.

Research shows that owing a substantial balance on revolving accounts relative to the amount of revolving credit available to you represents increased risk. In fact, evaluation of your level of revolving debt is one of the most important factors in a credit score. The score evaluates your total balances in relation to your total available credit on revolving accounts, as well as on individual revolving accounts. For a given amount of revolving credit available, a greater amount owed indicates a greater risk, and lowers the score. (For credit cards, the total outstanding balance on your last statement is generally the amount that will show in your credit report. Note that even if you pay off your credit cards in full each and every month, your credit report may show the last billing statement balance on those accounts.)

Paying down your revolving account balances is a good sign that you are able and willing to manage and repay your debt, and this will increase your score. On the other hand, shifting balances among revolving accounts, opening up new revolving accounts, and closing down other revolving accounts will not necessarily improve your score, and could possibly decrease your score.

**B5 (11) Amount Owed on Revolving Accounts is too High

, “Amount Owed on Revolving Accounts is too High”.

The score measures how much you owe on the revolving accounts that are listed on your credit report. (For credit cards, the total outstanding balance on your last statement is generally the amount that will show in your credit report. Note that even if you pay off your credit cards in full each and every month, your credit report may show the last billing statement balance on those accounts.) Research has shown that consumers owing larger amounts on their revolving credit accounts have greater future repayment risk than those who owe less. You can improve your credit rating by paying off your debts. Consolidating or moving your debt around from one account to another will not, however, raise your score, since the same amount is still owed. The best advice is to pay off your debts as quickly as you can.

J8 (12) Length of Time Revolving Accounts Have Been Established

, Length of Time Revolving Accounts Have Been Established.

This reason is based on a measurement of the age of the revolving accounts on your credit report, i.e. the age of the oldest account, the average age of accounts, or both.). Research shows that consumers with longer credit histories have better repayment risk than those with shorter credit histories. Also, consumers who frequently open new accounts have greater repayment risk than those who do not. Therefore, only apply for needed credit and wait before you apply for more. All other factors being equal, your score is likely to improve as your credit history ages.

K0 (13) Time Since Delinquency is too Recent or Unknown

, “Time Since Delinquency is too Recent or Unknown”.

Research shows that consumers with previous late payment behavior are much more likely to exhibit similar behavior in the future. The score evaluates not only the presence of previous late payments, but also how recently the missed payments occurred. In general, the more recently a payment was missed, the greater the risk, and the lower the score. There is no quick fix to raise your score if the late payment on your credit report is valid. (Credit account delinquencies stay on your report for up to seven years. Note that closing an account on which you had previously missed a payment does not make the late payment disappear from your credit report.) In order to improve your credit rating over time, you need to pay your bills on time. The longer you pay your bills on time, the better the score. If you have late payments, get caught up on back payments and stay current. As time passes the importance of these previous late payments will gradually lessen and the score will increase—as long as you make your payments on time on all of your credit obligations, and use your available credit responsibly.

In rare cases, evidence of a past missed payment on a credit account is present on the credit report, but the date of the late payment cannot be determined exactly. The occurrence of such undateable credit account delinquency on a credit report still represents greater risk than never having missed a payment at all, and thus it will still affect the score.

JO (14) Length of Time Accounts Have Been Established

, Length of Time Accounts Have Been Established.

This reason is based on a measurement of the age of the accounts on your credit report, i.e. the age of the oldest account, the average age of accounts, or both.) Research shows that consumers with longer credit histories have better repayment risk than those with shorter credit histories. Also, consumers who frequently open new accounts have greater repayment risk than those who do not. Therefore, only apply for needed credit and wait before you apply for more. All other factors being equal, your score is likely to improve as your credit history ages.

F5 (15) Lack of Recent Bank/National Revolving Information

, “Lack of Bank Revolving Information”.

This reason appears when no bankcard accounts (such as Visa, MasterCard, Discover, American Express, Diners Club, etc.) appear on the credit report, or all such accounts are closed, or are no longer being reported by the lender. The score evaluates the types of credit in your credit history and will consider your mix of credit cards, retail accounts, installment loans, finance company accounts and mortgage loans. It is not necessary to have one of each, and it is not a good idea to open credit accounts you have no need for, or don't intend to use. To improve your score you need to establish a credit history with several types of loan or account relationships and demonstrate that you can manage credit responsibly. Over time you will build a history which demonstrates your ability to manage different types of credit.

G1 (16) Lack of Recent Revolving Account Information

, Lack of Recent Revolving Account Information.

This reason appears when no revolving accounts (such as retail credit cards, bank or national credit cards, etc.) appear on the credit report, or all such accounts are closed, or are no longer being reported by the lender. The score evaluates the types of credit in your credit history and will consider your mix of credit cards, retail accounts, installment loans, finance company accounts and mortgage loans. It is not necessary to have one of each, and it is not a good idea to open credit accounts you have no need for, or don't intend to use. To improve your score you need to establish a credit history with several types of loan or account relationships and demonstrate that you can manage credit responsibly. Over time you will build a history which demonstrates your ability to manage different types of credit.

G4 (17) No Recent Non-Mortgage Balance Information

, “No Recent Non-Mortgage Balance Information”.

This reason occurs when all credit accounts (except possibly a mortgage loan) appearing on the credit report, are closed, or are no longer being reported by the lender. Research shows that consumers who use credit very moderately (and make all their payments on time) have slightly better repayment risk on new accounts than those who have not been using credit at all for some time. Note that it is not a good idea to open credit accounts you have no need for, or don't intend to use. To improve your score you need to establish a recent history of successful credit usage, and demonstrate that you can manage credit responsibly.

M1 (18) Number of Accounts with Delinquency

, “Number of Accounts with Delinquency”.

The appearance of this reason indicates that there is past or present evidence of late payments on one or more of your credit obligations. Late payments on existing credit accounts is a very powerful predictor of future repayment risk on your credit obligations. There is no quick fix to improve the score if these reported late payments are valid. However, as these missed payments age and fall off the credit report (late payments stay on your report for up to seven years), their impact on the score will gradually decrease. In the meantime, it is important to pay all your credit obligations on time, in order to avoid any additional missed payments appearing on our credit report.

**R0 (19) Too Few Accounts Currently Paid as Agreed

, “Too Few Accounts Currently Paid as Agreed”.

There are two possible reasons why this code appears with a score. The first possibility is if one or more of your accounts is presently being reported in delinquent status, or your report shows evidence of missed payments in the past. Your credit report needs to show that you pay your bills on time. If you have missed payments, get caught up on back payments and stay current. The longer you pay your bills on time, the better your score. Second, if no missed payments appear on your credit report, and this reason appears with your score, then your score would be improved by adding more successful repayment history to your record. Research shows that consumers with a moderate number of successfully paid accounts appearing on their credit report have better future repayment risk than relatively inexperienced credit consumers i.e. those with just a few prior credit accounts on file.

D1 (19) Date of Last Inquiry too Recent

, “Date of Last Inquiry too Recent”.

Statistical studies show that consumers with more recent inquiries who (evidence of seeking new credit) are riskier compared to consumers not seeking credit. This reason appears when your credit report contains recent credit inquiries posted as a result of your applying for new credit. Inquiries are the only information lenders have that indicates a consumer is actively seeking credit. There are many different types of inquiries that reside on your credit report. The score only considers those inquiries that were posted as a result of you actively seeking and applying for credit. Other types of inquiries, such as promotional inquiries (where a lender has pre-approved you for a credit offer) or consumer disclosure inquiries (where you have requested a copy of your own report) are not considered by the score.

In addition, the scores can identify rate shopping in the mortgage- and auto-lending environment, so that you are not penalized for inquiries related to one credit transaction.

Typically, the presence of inquiries on your credit file has only a small impact on FICO scores, carrying much less importance than delinquencies, current levels of indebtedness, and the length of time you have used credit. Thus, it is rare for this reason to appear in the top four codes for all but high scoring files. As time passes the age of your most recent inquiry will increase, and your score will rise as a result, provided you do not apply for additional credit in the meantime. Typically inquiries are purged from the credit bureau files after two years.

A common misperception is that every single inquiry will drop your score a certain number of points. This is not true. The impact of inquiries on your score will vary—depending on your overall credit profile. Inquiries will usually have a larger impact on the score for consumers with limited credit history and on consumers with previous late payment behavior. The most prudent action to raise your score over time is by applying for credit only when you need it.

K1 (20) Time Since Derogatory Public Record or Collection is too Short

, “Length of Time Since Derogatory Public Record or Collection is too Short”.

For the group of consumers with derogatory public records or collection agency references on their credit reports, a strong predictor of future repayment risk is the recency of the item. All other factors being equal, your credit score will improve with time as your derogatory public record or collection item becomes older. There is no quick fix to raise your score if the derogatory item on your credit report is valid. Your best course of action to improve your credit rating is to get caught up on back payments and stay current on all of your credit obligations. The longer you pay your bills on time, the better your score. Federal law requires that derogatory public records and collection items remain on your credit report for no more than seven years (10 years for certain bankruptcy information). Note that satisfying or paying off a collection item or derogatory public record does not make it disappear from your credit report. Research shows that the fact that it occurred is still predictive of future repayment risk, and thus it will still be considered by the score.

**B6 (21) Amount Past Due on Accounts

, “Amount Past Due on Accounts.

This reason appears when there is evidence of recently missed payments on your credit report. If one of your accounts is presently being reported in delinquent status, the amount past due on the account is indicated on your credit report. Research shows that future repayment risk increases greatly with past due amounts; and the greater the past due amount, the higher the risk. In order to improve your credit rating you need to pay your bills on time. If you have missed payments, get caught up on back payments and stay current. The longer you pay your bills on time, the better your score. Note that closing an account on which a past due amount is still owed does not make it disappear from your credit report.

No New Mapping 22 Serious Delinquency, Derogatory Public Record, or Collection Filed

, “Serious Delinquency, Derogatory Public Record, or Collection Filed.

This reason occurs when there is a derogatory public record, collection agency reference, or serious delinquency (late payment on a credit account) on your credit report. Research shows that consumers with previous late payment behavior are much more likely to exhibit similar behavior in the future. There is no quick fix to improve the score if the derogatory public record, collection item, or serious credit account delinquency appearing on your credit report is valid. However, as these age and fall off the credit report (derogatory public records, collection items, and credit account delinquencies stay on your report for up to seven years, with some bankruptcy records remaining for up to 10 years), their impact on the score will gradually decrease. Note that satisfying or paying off a collection item or derogatory public record will not result in this information being removed from your credit report. Research shows that the fact that it occurred is still predictive of future repayment risk, and thus it will still be considered by the score.

**M6 (23) Number of Bank/National Revolving Accounts with Balances

, “Number of Bank or National Revolving Accounts with Balances”.

A bank or national revolving account includes Visa, MasterCard, American Express, Discover, Diners Club, and similar accounts. Research shows that carrying balances on too many bankcards at once is a predictor of future repayment risk. (Note that even if you pay off your balance in full every month, your credit report may show a balance on those cards. The total balance on your last statement is generally the amount that will show in your credit report.) In order to improve your credit rating, pay down those credit card balances. And once they are paid down, keep your balances lower on credit cards and other “revolving debt. Note that consolidating your debt by transferring balances from many cards onto fewer cards will not necessarily raise your score, because the same total amount is still owed. Paying off your debt is the best way to raise your score.

G6 (24) No Recent Revolving Balances

, “No Recent Revolving Balances.

The score evaluates the types of credit currently in use, or that you have successfully used in the past, and will consider the mix of retail cards, bankcards, and installment loans appearing on your credit report. In general, demonstrating the ability to moderately and responsibly use revolving credit accounts will boost the score slightly. Research shows that consumers with very moderate usage of revolving credit accounts (i.e. charging low balances and repaying them on time) have slightly better repayment risk than those who do not use revolving credit at all.

J4 (25) Length of Time Installment Loans Have Been Established

, Length of Time Installment Loans Have Been Established.

This reason is based on a measurement of the age of the installment loan accounts on your credit report, i.e. the age of the oldest loan, the average age of installment loans, or both.). Research shows that consumers with longer credit histories have better repayment risk than those with shorter credit histories. Also, consumers who frequently open new accounts have greater repayment risk than those who do not. Therefore, only apply for needed credit and wait before you apply for more. All other factors being equal, your score is likely to improve as your credit history ages.

M8 (26) Number of Bank/National Revolving or Other Revolving Accounts (I/O Only)

, “Number of Bank Revolving or Other Revolving Accounts.

If this reason is appearing, most likely your score is fairly high, in which case you should have an excellent chance of being approved for credit, and receiving favorable terms. You have slightly fewer bank or national credit card accounts (e.g. Visa, MasterCard, Discover, American Express, Diners Club, etc.) appearing on your credit report than other consumers with relatively high scores.

R0 (27) Too Few Accounts Currently Paid as Agreed

, “Too Few Accounts Currently Paid as Agreed”.

There are two possible reasons why this code appears with a score. The first possibility is if one or more of your accounts is presently being reported in delinquent status, or your report shows evidence of missed payments in the past. Your credit report needs to show that you pay your bills on time. If you have missed payments, get caught up on back payments and stay current. The longer you pay your bills on time, the better your score. Second, if no missed payments appear on your credit report, and this reason appears with your score, then your score would be improved by adding more successful repayment history to your record. Research shows that consumers with a moderate number of successfully paid accounts appearing on their credit report have better future repayment risk than relatively inexperienced credit consumers i.e. those with just a few prior credit accounts on file.

**N2 (28) Number of Established Accounts

, “Number of Established Accounts”.

This reason may appear with credit reports with relatively short credit histories, but which have an unusually high number of credit accounts for such a young file. This reason may also appear with older credit files which have an unusually high number of credit accounts on file. Research has shown that consumers with a relatively large number of credit accounts appearing on their credit report represent higher risk compared to consumers with a more moderate number of credit accounts. Therefore, avoid applying for credit you don't need, or don't intend to use. (Note that closing your existing accounts will not make them disappear from your credit report immediately.) The best way to improve your credit rating is by managing ALL of your accounts responsibly, and not missing any payments.

G3 (29) No Recent Bank/National Revolving Balances

29, “No Recent Bankcard Balances”.

The score evaluates the types of credit currently in use, or that you have successfully used in the past, and will consider the mix of retail cards, bankcards, and installment loans appearing on your credit report. In general, demonstrating the ability to moderately and responsibly use bank or national revolving accounts (e.g. Visa, MasterCard, Discover, American Express, Diners Club, etc.) will boost the score slightly. Research shows that consumers with very moderate usage of bankcard accounts (i.e. charging low balances and repaying them on time) have slightly better repayment risk than those who do not use bankcard credit at all.

D1 (29) Date of Last Inquiry too Recent

“Date of Last Inquiry too Recent”.

Statistical studies show that consumers with more recent inquiries who (evidence of seeking new credit) are riskier compared to consumers not seeking credit. This reason appears when your credit report contains recent credit inquiries posted as a result of your applying for new credit. Inquiries are the only information lenders have that indicates a consumer is actively seeking credit. There are many different types of inquiries that reside on your credit report. The score only considers those inquiries that were posted as a result of you actively seeking and applying for credit. Other types of inquiries, such as promotional inquiries (where a lender has pre-approved you for a credit offer) or consumer disclosure inquiries (where you have requested a copy of your own report) are not considered by the score.

In addition, the scores can identify rate shopping in the mortgage- and auto-lending environment, so that you are not penalized for inquiries related to one credit transaction.

Typically, the presence of inquiries on your credit file has only a small impact on FICO scores, carrying much less importance than delinquencies, current levels of indebtedness, and the length of time you have used credit. Thus, it is rare for this reason to appear in the top four codes for all but high scoring files. As time passes the age of your most recent inquiry will increase, and your score will rise as a result, provided you do not apply for additional credit in the meantime. Typically inquiries are purged from the credit bureau files after two years.

A common misperception is that every single inquiry will drop your score a certain number of points. This is not true. The impact of inquiries on your score will vary—depending on your overall credit profile. Inquiries will usually have a larger impact on the score for consumers with limited credit history and on consumers with previous late payment behavior. The most prudent action to raise your score over time is by applying for credit only when you need it.

K2 (30) Time Since Most Recent Account Opening is too Short

30, “Time Since Most Recent Account Opening is too Short”.

Research shows that consumers who have recently opened new credit accounts exhibit slightly higher risk of default than those who have not. This is not an especially strong risk factor, and therefore usually means the difference of no more than a few points in a consumers FICO score. As with many other elements of the FICO score, this part of the score will improve with time. To improve your score, avoid opening new credit accounts unless necessary. It is possible that opening additional new accounts may lower your score.

R2 (31) Too Few Accounts with Recent Payment Information

, “Too Few Accounts with Recent Payment Information”.

This reason may appear when the credit report shows a relative lack of credit repayment experience (i.e. credit history is short, or the number of successfully paid credit accounts is low). Research shows that consumers with more credit experience have better repayment risk than those with less experience. This reason may also appear when there is a derogatory public record, collection agency reference, or serious credit account delinquency on your report, and the number of credit accounts with recent activity being reported is low. In this case, in order to improve your credit rating you need to pay your bills on time. If you have missed payments, get caught up on back payments and stay current. The longer you pay your bills on time, the better your score.

A6 (31) Amount Owed on Delinquent Accounts

, “Amount Owed on Delinquent Accounts”.

This reason appears when there is evidence of recently missed payments on your credit report. The occurrence of late payments on existing credit accounts is a very powerful predictor of future repayment risk on your credit obligations. Research shows that the greater the balances on past due accounts, the higher the risk. In order to improve your credit rating you need to pay your bills on time. If you have missed payments, get caught up on back payments and stay current. The longer you pay your bills on time, the better your score. Note that closing an account on which a past due balance is still owed does not make it disappear from your credit report.

F7 (32) Lack of Recent Installment Loan Information

, Lack of Recent Installment Loan Information.

This reason appears when no installment loan accounts appear on the credit report, or all such accounts are closed, or are no longer being reported by the lender. The score evaluates the types of credit in your credit history and will consider your mix of credit cards, retail accounts, installment loans, finance company accounts and mortgage loans. It is not necessary to have one of each, and it is not a good idea to open credit accounts you have no need for, or don't intend to use. To improve your score you need to establish a credit history with several types of loan or account relationships and demonstrate that you can manage credit responsibly. Over time you will build a history which demonstrates your ability to manage different types of credit.

**P9 (33) Proportion of Loan Balances to Loan Amounts is too High

, “Proportion of Loan Balances to Loan Amounts is too High”.

Simply having installment loans and owing money on them does not mean you are a high-risk borrower. To the contrary, paying down installment loans is a good sign that you are able and willing to manage and repay debt, and evidence of successful repayment weighs favorably on your credit rating. The FICO score examines many aspects of your current installment loan and revolving balances. One measurement is to compare the total outstanding installment balances against the total original loan amounts. Generally, the closer the loans are to being fully paid off, the better the score. This is because research has shown that loans with more of their original balances remaining represent higher risk than loans which have been paid down more. Compared to other measurements of indebtedness, however, this has relatively limited influence on the FICO score. Your best strategy to improve your score is to pay down your installment loan or loans as quickly as possible.

A6 (34) Amount Owed on Delinquent Accounts

, “Amount Owed on Delinquent Accounts”.

This reason occurs when there is evidence of recently missed payments on your credit report. The occurrence of late payments on existing credit accounts is a very powerful predictor of future repayment risk on your credit obligations. Research shows that the greater the balances on past due accounts, the higher the risk. In order to improve your credit rating you need to pay your bills on time. If you have missed payments, get caught up on back payments and stay current. The longer you pay your bills on time, the better your score. Note that closing an account on which a past due balance is still owed does not make it disappear from your credit report.

J4 (36) Length of Time Open Installment Loans Have Been Established (I/O Only).

, Length of Time Open Installment Loans Have Been Established.

This reason is based on a measurement of the age of the open installment loan accounts on your credit report, i.e. the age of the oldest open loan, the average age of open installment loans, or both.). Research shows that consumers with longer credit histories have better repayment risk than those with shorter credit histories. Also, consumers who frequently open new accounts have greater repayment risk than those who do not. Therefore, only apply for needed credit and wait before you apply for more. All other factors being equal, your score is likely to improve as your credit history ages.

N0 (37) Number of Consumer Finance Company Accounts Established Relative to Length of Consumer Finance History

, “Number of Consumer Finance Company Accounts Established Relative to Length of Consumer Finance History”.

This reason is based on a measurement of the frequency at which you have opened new finance company loan accounts since your first finance company account was opened. (If only one finance company loan appears on your credit report, then this reason is based on how recently that account was opened.) Research shows that consumers who frequently open new accounts have greater repayment risk than those who do not. Therefore, only apply for needed credit and wait before you apply for more.

D8 (38) Serious Delinquency, and Public Record or Collection Filed

, Serious Delinquency, and Public Record or Collection Filed.

This reason occurs when there is a derogatory public record or collection agency reference, as well as one or more serious delinquencies on your credit accounts, appearing on your credit report. Research shows that consumers with previous late payment behavior are much more likely to exhibit similar behavior in the future. There is no quick fix to improve the score if the derogatory public record, collection item, or serious credit account delinquency appearing on your credit report is valid. However, as these age and fall off the credit report (derogatory public records, collection items, and credit account delinquencies stay on your report for up to seven years, with some bankruptcy records remaining for up to 10 years), their impact on the score will gradually decrease. Note that satisfying or paying off the collection item or derogatory public record will not result in this information being removed from your credit report. Research shows that the fact that it occurred is still predictive of future repayment risk, and thus it will still be considered by the score.

D7 (39) Serious Delinquency

, “Serious Delinquency”.

This reason appears when your credit report contains evidence of one or more serious delinquencies on your credit accounts. Research shows that consumers with previous late payment behavior are much more likely to exhibit similar behavior in the future. There is no quick fix to improve the score if the serious delinquency indicated on your credit report is valid. However, as these age and fall off the credit report (credit account delinquencies stay on your report for up to seven years), their impact on the score will gradually decrease.

D4 (40) Derogatory Public Record or Collection Filed

, Derogatory Public Record or Collection Filed.

This reason appears whenever there is derogatory public record or collection agency reference on your credit report. Research shows that consumers with previous late payment behavior are much more likely to exhibit similar behavior in the future. There is no quick fix to improve the score if the derogatory public record or collection item on your credit report is valid. However, as these age and fall off the credit report (derogatory public records and collection items stay on your report for up to seven years, with some bankruptcy records remaining for up to 10 years), their impact on the score will gradually decrease. Note that satisfying or paying off the collection item or derogatory public record will not result in this information being removed from your credit report. Research shows that the fact that it occurred is still predictive of future repayment risk, and thus it will still be considered by the score.

J3 (98) Length of Time Consumer Finance Company Loans Have Been Established

“Length of Time Consumer Finance Company Loans Have Been Established.

This reason is based on a measurement of the age of the finance company loan accounts on your credit report, i.e. the age of the oldest finance company loan, the average age of finance company loans, or both. Research shows that consumers with longer credit histories have better repayment risk than those with shorter credit histories. Also, consumers who frequently open new accounts have greater repayment risk than those who do not. Therefore, only apply for needed credit and wait before you apply for more. All other factors being equal, your score is likely to improve as your credit history ages.

F4 (97) Lack of Recent Auto Loan Information (I/O Only)

, Lack of Recent Auto Loan Information.

This reason appears when no auto loans are found on the credit report, or all such accounts are closed, or are no longer being reported by the lender. (Some banks or credit unions may not indicate auto loan on such loans when they report to the credit reporting agencies.) The score evaluates the types of credit in your credit history, and will consider your mix of credit cards, retail accounts, installment loans, finance company accounts and mortgage loans. It is not necessary to have one of each, and it is not a good idea to open credit accounts you have no need for, or don't intend to use. To improve your score you need to establish a credit history with several types of loan or account relationships and demonstrate that you can manage credit responsibly. Over time you will build a history which demonstrates your ability to manage different types of credit.

F3 (98) Lack of Recent Auto Finance Loan Information (I/O Only)

, Lack of Recent Auto Finance Loan Information.

This reason appears when no auto finance company loans (e.g. loans with lenders such as GMAC, Ford Motor Credit, Chrysler Financial Corp., etc.) are found on the credit report, or all such accounts are closed, or are no longer being reported by the lender. The score evaluates the types of credit in your credit history, and will consider your mix of credit cards, retail accounts, installment loans, finance company accounts and mortgage loans. It is not necessary to have one of each, and it is not a good idea to open credit accounts you have no need for, or don't intend to use. To improve your score you need to establish a credit history with several types of loan or account relationships and demonstrate that you can manage credit responsibly. Over time you will build a history which demonstrates your ability to manage different types of credit.

Summary Bullets

J6 (36) Length of Time Open Installment Loans Have Been Established

Only apply for needed credit and wait before you apply for more. All other factors being equal, your score is likely to improve as your credit history ages.

X0 (46) Payments Due on Accounts

You can improve your credit rating by paying off your debts. Consolidating or moving your debt around from one account to another will not, however, raise your score, since the same amount is still owed. The best advice is to pay off your debts as quickly as you can.

A3 (01) Amount Owed on Accounts is too High

You can improve your credit rating by paying off your debts. Consolidating or moving your debt around from one account to another will not, however, raise your score, since the same amount is still owed. The best advice is to pay off your debts as quickly as you can.

D6 (02) Level of Delinquency on Accounts

In order to improve your credit rating over time, you need to pay your bills on time. The longer you pay your bills on time, the better the score. If you have late payments, get caught up on back payments and stay current. As time passes the importance of these previous late payments will gradually lessen and the score will increase—as long as you make your payments on time on all of your credit obligations, and use your available credit responsibly.

R4 (03) Too Few Bank/National Revolving Accounts

To improve your score you need to establish a credit history with several types of loan or account relationships and demonstrate that you can manage credit responsibly. Over time you will build a history which demonstrates your ability to manage different types of credit.

P9 (03) Proportion of Loan Balances to Loan Amounts is too High

Your best strategy to improve your score is to pay down your installment loan or loans as quickly as possible.

T2 (04) Too Many Bank/National Revolving Accounts (EQX Only)

Avoid applying for credit you don't need, or don't intend to use. (Note that closing your existing bankcard accounts will not make them disappear from your credit report immediately; therefore, closing many or all of your bankcard accounts will probably not increase the score.) The best way to improve your credit rating is by managing ALL of your accounts responsibly, and not missing any payments.

F7 (04) Lack of Recent Installment Loan Information (XPN/TU Only)

To improve your score you need to establish a credit history with several types of loan or account relationships and demonstrate that you can manage credit responsibly. Over time you will build a history which demonstrates your ability to manage different types of credit.

T1 (05) Too Many Accounts with Balances

Paying off your debt is the best way to raise your score.

T3 (06) Too Many Consumer Finance Company Accounts

The best way to improve your credit rating is by managing all of your accounts responsibly, not missing any payments, and not opening new credit accounts you don't need.

A0 (07) Account Pay History is too New to Rate

To improve your score you need to establish a recent history of successfully repaying credit obligations, especially by keeping account balances low and making all payments on time.

T5 (08) Too Many Inquiries Last 12 Months

The most prudent action to raise your score over time is by applying for credit only when you need it.

T0 (09) Too Many Accounts Recently Opened

The best way to improve your credit rating is by responsibly managing all of your accounts, including newly opened accounts, and not missing any payments.

P5 (10) Proportion of Balances to Credit Limits on Bank/National Revolving or Other Revolving Accounts

Paying down your revolving account balances is a good sign that you are able and willing to manage and repay your debt, and this will increase your score. On the other hand, shifting balances among revolving accounts, opening up new revolving accounts, and closing down other revolving accounts will not necessarily improve your score, and could possibly decrease your score.

B5 (11) Amount Owed on Revolving Accounts is too High

You can improve your credit rating by paying off your debts. Consolidating or moving your debt around from one account to another will not, however, raise your score, since the same amount is still owed. The best advice is to pay off your debts as quickly as you can.

J8 (12) Length of Time Revolving Accounts Have Been Established

Only apply for needed credit and wait before you apply for more. All other factors being equal, your score is likely to improve as your credit history ages.

K0 (13) Time Since Delinquency is too Recent or Unknown

If you have late payments, get caught up on back payments and stay current. As time passes the importance of these previous late payments will gradually lessen and the score will increase—as long as you make your payments on time on all of your credit obligations, and use your available credit responsibly.

JO (14) Length of Time Accounts Have Been Established

Only apply for needed credit and wait before you apply for more. All other factors being equal, your score is likely to improve as your credit history ages.

F5 (15) Lack of Recent Bank/National Revolving Information

To improve your score you need to establish a credit history with several types of loan or account relationships and demonstrate that you can manage credit responsibly. Over time you will build a history which demonstrates your ability to manage different types of credit.

G1 (16) Lack of Recent Revolving Account Information

To improve your score you need to establish a credit history with several types of loan or account relationships and demonstrate that you can manage credit responsibly. Over time you will build a history which demonstrates your ability to manage different types of credit.

G4 (17) No Recent Non-Mortgage Balance Information

To improve your score you need to establish a recent history of successful credit usage, and demonstrate that you can manage credit responsibly.

M1 (18) Number of Accounts with Delinquency

It is important to pay all your credit obligations on time, in order to avoid any additional missed payments appearing on our credit report.

R0 (19) Too Few Accounts Currently Paid as Agreed

If you have missed payments, get caught up on back payments and stay current. The longer you pay your bills on time, the better your score

D1 (19) Date of Last Inquiry too Recent

The most prudent action to raise your score over time is by applying for credit only when you need it.

K1 (20) Time Since Derogatory Public Record or Collection is too Short

Your best course of action to improve your credit rating is to get caught up on back payments and stay current on all of your credit obligations. The longer you pay your bills on time, the better your score

B6 (21) Amount Past Due on Accounts

If you have missed payments, get caught up on back payments and stay current. The longer you pay your bills on time, the better your score. Note that closing an account on which a past due amount is still owed does not make it disappear from your credit report.

No New Mapping 22 SERIOUS Delinquency, Derogatory Public Record, or Collection Filed

There is no quick fix to improve the score if the derogatory public record, collection item, or serious credit account delinquency appearing on your credit report is valid. However, as these age and fall off the credit report, their impact on the score will gradually decrease. Note that satisfying or paying off a collection item or derogatory public record will not result in this information being removed from your credit report

M6 (23) Number of Bank/National Revolving Accounts with Balances

In order to improve your credit rating, pay down those credit card balances.

And once they are paid down, keep your balances lower on credit cards and other “revolving debt. Note that consolidating your debt by transferring balances from many cards onto fewer cards will not necessarily raise your score, because the same total amount is still owed. Paying off your debt is the best way to raise your score.

G6 (24) No Recent Revolving Balances

Demonstrating the ability to moderately and responsibly use revolving credit accounts will boost the score slightly.

J4 (25) Length of Time Installment Loans Have Been Established

Only apply for needed credit and wait before you apply for more. All other factors being equal, your score is likely to improve as your credit history ages.

M8 (26) Number of Bank/National Revolving or Other Revolving Accounts (I/O Only)

R0 (27) Too Few Accounts Currently Paid as Agreed

If you have missed payments, get caught up on back payments and stay current. The longer you pay your bills on time, the better your score

N2 (28) Number of Established Accounts

Avoid applying for credit you don't need, or don't intend to use. (Note that closing your existing accounts will not make them disappear from your credit report immediately.) The best way to improve your credit rating is by managing ALL of your accounts responsibly, and not missing any payments.

G3 (29) No Recent Bank/National Revolving Balances

Demonstrating the ability to moderately and responsibly use bank or national revolving accounts (e.g. Visa, MasterCard, Discover, American Express, Diners Club, etc.) will boost the score slightly.

D1 (29) Date of Last Inquiry too Recent

The most prudent action to raise your score over time is by applying for credit only when you need it.

K2 (30) Time Since Most Recent Account Opening is too Short

To improve your score, avoid opening new credit accounts unless necessary. It is possible that opening additional new accounts may lower your score.

R2 (31) Too Few Accounts with Recent Payment Information

In order to improve your credit rating you need to pay your bills on time. If you have missed payments, get caught up on back payments and stay current. The longer you pay your bills on time, the better your score.

A6 (31) Amount Owed on Delinquent Accounts

If you have missed payments, get caught up on back payments and stay current. The longer you pay your bills on time, the better your score. Note that closing an account on which a past due balance is still owed does not make it disappear from your credit report.

F7 (32) Lack of Recent Installment Loan Information

To improve your score you need to establish a credit history with several types of loan or account relationships and demonstrate that you can manage credit responsibly. Over time you will build a history which demonstrates your ability to manage different types of credit.

P9 (33) Proportion of Loan Balances to Loan Amounts is too High

Your best strategy to improve your score is to pay down your installment loan or loans as quickly as possible.

A6 (34) Amount Owed on Delinquent Accounts

If you have missed payments, get caught up on back payments and stay current. The longer you pay your bills on time, the better your score. Note that closing an account on which a past due balance is still owed does not make it disappear from your credit report.

J4 (36) Length of Time Open Installment Loans Have Been Established (I/O Only).

Only apply for needed credit and wait before you apply for more. All other factors being equal, your score is likely to improve as your credit history ages.

N0 (37) Number of Consumer Finance Company Accounts Established Relative to Length of Consumer Finance History

Only apply for needed credit and wait before you apply for more.

D8 (38) Serious Delinquency, and Public Record or Collection Filed

There is no quick fix to improve the score if the derogatory public record, collection item, or serious credit account delinquency appearing on your credit report is valid. However, as these age and fall off the credit report, their impact on the score will gradually decrease. Note that satisfying or paying off the collection item or derogatory public record will not result in this information being removed from your credit report

D7 (39) Serious Delinquency

There is no quick fix to improve the score if the serious delinquency indicated on your credit report is valid. However, as these age and fall off the credit report, their impact on the score will gradually decrease.

D4 (40) Derogatory Public Record or Collection Filed

There is no quick fix to improve the score if the derogatory public record or collection item on your credit report is valid. However, as these age and fall off the credit report, their impact on the score will gradually decrease. Note that satisfying or paying off the collection item or derogatory public record will not result in this information being removed from your credit report.

J3 (98) Length of Time Consumer Finance Company Loans Have Been Established

Only apply for needed credit and wait before you apply for more. All other factors being equal, your score is likely to improve as your credit history ages.

F4 (97) Lack of Recent Auto Loan Information (I/O Only)

To improve your score you need to establish a credit history with several types of loan or account relationships and demonstrate that you can manage credit responsibly. Over time you will build a history which demonstrates your ability to manage different types of credit.

F3 (98) Lack of Recent Auto Finance Loan Information (I/O Only)

To improve your score you need to establish a credit history with several types of loan or account relationships and demonstrate that you can manage credit responsibly. Over time you will build a history which demonstrates your ability to manage different types of credit.

### Exemplary Implementation

The Following Tables Providea Detailed Description of an Exemplary Implementaion fo the Invention.

List of Tables Contained Below

Substitution Labels (Table B).

Primary Explanations Table (Table C).

Per Bureau Reason Code Mapping (Table D).

Expanded Reason Explanations (Table E).

Overview of Tables

The body of the analysis begins with “{Main}”, which is retrieved from the Primary Explanations Table. Based on the value of its Associated Key (Num of Reasons), the appropriate text block is selected for the body of the explanation under construction. This text block is then scanned for further instructions, in the form of “{<label>}” or “#<keyword>#”, to conditionally introduce additional text blocks in place of the token. Labels are replaced with text blocks from the Primary Explanations Table, conditioned on the value of their Associated Keys in comparison to the Key Value. Keyword substations are supplied by the environment (e.g., “DATE”), or from other tables. Keywords of the form “CODEx”, “REASONx”, “FRIENDLYx”, for example, invoke look-ups in the Expanded Reason Explanations and Per Bureau Reason Code Mapping tables. This process continues recursively until all “{<label>}” and “#<keyword>#” tokens have been exhausted. Note that the text blocks are Hyper Text Markup Language (HTML) fragments, and include instructions for the display of conditionally chosen graphics files to aid in the explanation.

TABLE B
Substitution Labels

| Label | Associated Key |
|---|---|
| Bar Charts | Score |
| CB Mark | Bureau |
| CB Name | Bureau |
| Contact CB | Score |
| Lenders View | Score |
| Main | Num of Reasons |
| No Code Kick | Score |
| Odds Better | Score |
| Odds Worse | Score |
| Percentile | Score |
| Percentile Graph | Score |
| Reason Set | Num of Reasons |
| Risk Likelihood | Score |
| Score Group Intro | Score |
| Score Group Summary | Score |
| Score Name | Bureau |
| Score Name Article | Bureau |
| Score Name Unreg | Bureau |
| Score Qualifier | Score |

TABLE C
Primary Explanations Table

| | | |
|---|---|---|
| | Key | |
| Label | Value | Explanation Text |

| Bar Charts | 0.000000 | <img src=../images/bi1.gif width=430 |
|---|---|---|
| | | height=176><br><blockquote><b>Distribution.</b> <font |
| | | color=##333333>This chart shows the percentage of people who |
| | | score in specific FICO score ranges. For example, about 20% of |
| | | U.S. consumers have a FICO score between 700 and 749. Your |
| | | score of #SCORE# places you in the “up to 499” range, along with |
| | | 1% of the total population. (Note that the score ranges shown |
| | | above are provided for your information, but they do not |
| | | necessarily correspond to any particular lender's policies for |
| | | extending credit.)</font></blockquote><br><br><img |
| | | src=../images/br87.gif width=430 |
| | | height=171><br><blockquote><b>Credit repayment.</b> <font |
| | | color=##333333>The second chart demonstrates the delinquency |
| | | rate (or credit risk) associated with selected ranges of the FICO |
| | | score. In this illustration, the delinquency rate is the percentage of |
| | | borrowers who reach 90 days past due or worse on any credit |
| | | account over a two-year period. For example, the delinquency rate |
| | | of consumers in the 700-749 range is 5%. This means that for |
| | | every 100 borrowers in this range, approximately five will default |
| | | on a loan, file for bankruptcy, or fall 90 days past due on at least |
| | | one credit account in the next two years. As a group, the |
| | | consumers in your score range (up to 499) have a delinquency rate |
| | | of 87%.</font></blockquote><br> |
| Bar Charts | 500.000000 | <img src=../images/bi5.gif width=430 |
| | | height=176><br><blockquote><b>Distribution.</b> <font |
| | | color=##333333>This chart shows the percentage of people who |
| | | score in specific FICO score ranges. For example, about 20% of |
| | | U.S. consumers have a FICO score between 700 and 749. Your |
| | | score of #SCORE# places you in the 500-549 range, along with |
| | | 5% of the total population. (Note that the score ranges shown |
| | | above are provided for your information, but they do not |
| | | necessarily correspond to any particular lender's policies for |
| | | extending credit.)</font></blockquote><br><br><img |
| | | src=../images/br71.gif width=430 |
| | | height=171><br><blockquote><b>Credit repayment.</b> <font |
| | | color=##333333>The second chart demonstrates the delinquency |
| | | rate (or credit risk) associated with selected ranges of the FICO |
| | | score. In this illustration, the delinquency rate is the percentage of |
| | | borrowers who reach 90 days past due or worse on any credit |
| | | account over a two-year period. For example, the delinquency rate |
| | | of consumers in the 700-749 range is 5%. This means that for |
| | | every 100 borrowers in this range, approximately five will default |
| | | on a loan, file for bankruptcy, or fall 90 days past due on at least |
| | | one credit account in the next two years. As a group, the |
| | | consumers in your score range, 500-549, have a delinquency rate |
| | | of 71%.</font></blockquote><br> |
| Bar Charts | 550.000000 | <img src=../images/bi7.gif width=430 |
| | | height=176><br><blockquote><b>Distribution.</b> <font |
| | | color=##333333>This chart shows the percentage of people who |
| | | score in specific FICO score ranges. For example, about 20% of |
| | | U.S. consumers have a FICO score between 700 and 749. Your |
| | | score of #SCORE# places you in the 550-599 range, along with |
| | | 7% of the total population. (Note that the score ranges shown |
| | | above are provided for your information, but they do not |
| | | necessarily correspond to any particular lender's policies for |
| | | extending credit.)</font></blockquote><br><br><img |
| | | src=../images/br51.gif width=430 |
| | | height=171><br><blockquote><b>Credit repayment.</b> <font |
| | | color=##333333>The second chart demonstrates the delinquency |
| | | rate (or credit risk) associated with selected ranges of the FICO |
| | | score. In this illustration, the delinquency rate is the percentage of |
| | | borrowers who reach 90 days past due or worse on any credit |
| | | account over a two-year period. For example, the delinquency rate |
| | | of consumers in the 700-749 range is 5%. This means that for |
| | | every 100 borrowers in this range, approximately five will default |
| | | on a loan, file for bankruptcy, or fall 90 days past due on at least |
| | | one credit account in the next two years. As a group, the |
| | | consumers in your score range, 550-599, have a delinquency rate |
| | | of 51%.</font></blockquote><br> |
| Bar Charts | 600.000000 | <img src=../images/bi11.gif width=430 |
| | | height=176><br><blockquote><b>Distribution.</b> <font |
| | | color=##333333>This chart shows the percentage of people who |
| | | score in specific FICO score ranges. For example, about 20% of |
| | | U.S. consumers have a FICO score between 700 and 749. Your |
| | | score of #SCORE# places you in the 600-649 range, along with |
| | | 11% of the total population. (Note that the score ranges shown |
| | | above are provided for your information, but they do not |
| | | necessarily correspond to any particular lender's policies for |
| | | extending credit.)</font></blockquote><br><br><img |
| | | src=../images/br31.gif width=430 |
| | | height=171><br><blockquote><b>Credit repayment.</b> <font |
| | | color=##333333>The second chart demonstrates the delinquency |
| | | rate (or credit risk) associated with selected ranges of the FICO |
| | | score. In this illustration, the delinquency rate is the percentage of |
| | | borrowers who reach 90 days past due or worse on any credit |
| | | account over a two-year period. For example, the delinquency rate |
| | | of consumers in the 700-749 range is 5%. This means that for |
| | | every 100 borrowers in this range, approximately five will default |
| | | on a loan, file for bankruptcy, or fall 90 days past due on at least |
| | | one credit account in the next two years. As a group, the |
| | | consumers in your score range, 600-649, have a delinquency rate |
| | | of 31%.</font></blockquote><br> |
| Bar Charts | 650.000000 | <img src=../images/bi16.gif width=430 |
| | | height=176><br><blockquote><b>Distribution.</b> <font |
| | | color=##333333>This chart shows the percentage of people who |
| | | score in specific FICO score ranges. For example, about 5% of |
| | | U.S. consumers have a FICO score between 500 and 549. Your |
| | | score of #SCORE# places you in the 650-699 range, along with |
| | | 16% of the total population. (Note that the score ranges shown |
| | | above are provided for your information, but they do not |
| | | necessarily correspond to any particular lender's policies for |
| | | extending credit.)</font></blockquote><br><br><img |
| | | src=../images/br15.gif width=430 |
| | | height=171><br><blockquote><b>Credit repayment.</b> <font |
| | | color=##333333>The second chart demonstrates the delinquency |
| | | rate (or credit risk) associated with selected ranges of the FICO |
| | | score. In this illustration, the delinquency rate is the percentage of |
| | | borrowers who reach 90 days past due or worse on any credit |
| | | account over a two-year period. For example, the delinquency rate |
| | | of consumers in the 500-549 range is 71%. This means that for |
| | | every 100 borrowers in this range, approximately 71 will default |
| | | on a loan, file for bankruptcy, or fall 90 days past due on at least |
| | | one credit account in the next two years. As a group, the |
| | | consumers in your score range, 650-699, have a delinquency rate |
| | | of 15%.</font></blockquote><br> |
| Bar Charts | 700.000000 | <img src=../images/bi20.gif width=430 |
| | | height=176><br><blockquote><b>Distribution.</b> <font |
| | | color=##333333>This chart shows the percentage of people who |
| | | score in specific FICO score ranges. For example, about 5% of |
| | | U.S. consumers have a FICO score between 500 and 549. Your |
| | | score of #SCORE# places you in the 700-749 range, along with |
| | | 20% of the total population. (Note that the score ranges shown |
| | | above are provided for your information, but they do not |
| | | necessarily correspond to any particular lender's policies for |
| | | extending credit.)</font></blockquote><br><br><img |
| | | src=../images/br5.gif width=430 |
| | | height=171><br><blockquote><b>Credit repayment.</b> <font |
| | | color=##333333>The second chart demonstrates the delinquency |
| | | rate (or credit risk) associated with selected ranges of the FICO |
| | | score. In this illustration, the delinquency rate is the percentage of |
| | | borrowers who reach 90 days past due or worse on any credit |
| | | account over a two-year period. For example, the delinquency rate |
| | | of consumers in the 500-549 range is 71%. This means that for |
| | | every 100 borrowers in this range, approximately 71 will default |
| | | on a loan, file for bankruptcy, or fall 90 days past due on at least |
| | | one credit account in the next two years. As a group, the |
| | | consumers in your score range, 700-749, have a delinquency rate |
| | | of 5%.</font></blockquote><br> |
| Bar Charts | 750.000000 | <img src=../images/bi29.gif width=430 |
| | | height=176><br><blockquote><b>Distribution.</b> <font |
| | | color=##333333>This chart shows the percentage of people who |
| | | score in specific FICO score ranges. For example, about 5% of |
| | | U.S. consumers have a FICO score between 500 and 549. Your |
| | | score of #SCORE# places you in the 750-799 range, along with |
| | | 29% of the total population. (Note that the score ranges shown |
| | | above are provided for your information, but they do not |
| | | necessarily correspond to any particular lender's policies for |
| | | extending credit.)</font></blockquote><br><br><img |
| | | src=../images/br2.gif width=430 |
| | | height=171><br><blockquote><b>Credit repayment.</b> <font |
| | | color=##333333>The second chart demonstrates the delinquency |
| | | rate (or credit risk) associated with selected ranges of the FICO |
| | | score. In this illustration, the delinquency rate is the percentage of |
| | | borrowers who reach 90 days past due or worse on any credit |
| | | account over a two-year period. For example, the delinquency rate |
| | | of consumers in the 500-549 range is 71%. This means that for |
| | | every 100 borrowers in this range, approximately 71 will default |
| | | on a loan, file for bankruptcy, or fall 90 days past due on at least |
| | | one credit account in the next two years. As a group, the |
| | | consumers in your score range, 750-799, have a delinquency rate |
| | | of just 2%.</font></blockquote><br> |
| Bar Charts | 800.000000 | <img src=../images/bi11r.gif width=430 |
| | | height=176><br><blockquote><b>Distribution.</b> <font |
| | | color=##333333>This chart shows the percentage of people who |
| | | score in specific FICO score ranges. For example, about 5% of |
| | | U.S. consumers have a FICO score between 500 and 549. Your |
| | | score of #SCORE# places you in the 800+ range, along with 11% |
| | | of the total population. (Note that the score ranges shown above |
| | | are provided for your information, but they do not necessarily |
| | | correspond to any particular lender's policies for extending |
| | | credit.)</font></blockquote><br><br><img src=../images/br1.gif |
| | | width=430 height=171><br><blockquote><b>Credit |
| | | repayment.</b> <font color=##333333>The second chart |
| | | demonstrates the delinquency rate (or credit risk) associated with |
| | | selected ranges of the FICO score. In this illustration, the |
| | | delinquency rate is the percentage of borrowers who reach 90 days |
| | | past due or worse on any credit account over a two-year period. |
| | | For example, the delinquency rate of consumers in the 500-549 |
| | | range is 71%. This means that for every 100 borrowers in this |
| | | range, approximately 71 will default on a loan, file for bankruptcy, |
| | | or fall 90 days past due on at least one credit account in the next |
| | | two years. As a group, the consumers in your score range, 800+, |
| | | have a delinquency rate of just 1%.</font></blockquote><br> |
| CB Mark | 1.000000 | EMPIRICA is a registered trademark of Trans Union, LLC. |
| CB Mark | 2.000000 | BEACON is a registered trademark of Equifax, Inc. |
| CB Mark | 3.000000 | |
| CB Name | 1.000000 | Trans Union, LLC |
| CB Name | 2.000000 | Equifax |
| CB Name | 3.000000 | Experian |
| Contact CB | 0.000000 | Review your credit bureau report from each credit reporting |
| | | agency at least once a year and especially before making a large |
| | | purchase, like a house or a car. You should make sure the |
| | | information in your credit bureau report is correct. You don't need |
| | | to be concerned if the balance doesn't exactly match your credit |
| | | card statement. But you do need to worry if the credit bureau |
| | | report includes late payments that you believe are in error. And |
| | | you should verify that the accounts listed on your credit bureau |
| | | report are accounts that you own. Your credit score is based on |
| | | your credit bureau report, and lenders also review this information |
| | | when making credit decisions.<br><br>If you feel that the |
| | | information contained in your credit bureau report is not accurate, |
| | | you should contact the credit reporting agencies |
| | | directly:<br><blockquote>Equifax: (800) 685-1111 |
| | | <i>www.equifax.com</i><br>Experian: (888) 397-3742 |
| | | <i>www.experian.com</i><br> Trans Union: (800) 916-8800 |
| | | <i>www.transunion.com</i></blockquote><br><br>Fair, |
| | | Isaac, FICO and FICO Guide are trademarks or registered |
| | | trademarks of Fair, Isaac and Company, Inc. in the United States |
| | | and/or other countries. {CB Mark}<br><br><b>Copyright © |
| | | 2000 Fair, Isaac and Co., Inc. All rights reserved.</b> |
| Lenders | 0.000000 | <b>How lenders view your FICO score</b><br>Many lenders use |
| View | | FICO scores as one method to estimate the risk associated with an |
| | | individual's application for credit. Simply put, the higher the |
| | | score, the lower the risk. People with high FICO scores are |
| | | proven to repay loans and credit cards more consistently than |
| | | people with low FICO scores. And although the scores are |
| | | remarkably accurate, no one can predict with certainty whether or |
| | | not you will repay a credit account.<br><br>Frequently, there is |
| | | more to consider in a credit decision than just a person's credit |
| | | history. Because the FICO score is based solely on the |
| | | information in your credit bureau report, many lenders bring other |
| | | factors into their decisions as well, such as your income or |
| | | employment history. So the FICO score itself, while important, is |
| | | by no means the only factor on which your credit application is |
| | | evaluated. It is also important to understand that every lender sets |
| | | their own policies and tolerance for risk when making decisions. |
| | | Though many lenders incorporate FICO scores into their |
| | | decisions, there is certainly no single “cutoff score” used by all |
| | | lenders. In fact, since they often consider additional information |
| | | or special circumstances, some lenders may extend you credit even |
| | | if your score is low, or decline your request although your score is |
| | | high. Nonetheless, the FICO score is the most widely used and |
| | | recognized credit rating, so it's important that you know and |
| | | understand your own score.<br> |
| Main | 0.000000 | <b>FICO Guide<sup>TM</sup> Analysis</b> |
| | | <i>#DATE#</i><br><br><b>CreditScore:</b> |
| | | #SCORE#<br><b>Source of score:</b> {CB Name} ({Score |
| | | Name})<br><b>Reason codes:</b> (none)<br><br><b>Your |
| | | {Score Name Unreg} score: #SCORE#</b><br>The information |
| | | in your {CB Name} credit bureau report has been summarized in |
| | | {Score Name Article} {Score Name} score of #SCORE#. Most |
| | | U.S. consumers score between 300 and 850. Generally, the higher |
| | | your score, the more favorably a lender will view your application |
| | | for credit. Compared to the national population, you are in the |
| | | {Percentile} percentile of consumers by credit risk. A score of |
| | | #SCORE# is {Score Qualifier} average. {Risk |
| | | Likelihood} <br><br> {Percentile Graph} <br><br>{Lenders |
| | | View}<br><p class=page></p>{Score Group |
| | | Intro}<br><br>{Bar Charts}<br><br>{Reason Set}<br> |
| | | {Contact CB} |
| Main | 1.000000 | <b>FICO Guide<sup>TM</sup> Analysis</b> |
| | | <i>#DATE#</i><br><br><b>Credit Score:</b> |
| | | #SCORE#<br><b>Source of score:</b> {CB Name} ({Score |
| | | Name})<br><b>Reason codes:</b> #CODE1#<br><br><b>Your |
| | | {Score Name Unreg} score: #SCORE#</b><br>The information |
| | | in your {CB Name} credit bureau report has been summarized in |
| | | {Score Name Article} {Score Name} score of #SCORE#. Most |
| | | U.S. consumers score between 300 and 850. Generally, the higher |
| | | your score, the more favorably a lender will view your application |
| | | for credit. Compared to the national population, you are in the |
| | | {Percentile} percentile of consumers by credit risk. A score of |
| | | #SCORE# is {Score Qualifier} average. {Risk |
| | | Likelihood}<br><br>{Percentile Graph} <br><br>{Lenders |
| | | View}<br><p class=page></p>{Score Group |
| | | Intro}<br><br>{Bar Charts}<br><br>{Reason Set}<br> |
| | | {Contact CB} |
| Main | 2.000000 | <b>FICO Guide<sup>TM</sup> Analysis</b> |
| | | <i>#DATE#</i><br><br><b>CreditScore:</b> |
| | | #SCORE#<br><b>Source of score:</b> {CB Name} ({Score |
| | | Name})<br><b>Reason codes:</b> #CODE1# #CODE2#<br><br><b>Your |
| | | {Score Name Unreg) score: #SCORE#</b><br>The information |
| | | in your {CB Name} credit bureau report has been summarized in |
| | | {Score Name Article} {Score Name} score of #SCORE#. Most |
| | | U.S. consumers score between 300 and 850. Generally, the higher |
| | | your score, the more favorably a lender will view your application |
| | | for credit. Compared to the national population, you are in the |
| | | {Percentile} percentile of consumers by credit risk. A score of |
| | | #SCORE# is {Score Qualifier} average. {Risk |
| | | Likelihood}<br><br>{Percentile Graph}<br><br>{Lenders |
| | | View}<br><p class=page></p>{Score Group |
| | | Intro}<br><br>{Bar Charts}<br><br>{Reason Set}<br> |
| | | {Contact CB} |
| Main | 3.000000 | <b>FICO Guide<sup>TM</sup> Analysis</b> |
| | | <i>#DATE#</i><br><br><b>CreditScore:</b> |
| | | #SCORE#<br><b>Source of score:</b> {CB Name} ({Score |
| | | Name})<br><b>Reason codes:</b> #CODE1# #CODE2# |
| | | #CODE3#<br><br><b>Your {Score Name Unreg} score: |
| | | #SCORE#</b><br>The information in your {CB Name} credit |
| | | bureau report has been summarized in {Score Name Article} |
| | | {Score Name} score of #SCORE#. Most U.S. consumers score |
| | | between 300 and 850. Generally, the higher your score, the more |
| | | favorably a lender will view your application for credit. |
| | | Compared to the national population, you are in the {Percentile} |
| | | percentile of consumers by credit risk. A score of #SCORE# is |
| | | {Score Qualifier} average. {Risk |
| | | Likelihood}<br><br>{Percentile Graph}<br><br>{Lenders |
| | | View}<br><p class=page></p>{Score Group |
| | | Intro}<br><br>{Bar Charts}<br><br>{Reason Set}<br> |
| | | {Contact CB} |
| Main | 4.000000 | <b>FICO Guide<sup>TM</sup> Analysis</b> |
| | | <i>#DATE#</i><br><br><b>CreditScore:</b> |
| | | #SCORE#<br><b>Source of score:</b> {CB Name} ({Score |
| | | Name})<br><b>Reason codes:</b> #CODE1# #CODE2# |
| | | #CODE3# #CODE4#<br><br><b>Your {Score Name Unreg} |
| | | score: #SCORE#</b><br>The information in your {CB Name} |
| | | credit bureau report has been summarized in {Score Name |
| | | Article} {Score Name} score of #SCORE#. Most U.S. consumers |
| | | score between 300 and 850. Generally, the higher your score, the |
| | | more favorably a lender will view your application for credit. |
| | | Compared to the national population, you are in the {Percentile} |
| | | percentile of consumers by credit risk. A score of #SCORE# is |
| | | {Score Qualifier} average. {Risk |
| | | Likelihood}<br><br>{Percentile Graph}<br><br>{Lenders |
| | | View}<br><p class=page></p>{Score Group |
| | | Intro}<br><br>{Bar Charts}<br><br>{Reason Set}<br> |
| | | {Contact CB} |
| No Code | 0.000000 | As your score is not exceptionally high, the latter is the more |
| Kick | | probable explanation. |
| No Code | 700.000000 | Your score is quite high, but it is usually the case that even scores |
| Kick | | this high are accompanied by at least one or two reason codes. If |
| | | possible, you might wish to examine the credit bureau report that |
| | | includes your FICO score and search for reason codes which will |
| | | give you an idea of the top factors affecting your score. Even so, |
| | | based on your strong FICO score, your credit history is very good. |
| No Code | 760.000000 | Your score is exceptionally high, so it is most likely that no factors |
| Kick | | were returned with the FICO score. Nothing in your credit bureau |
| | | report suggests that you might be a credit risk to lenders. |
| Odds Better | 730.000000 | 1.05 |
| Odds Better | 735.000000 | 1.16 |
| Odds Better | 740.000000 | 1.28 |
| Odds Better | 745.000000 | 1.41 |
| Odds Better | 750.000000 | 1.56 |
| Odds Better | 755.000000 | 1.72 |
| Odds Better | 760.000000 | 1.90 |
| Odds Better | 765.000000 | 2.10 |
| Odds Better | 770.000000 | 2.32 |
| Odds Better | 775.000000 | 2.56 |
| Odds Better | 780.000000 | 2.83 |
| Odds Better | 785.000000 | 3.12 |
| Odds Better | 790.000000 | 3.45 |
| Odds Better | 795.000000 | 3.81 |
| Odds Better | 800.000000 | 4.20 |
| Odds Better | 805.000000 | 4.64 |
| Odds Better | 810.000000 | 5.12 |
| Odds Better | 815.000000 | 5.66 |
| Odds Better | 820.000000 | 6.25 |
| Odds Better | 825.000000 | 6.90 |
| Odds Better | 830.000000 | 7.61 |
| Odds Better | 835.000000 | 8.41 |
| Odds Better | 840.000000 | 9.28 |
| Odds Better | 845.000000 | 10.2 |
| Odds Better | 850.000000 | 11.3 |
| Odds Better | 855.000000 | 12.5 |
| Odds Better | 860.000000 | 13.8 |
| Odds Better | 865.000000 | 15.2 |
| Odds Better | 870.000000 | 16.8 |
| Odds Better | 875.000000 | 18.6 |
| Odds Better | 880.000000 | 20.5 |
| Odds Better | 885.000000 | 22.6 |
| Odds Better | 890.000000 | 25.0 |
| Odds Better | 895.000000 | 27.6 |
| Odds Better | 900.000000 | 30.5 |
| Odds Better | 905.000000 | 33.6 |
| Odds Better | 910.000000 | 37.1 |
| Odds Better | 915.000000 | 41.0 |
| Odds Better | 920.000000 | 45.3 |
| Odds Better | 925.000000 | 50.0 |
| Odds Better | 930.000000 | 55.2 |
| Odds Better | 935.000000 | 60.9 |
| Odds Better | 940.000000 | 67.2 |
| Odds Better | 945.000000 | 74.2 |
| Odds Better | 950.000000 | 82.0 |
| Odds Worse | 250.000000 | 12800 |
| Odds Worse | 255.000000 | 11600 |
| Odds Worse | 260.000000 | 10500 |
| Odds Worse | 265.000000 | 9500 |
| Odds Worse | 270.000000 | 8610 |
| Odds Worse | 275.000000 | 7800 |
| Odds Worse | 280.000000 | 7060 |
| Odds Worse | 285.000000 | 6400 |
| Odds Worse | 290.000000 | 5790 |
| Odds Worse | 295.000000 | 5250 |
| Odds Worse | 300.000000 | 4750 |
| Odds Worse | 305.000000 | 4300 |
| Odds Worse | 310.000000 | 3900 |
| Odds Worse | 315.000000 | 3530 |
| Odds Worse | 320.000000 | 3200 |
| Odds Worse | 325.000000 | 2900 |
| Odds Worse | 330.000000 | 2620 |
| Odds Worse | 335.000000 | 2380 |
| Odds Worse | 340.000000 | 2150 |
| Odds Worse | 345.000000 | 1950 |
| Odds Worse | 350.000000 | 1770 |
| Odds Worse | 355.000000 | 1600 |
| Odds Worse | 360.000000 | 1450 |
| Odds Worse | 370.000000 | 1190 |
| Odds Worse | 375.000000 | 1080 |
| Odds Worse | 380.000000 | 975 |
| Odds Worse | 385.000000 | 883 |
| Odds Worse | 390.000000 | 799 |
| Odds Worse | 395.000000 | 724 |
| Odds Worse | 400.000000 | 656 |
| Odds Worse | 405.000000 | 594 |
| Odds Worse | 410.000000 | 538 |
| Odds Worse | 415.000000 | 487 |
| Odds Worse | 420.000000 | 441 |
| Odds Worse | 425.000000 | 400 |
| Odds Worse | 430.000000 | 362 |
| Odds Worse | 435.000000 | 328 |
| Odds Worse | 440.000000 | 297 |
| Odds Worse | 445.000000 | 269 |
| Odds Worse | 450.000000 | 244 |
| Odds Worse | 455.000000 | 221 |
| Odds Worse | 460.000000 | 200 |
| Odds Worse | 465.000000 | 181 |
| Odds Worse | 470.000000 | 164 |
| Odds Worse | 475.000000 | 148 |
| Odds Worse | 480.000000 | 134 |
| Odds Worse | 485.000000 | 122 |
| Odds Worse | 490.000000 | 110 |
| Odds Worse | 495.000000 | 99.9 |
| Odds Worse | 500.000000 | 90.5 |
| Odds Worse | 505.000000 | 82.0 |
| Odds Worse | 510.000000 | 74.2 |
| Odds Worse | 515.000000 | 67.2 |
| Odds Worse | 520.000000 | 60.9 |
| Odds Worse | 525.000000 | 55.2 |
| Odds Worse | 530.000000 | 50.0 |
| Odds Worse | 535.000000 | 45.3 |
| Odds Worse | 540.000000 | 41.0 |
| Odds Worse | 545.000000 | 37.1 |
| Odds Worse | 550.000000 | 33.6 |
| Odds Worse | 555.000000 | 30.5 |
| Odds Worse | 560.000000 | 27.6 |
| Odds Worse | 565.000000 | 25.0 |
| Odds Worse | 575.000000 | 20.5 |
| Odds Worse | 580.000000 | 18.6 |
| Odds Worse | 585.000000 | 16.8 |
| Odds Worse | 590.000000 | 15.2 |
| Odds Worse | 595.000000 | 13.8 |
| Odds Worse | 600.000000 | 12.5 |
| Odds Worse | 605.000000 | 11.3 |
| Odds Worse | 610.000000 | 10.2 |
| Odds Worse | 615.000000 | 9.28 |
| Odds Worse | 620.000000 | 8.41 |
| Odds Worse | 625.000000 | 7.61 |
| Odds Worse | 630.000000 | 6.90 |
| Odds Worse | 635.000000 | 6.25 |
| Odds Worse | 640.000000 | 5.66 |
| Odds Worse | 645.000000 | 5.12 |
| Odds Worse | 650.000000 | 4.64 |
| Odds Worse | 655.000000 | 4.20 |
| Odds Worse | 660.000000 | 3.81 |
| Odds Worse | 665.000000 | 3.45 |
| Odds Worse | 670.000000 | 3.12 |
| Odds Worse | 675.000000 | 2.83 |
| Odds Worse | 680.000000 | 2.56 |
| Odds Worse | 685.000000 | 2.32 |
| Odds Worse | 690.000000 | 2.10 |
| Odds Worse | 695.000000 | 1.90 |
| Odds Worse | 700.000000 | 1.72 |
| Odds Worse | 705.000000 | 1.56 |
| Odds Worse | 710.000000 | 1.41 |
| Odds Worse | 715.000000 | 1.28 |
| Odds Worse | 720.000000 | 1.16 |
| Odds Worse | 725.000000 | 1.05 |
| Percentile | 0.000000 | 1st |
| Percentile | 490.000000 | 1st |
| Percentile | 508.000000 | 2nd |
| Percentile | 521.000000 | 3rd |
| Percentile | 532.000000 | 4th |
| Percentile | 541.000000 | 5th |
| Percentile | 549.000000 | 6th |
| Percentile | 557.000000 | 7th |
| Percentile | 565.000000 | 8th |
| Percentile | 572.000000 | 9th |
| Percentile | 579.000000 | 10th |
| Percentile | 586.000000 | 11th |
| Percentile | 592.000000 | 12th |
| Percentile | 598.000000 | 13th |
| Percentile | 604.000000 | 14th |
| Percentile | 609.000000 | 15th |
| Percentile | 614.000000 | 16th |
| Percentile | 619.000000 | 17th |
| Percentile | 623.000000 | 18th |
| Percentile | 628.000000 | 19th |
| Percentile | 632.000000 | 20th |
| Percentile | 636.000000 | 21st |
| Percentile | 640.000000 | 22nd |
| Percentile | 644.000000 | 23rd |
| Percentile | 648.000000 | 24th |
| Percentile | 651.000000 | 25th |
| Percentile | 655.000000 | 26th |
| Percentile | 659.000000 | 27th |
| Percentile | 662.000000 | 28th |
| Percentile | 665.000000 | 29th |
| Percentile | 669.000000 | 30th |
| Percentile | 672.000000 | 31st |
| Percentile | 675.000000 | 32nd |
| Percentile | 678.000000 | 33rd |
| Percentile | 682.000000 | 34th |
| Percentile | 685.000000 | 35th |
| Percentile | 688.000000 | 36th |
| Percentile | 691.000000 | 37th |
| Percentile | 694.000000 | 38th |
| Percentile | 697.000000 | 39th |
| Percentile | 700.000000 | 40th |
| Percentile | 703.000000 | 41st |
| Percentile | 706.000000 | 42nd |
| Percentile | 708.000000 | 43rd |
| Percentile | 711.000000 | 44th |
| Percentile | 714.000000 | 45th |
| Percentile | 717.000000 | 46th |
| Percentile | 719.000000 | 47th |
| Percentile | 722.000000 | 48th |
| Percentile | 724.000000 | 49th |
| Percentile | 727.000000 | 50th |
| Percentile | 732.000000 | 52nd |
| Percentile | 734.000000 | 53rd |
| Percentile | 736.000000 | 54th |
| Percentile | 739.000000 | 55th |
| Percentile | 741.000000 | 56th |
| Percentile | 743.000000 | 57th |
| Percentile | 745.000000 | 58th |
| Percentile | 748.000000 | 59th |
| Percentile | 750.000000 | 60th |
| Percentile | 752.000000 | 61st |
| Percentile | 754.000000 | 62nd |
| Percentile | 756.000000 | 63rd |
| Percentile | 758.000000 | 64th |
| Percentile | 760.000000 | 65th |
| Percentile | 762.000000 | 66th |
| Percentile | 763.000000 | 67th |
| Percentile | 765.000000 | 68th |
| Percentile | 767.000000 | 69th |
| Percentile | 769.000000 | 70th |
| Percentile | 771.000000 | 71st |
| Percentile | 772.000000 | 72nd |
| Percentile | 774.000000 | 73rd |
| Percentile | 776.000000 | 74th |
| Percentile | 778.000000 | 75th |
| Percentile | 780.000000 | 76th |
| Percentile | 781.000000 | 77th |
| Percentile | 783.000000 | 78th |
| Percentile | 784.000000 | 79th |
| Percentile | 786.000000 | 80th |
| Percentile | 788.000000 | 81st |
| Percentile | 789.000000 | 82nd |
| Percentile | 791.000000 | 83rd |
| Percentile | 792.000000 | 84th |
| Percentile | 794.000000 | 85th |
| Percentile | 795.000000 | 86th |
| Percentile | 797.000000 | 87th |
| Percentile | 799.000000 | 88th |
| Percentile | 800.000000 | 89th |
| Percentile | 802.000000 | 90th |
| Percentile | 803.000000 | 91st |
| Percentile | 805.000000 | 92nd |
| Percentile | 807.000000 | 93rd |
| Percentile | 809.000000 | 94th |
| Percentile | 811.000000 | 95th |
| Percentile | 814.000000 | 96th |
| Percentile | 817.000000 | 97th |
| Percentile | 820.000000 | 98th |
| Percentile | 826.000000 | 99th |
| Percentile | 843.000000 | 100th |

| | | |
|---|---|---|
| Percentile | 0.000000 | <img src=../images/p1.gif height=126 |
| Graph | | width=430><br><blockquote><b>Understanding your |
| | | percentile.</b> <font color=##333333>Compared to the national |
| | | population, your FICO&reg; score is in the 1st percentile. This |
| | | means that roughly 1% of consumers have scores lower than or |
| | | equal to your own score, and 99% have scores which are |
| | | higher.</b></font></blockquote> |
| Percentile | 490.000000 | <img src=../images/p1.gif height=126 |
| Graph | | width=430><br><blockquote><b>Understanding your |
| | | percentile.</b> <font color=##333333>Compared to the national |
| | | population, your FICO&reg; score is in the 1st percentile. This |
| | | means that roughly 1% of consumers have scores lower than or |
| | | equal to your own score, and 99% have scores which are |
| | | higher.</b></font></blockquote> |
| Percentile | 508.000000 | <img src=../images/p2.gif height=126 |
| Graph | | width=430><br><blockquote><b>Understanding your |
| | | percentile.</b> <font color=##333333>Compared to the national |
| | | population, your FICO&reg; score is in the 2nd percentile. This |
| | | means that roughly 2% of consumers have scores lower than or |
| | | equal to your own score, and 98% have scores which are |
| | | higher. </b></font></blockquote> |
| Percentile | 521.000000 | <img src=../images/p3.gif height=126 |
| Graph | | width=430><br><blockquote><b>Understanding your |
| | | percentile.</b> <font color=##333333>Compared to the national |
| | | population, your FICO&reg; score is in the 3rd percentile. This |
| | | means that roughly 3% of consumers have scores lower than or |
| | | equal to your own score, and 97% have scores which are |
| | | higher.</b></font></blockquote> |
| Percentile | 532.000000 | <img src=../images/p4.gif height=126 |
| Graph | | width=430><br><blockquote><b>Understanding your |
| | | percentile.</b> <font color=##333333>Compared to the national |
| | | population, your FICO&reg; score is in the 4th percentile. This |
| | | means that roughly 4% of consumers have scores lower than or |
| | | equal to your own score, and 96% have scores which are |
| | | higher.</b></font></blockquote> |
| Percentile | 541.000000 | <img src=../images/p5.gif height=126 |
| Graph | | width=430><br><blockquote><b>Understanding your |
| | | percentile.</b> <font color=##333333>Compared to the national |
| | | population, your FICO&reg; score is in the 5th percentile. This |
| | | means that roughly 5% of consumers have scores lower than or |
| | | equal to your own score, and 95% have scores which are |
| | | higher.</b></font></blockquote> |
| Percentile | 549.000000 | <img src=../images/p6.gif height=126 |
| Graph | | width=430><br><blockquote><b>Understanding your |
| | | percentile.</b> <font color=##333333>Compared to the national |
| | | population, your FICO&reg; score is in the 6th percentile. This |
| | | means that roughly 6% of consumers have scores lower than or |
| | | equal to your own score, and 94% have scores which are |
| | | higher.</b></font></blockquote> |
| Percentile | 557.000000 | <img src=../images/p7.gif height=126 |
| Graph | | width=430><br><blockquote><b>Understanding your |
| | | percentile.</b> <font color=##333333>Compared to the national |
| | | population, your FICO&reg; score is in the 7th percentile. This |
| | | means that roughly 7% of consumers have scores lower than or |
| | | equal to your own score, and 93% have scores which are |
| | | higher.</b></font></blockquote> |
| Percentile | 565.000000 | <img src=../images/p8.gif height=126 |
| Graph | | width=430><br><blockquote><b>Understanding your |
| | | percentile.</b> <font color=##333333>Compared to the national |
| | | population, your FICO&reg; score is in the 8th percentile. This |
| | | means that roughly 8% of consumers have scores lower than or |
| | | equal to your own score, and 92% have scores which are |
| | | higher. </b></font></blockquote> |
| Percentile | 572.000000 | <img src=../images/p9.gif height=126 |
| Graph | | width=430><br><blockquote><b>Understanding your |
| | | percentile.</b> <font color=##333333>Compared to the national |
| | | population, your FICO&reg; score is in the 9th percentile. This |
| | | means that roughly 9% of consumers have scores lower than or |
| | | equal to your own score, and 91% have scores which are |
| | | higher.</b></font></blockquote> |
| Percentile | 579.000000 | <img src=../images/p10.gif height=126 |
| Graph | | width=430><br><blockquote><b>Understanding your |
| | | percentile.</b> <font color=##333333>Compared to the national |
| | | population, your FICO&reg; score is in the 10th percentile. This |
| | | means that roughly 10% of consumers have scores lower than or |
| | | equal to your own score, and 90% have scores which are |
| | | higher. </b></font></blockquote> |
| Percentile | 586.000000 | <img src=../images/p11.gif height=126 |
| Graph | | width=430><br><blockquote><b>Understanding your |
| | | percentile.</b> <font color=##333333>Compared to the nationalpopulation, |
| | | your FICO&reg; score is in the 11th percentile. This |
| | | means that roughly 11% of consumers have scores lower than or |
| | | equal to your own score, and 89% have scores which are |
| | | higher.</b></font></blockquote> |
| Percentile | 592.000000 | <img src=../images/p12.gif height=126 |
| Graph | | width=430><br><blockquote><b>Understanding your |
| | | percentile.</b> <font color=##333333>Compared to the national |
| | | population, your FICO&reg; score is in the 12th percentile. This |
| | | means that roughly 12% of consumers have scores lower than or |
| | | equal to your own score, and 88% have scores which are |
| | | higher.</b></font></blockquote> |
| Percentile | 598.000000 | <img src=../images/p13.gif height= 126 |
| Graph | | width=430><br><blockquote><b>Understanding your |
| | | percentile.</b> <font color=##333333>Compared to the national |
| | | population, your FICO&reg; score is in the 13th percentile. This |
| | | means that roughly 13% of consumers have scores lower than or |
| | | equal to your own score, and 87% have scores which are |
| | | higher.</b></font></blockquote> |
| Percentile | 604.000000 | <img src=../images/p14.gif height=126 |
| Graph | | width=430><br><blockquote><b>Understanding your |
| | | percentile.</b> <font color=##333333>Compared to the national |
| | | population, your FICO&reg; score is in the 14th percentile. This |
| | | means that roughly 14% of consumers have scores lower than or |
| | | equal to your own score, and 86% have scores which are |
| | | higher.</b></font></blockquote> |
| Percentile | 609.000000 | <img src=../images/p15.gif height=126 |
| Graph | | width=430><br><blockquote><b>Understanding your |
| | | percentile.</b> <font color=##333333>Compared to the national |
| | | population, your FICO&reg; score is in the 15th percentile. This |
| | | means that roughly 15% of consumers have scores lower than or |
| | | equal to your own score, and 85% have scores which are |
| | | higher.</b></font></blockquote> |
| Percentile | 614.000000 | <img src=../images/p16.gif height=126 |
| Graph | | width=430><br><blockquote><b>Understanding your |
| | | percentile.</b> <font color=##333333>Compared to the national |
| | | population, your FICO&reg; score is in the 16th percentile. This |
| | | means that roughly 16% of consumers have scores lower than or |
| | | equal to your own score, and 84% have scores which are |
| | | higher.</b></font></blockquote> |
| Percentile | 619.000000 | <img src=../images/p17.gif height=126 |
| Graph | | width=430><br><blockquote><b>Understanding your |
| | | percentile.</b> <font color=##333333>Compared to the national |
| | | population, your FICO&reg; score is in the 17th percentile. This |
| | | means that roughly 17% of consumers have scores lower than or |
| | | equal to your own score, and 83% have scores which are |
| | | higher.</b></font></blockquote> |
| Percentile | 623.000000 | <img src=../images/p18.gif height=126 |
| Graph | | width=430><br><blockquote><b>Understanding your |
| | | percentile.</b> <font color=##333333>Compared to the national |
| | | population, your FICO&reg; score is in the 18th percentile. This |
| | | means that roughly 18% of consumers have scores lower than or |
| | | equal to your own score, and 82% have scores which are |
| | | higher.</b></font></blockquote> |
| Percentile | 628.000000 | <img src=../images/p19.gif height=126 |
| Graph | | width=430><br><blockquote><b>Understanding your |
| | | percentile.</b> <font color=##333333>Compared to the national |
| | | population, your FICO&reg; score is in the 19th percentile. This |
| | | means that roughly 19% of consumers have scores lower than or |
| | | equal to your own score, and 81% have scores which are |
| | | higher.</b></font></blockquote> |
| Percentile | 632.000000 | <img src=../images/p20.gif height=126 |
| Graph | | width=430><br><blockquote><b>Understanding your |
| | | percentile.</b> <font color=##333333>Compared to the national |
| | | population, your FICO&reg; score is in the 20th percentile. This |
| | | means that roughly 20% of consumers have scores lower than or |
| | | equal to your own score, and 80% have scores which are |
| | | higher. </b></font></blockquote> |
| Percentile | 636.000000 | <img src=../images/p21.gif height=126 |
| Graph | | width=430><br><blockquote><b>Understanding your |
| | | percentile.</b> <font color=##333333>Compared to the national |
| | | population, your FICO&reg; score is in the 21st percentile. This |
| | | means that roughly 21% of consumers have scores lower than or |
| | | equal to your own score, and 79% have scores which are |
| | | higher. </b></font></blockquote> |
| Percentile | 640.000000 | <img src=../images/p22.gif height=126 |
| Graph | | width=430><br><blockquote><b>Understanding your |
| | | percentile.</b> <font color=##333333>Compared to the national |
| | | population, your FICO&reg; score is in the 22nd percentile. This |
| | | means that roughly 22% of consumers have scores lower than or |
| | | equal to your own score, and 78% have scores which are |
| | | higher.</b></font></blockquote> |
| Percentile | 644.000000 | <img src=../images/p23.gif height=126 |
| Graph | | width=430><br><blockquote><b>Understanding your |
| | | percentile.</b> <font color=##333333>Compared to the national |
| | | population, your FICO&reg; score is in the 23rd percentile. This |
| | | means that roughly 23% of consumers have scores lower than or |
| | | equal to your own score, and 77% have scores which are |
| | | higher.</b></font></blockquote> |
| Percentile | 648.000000 | <img src=../images/p24.gif height=126 |
| Graph | | width=430><br><blockquote><b>Understanding your |
| | | percentile.</b> <font color=##333333>Compared to the national |
| | | population, your FICO&reg; score is in the 24th percentile. This |
| | | means that roughly 24% of consumers have scores lower than or |
| | | equal to your own score, and 76% have scores which are |
| | | higher.</b></font></blockquote> |
| Percentile | 651.000000 | <img src=../images/p25.gif height=126 |
| Graph | | width=430><br><blockquote><b>Understanding your |
| | | percentile.</b> <font color=##333333>Compared to the national |
| | | population, your FICO&reg; score is in the 25th percentile. This |
| | | means that roughly 25% of consumers have scores lower than or |
| | | equal to your own score, and 75% have scores which are |
| | | higher. </b></font></blockquote> |
| Percentile | 655.000000 | <img src=../images/p26.gif height=126 |
| Graph | | width=430><br><blockquote><b>Understanding your |
| | | percentile.</b> <font color=##333333>Compared to the national |
| | | population, your FICO&reg; score is in the 26th percentile. This |
| | | means that roughly 26% of consumers have scores lower than or |
| | | equal to your own score, and 74% have scores which are |
| | | higher.</b></font></blockquote> |
| Percentile | 659.000000 | <img src=../images/p27.gif height=126 |
| Graph | | width=430><br><blockquote><b>Understanding your |
| | | percentile.</b> <font color=##333333>Compared to the national |
| | | population, your FICO&reg; score is in the 27th percentile. This |
| | | means that roughly 27% of consumers have scores lower than or |
| | | equal to your own score, and 73% have scores which are |
| | | higher.</b></font></blockquote> |
| Percentile | 662.000000 | <img src=../images/p28.gif height=126 |
| Graph | | width=430><br><blockquote><b>Understanding your |
| | | percentile.</b> <font color=##333333>Compared to the national |
| | | population, your FICO&reg; score is in the 28th percentile. This |
| | | means that roughly 28% of consumers have scores lower than or |
| | | equal to your own score, and 72% have scores which are |
| | | higher. </b></font></blockquote> |
| Percentile | 665.000000 | <img src=../images/p29.gif height=126 |
| Graph | | width=430><br><blockquote><b>Understanding your |
| | | percentile.</b> <font color=##333333>Compared to the national |
| | | population, your FICO&reg; score is in the 29th percentile. This |
| | | means that roughly 29% of consumers have scores lower than or |
| | | equal to your own score, and 71% have scores which are |
| | | higher.</b></font></blockquote> |
| Percentile | 669.000000 | <img src=../images/p30.gif height=126 |
| Graph | | width=430><br><blockquote><b>Understanding your |
| | | percentile.</b> <font color=##333333>Compared to the national |
| | | population, your FICO&reg; score is in the 30th percentile. This |
| | | means that roughly 30% of consumers have scores lower than or |
| | | equal to your own score, and 70% have scores which are |
| | | higher. </b></font></blockquote> |
| Percentile | 672.000000 | <img src=../images/p31.gif height=126 |
| Graph | | width=430><br><blockquote><b>Understanding your |
| | | percentile.</b> <font color=##333333>Compared to the national |
| | | population, your FICO&reg; score is in the 31st percentile. This |
| | | means that roughly 31% of consumers have scores lower than or |
| | | equal to your own score, and 69% have scores which are |
| | | higher.</b></font></blockquote> |
| Percentile | 675.000000 | <img src=../images/p32.gif height=126 |
| Graph | | width=430><br><blockquote><b>Understanding your |
| | | percentile.</b> <font color=##333333>Compared to the national |
| | | population, your FICO&reg; score is in the 32nd percentile. This |
| | | means that roughly 32% of consumers have scores lower than or |
| | | equal to your own score, and 68% have scores which are |
| | | higher.</b></font></blockquote> |
| Percentile | 678.000000 | <img src=../images/p33.gif height=126 |
| Graph | | width=430><br><blockquote><b>Understanding your |
| | | percentile.</b> <font color=##333333>Compared to the national |
| | | population, your FICO&reg; score is in the 33rd percentile. This |
| | | means that roughly 33% of consumers have scores lower than or |
| | | equal to your own score, and 67% have scores which are |
| | | higher.</b></font></blockquote> |
| Percentile | 682.000000 | <img src=../images/p34.gif height=126 |
| Graph | | width=430><br><blockquote><b>Understanding your |
| | | percentile.</b> <font color=##333333>Compared to the national |
| | | population, your FICO&reg; score is in the 34th percentile. This |
| | | means that roughly 34% of consumers have scores lower than or |
| | | equal to your own score, and 66% have scores which are |
| | | higher. </b></font></blockquote> |
| Percentile | 685.000000 | <img src=../images/p35.gif height=126 |
| Graph | | width=430><br><blockquote><b>Understanding your |
| | | percentile.</b> <font color=##333333>Compared to the national |
| | | population, your FICO&reg; score is in the 35th percentile. This |
| | | means that roughly 35% of consumers have scores lower than or |
| | | equal to your own score, and 65% have scores which are |
| | | higher.</b></font></blockquote> |
| Percentile | 688.000000 | <img src=../images/p36.gif height=126 |
| Graph | | width=430><br><blockquote><b>Understanding your |
| | | percentile.</b> <font color=##333333>Compared to the national |
| | | population, your FICO&reg; score is in the 36th percentile. This |
| | | means that roughly 36% of consumers have scores lower than or |
| | | equal to your own score, and 64% have scores which are |
| | | higher.</b></font></blockquote> |
| Percentile | 691.000000 | <img src=../images/p37.gif height=126 |
| Graph | | width=430><br><blockquote><b>Understanding your |
| | | percentile.</b> <font color=##333333>Compared to the national |
| | | population, your FICO&reg; score is in the 37th percentile. This |
| | | means that roughly 37% of consumers have scores lower than or |
| | | equal to your own score, and 63% have scores which are |
| | | higher.</b></font></blockquote> |
| Percentile | 694.000000 | <img src=../images/p38.gif height=126 |
| Graph | | width=430><br><blockquote><b>Understanding your |
| | | percentile.</b> <font color=##333333>Compared to the national |
| | | population, your FICO&reg; score is in the 38th percentile. This |
| | | means that roughly 38% of consumers have scores lower than or |
| | | equal to your own score, and 62% have scores which are |
| | | higher.</b></font></blockquote> |
| Percentile | 697.000000 | <img src=../images/p39.gif height=126 |
| Graph | | width=430><br><blockquote><b>Understanding your |
| | | percentile.</b> <font color=##333333>Compared to the national |
| | | population, your FICO&reg; score is in the 39th percentile. This |
| | | means that roughly 39% of consumers have scores lower than or |
| | | equal to your own score, and 61% have scores which are |
| | | higher.</b></font></blockquote> |
| Percentile | 700.000000 | <img src=../images/p40.gif height=126 |
| Graph | | width=430><br><blockquote><b>Understanding your |
| | | percentile.</b> <font color=##333333>Compared to the national |
| | | population, your FICO&reg; score is in the 40th percentile. This |
| | | means that roughly 40% of consumers have scores lower than or |
| | | equal to your own score, and 60% have scores which are |
| | | higher.</b></font></blockquote> |
| Percentile | 703.000000 | <img src=../images/p41.gif height=126 |
| Graph | | width=430><br><blockquote><b>Understanding your |
| | | percentile.</b> <font color=##333333>Compared to the national |
| | | population, your FICO&reg; score is in the 41st percentile. This |
| | | means that roughly 41% of consumers have scores lower than or |
| | | equal to your own score, and 59% have scores which are |
| | | higher.</b></font></blockquote> |
| Percentile | 706.000000 | <img src=../images/p42.gif height=126 |
| Graph | | width=430><br><blockquote><b>Understanding your |
| | | percentile.</b> <font color=##333333>Compared to the national |
| | | population, your FICO&reg; score is in the 42nd percentile. This |
| | | means that roughly 42% of consumers have scores lower than or |
| | | equal to your own score, and 58% have scores which are |
| | | higher.</b></font></blockquote> |
| Percentile | 708.000000 | <img src=../images/p43.gif height=126 |
| Graph | | width=430><br><blockquote><b>Understanding your |
| | | percentile.</b> <font color=##333333>Compared to the national |
| | | population, your FICO&reg; score is in the 43rd percentile. This |
| | | means that roughly 43% of consumers have scores lower than or |
| | | equal to your own score, and 57% have scores which are |
| | | higher.</b></font></blockquote> |
| Percentile | 711.000000 | <img src=../images/p44.gif height=126 |
| Graph | | width=430><br><blockquote><b>Understanding your |
| | | percentile.</b> <font color=##333333>Compared to the national |
| | | population, your FICO&reg; score is in the 44th percentile. This |
| | | means that roughly 44% of consumers have scores lower than or |
| | | equal to your own score, and 56% have scores which are |
| | | higher.</b></font></blockquote> |
| Percentile | 714.000000 | <img src=../images/p45.gif height= 126 |
| Graph | | width=430><br><blockquote><b>Understanding your |
| | | percentile.</b> <font color=##333333>Compared to the national |
| | | population, your FICO&reg; score is in the 45th percentile. This |
| | | means that roughly 45% of consumers have scores lower than or |
| | | equal to your own score, and 55% have scores which are |
| | | higher.</b></font></blockquote> |
| Percentile | 717.000000 | <img src=../images/p46.gif height=126 |
| Graph | | width=430><br><blockquote><b>Understanding your |
| | | percentile.</b> <font color=##333333>Compared to the national |
| | | population, your FICO&reg; score is in the 46th percentile. This |
| | | means that roughly 46% of consumers have scores lower than or |
| | | equal to your own score, and 54% have scores which are |
| | | higher.</b></font></blockquote> |
| Percentile | 719.000000 | <img src=../images/p47.gif height=126 |
| Graph | | width=430><br><blockquote><b>Understanding your |
| | | percentile.</b> <font color=##333333>Compared to the national |
| | | population, your FICO&reg; score is in the 47th percentile. This |
| | | means that roughly 47% of consumers have scores lower than or |
| | | equal to your own score, and 53% have scores which are |
| | | higher.</b></font></blockquote> |
| Percentile | 722.000000 | <img src=../images/p48.gif height=126 |
| Graph | | width=430><br><blockquote><b>Understanding your |
| | | percentile.</b> <font color=##333333>Compared to the national |
| | | population, your FICO&reg; score is in the 48th percentile. This |
| | | means that roughly 48% of consumers have scores lower than or |
| | | equal to your own score, and 52% have scores which are |
| | | higher.</b></font></blockquote> |
| Percentile | 724.000000 | <img src=../images/p49.gif height=126 |
| Graph | | width=430><br><blockquote><b>Understanding your |
| | | percentile.</b> <font color=##333333>Compared to the national |
| | | population, your FICO&reg; score is in the 49th percentile. This |
| | | means that roughly 49% of consumers have scores lower than or |
| | | equal to your own score, and 51% have scores which are |
| | | higher.</b></font></blockquote> |
| Percentile | 727.000000 | <img src=../images/p50.gif height=126 |
| Graph | | width=430><br><blockquote><b>Understanding your |
| | | percentile.</b> <font color=##333333>Compared to the national |
| | | population, your FICO&reg; score is in the 50th percentile. This |
| | | means that roughly 50% of consumers have scores lower than or |
| | | equal to your own score, and 50% have scores which are |
| | | higher.</b></font></blockquote> |
| Percentile | 729.000000 | <img src=../images/p51.gif height=126 |
| Graph | | width=430><br><blockquote><b>Understanding your |
| | | percentile.</b> <font color=##333333>Compared to the national |
| | | population, your FICO&reg; score is in the 51st percentile. This |
| | | means that roughly 51% of consumers have scores lower than or |
| | | equal to your own score, and 49% have scores which are |
| | | higher.</b></font></blockquote> |
| Percentile | 732.000000 | <img src=../images/p52.gif height=126 |
| Graph | | width=430><br><blockquote><b>Understanding your |
| | | percentile.</b> <font color=##333333>Compared to the national |
| | | population, your FICO&reg; score is in the 52nd percentile. This |
| | | means that roughly 52% of consumers have scores lower than or |
| | | equal to your own score, and 48% have scores which are |
| | | higher.</b></font></blockquote> |
| Percentile | 734.000000 | <img src=../images/p53.gif height=126 |
| Graph | | width=430><br><blockquote><b>Understanding your |
| | | percentile.</b> <font color=##333333>Compared to the national |
| | | population, your FICO&reg; score is in the 53rd percentile. This |
| | | means that roughly 53% of consumers have scores lower than or |
| | | equal to your own score, and 47% have scores which are |
| | | higher.</b></font></blockquote> |
| Percentile | 736.000000 | <img src=../images/p54.gif height=126 |
| Graph | | width=430><br><blockquote><b>Understanding your |
| | | percentile.</b> <font color=##333333>Compared to the national |
| | | population, your FICO&reg; score is in the 54th percentile. This |
| | | means that roughly 54% of consumers have scores lower than or |
| | | equal to your own score, and 46% have scores which are |
| | | higher.</b></font></blockquote> |
| Percentile | 739.000000 | <img src=../images/p55.gif height=126 |
| Graph | | width=430><br><blockquote><b>Understanding your |
| | | percentile.</b> <font color=##333333>Compared to the national |
| | | population, your FICO&reg; score is in the 55th percentile. This |
| | | means that roughly 55% of consumers have scores lower than or |
| | | equal to your own score, and 45% have scores which are |
| | | higher.</b></font></blockquote> |
| Percentile | 741.000000 | <img src=../images/p56.gif height=126 |
| Graph | | width=430><br><blockquote><b>Understanding your |
| | | percentile.</b> <font color=##333333>Compared to the national |
| | | population, your FICO&reg; score is in the 56th percentile. This |
| | | means that roughly 56% of consumers have scores lower than or |
| | | equal to your own score, and 44% have scores which are |
| | | higher.</b></font></blockquote> |
| Percentile | 743.000000 | <img src=../images/p57.gif height=126 |
| Graph | | width=430><br><blockquote><b>Understanding your |
| | | percentile.</b> <font color=##333333>Compared to the national |
| | | population, your FICO&reg; score is in the 57th percentile. This |
| | | means that roughly 57% of consumers have scores lower than or |
| | | equal to your own score, and 43% have scores which are |
| | | higher.</b></font></blockquote> |
| Percentile | 745.000000 | <img src=../images/p58.gif height=126 |
| Graph | | width=430><br><blockquote><b>Understanding your |
| | | percentile.</b> <font color=##333333>Compared to the national |
| | | population, your FICO&reg; score is in the 58th percentile. This |
| | | means that roughly 58% of consumers have scores lower than or |
| | | equal to your own score, and 42% have scores which are |
| | | higher.</b></font></blockquote> |
| Percentile | 748.000000 | <img src=../images/p59.gif height=126 |
| Graph | | width=430><br><blockquote><b>Understanding your |
| | | percentile.</b> <font color=##333333>Compared to the national |
| | | population, your FICO&reg; score is in the 59th percentile. This |
| | | means that roughly 59% of consumers have scores lower than or |
| | | equal to your own score, and 41% have scores which are |
| | | higher.</b></font></blockquote> |
| Percentile | 750.000000 | <img src=../images/p60.gif height=126 |
| Graph | | width=430><br><blockquote><b>Understanding your |
| | | percentile.</b> <font color=##333333>Compared to the national |
| | | population, your FICO&reg; score is in the 60th percentile. This |
| | | means that roughly 60% of consumers have scores lower than or |
| | | equal to your own score, and 40% have scores which are |
| | | higher.</b></font></blockquote> |
| Percentile | 752.000000 | <img src=../images/p61.gif height=126 |
| Graph | | width=430><br><blockquote><b>Understanding your |
| | | percentile.</b> <font color=##333333>Compared to the national |
| | | population, your FICO&reg; score is in the 61st percentile. This |
| | | means that roughly 61% of consumers have scores lower than or |
| | | equal to your own score, and 39% have scores which are |
| | | higher.</b></font></blockquote> |
| Percentile | 754.000000 | <img src=../images/p62.gif height=126 |
| Graph | | width=430><br><blockquote><b>Understanding your |
| | | percentile.</b> <font color=##333333>Compared to the national |
| | | population, your FICO&reg; score is in the 62nd percentile. This |
| | | means that roughly 62% of consumers have scores lower than or |
| | | equal to your own score, and 38% have scores which are |
| | | higher.</b></font></blockquote> |
| Percentile | 756.000000 | <img src=../images/p63.gif height=126 |
| Graph | | width=430><br><blockquote><b>Understanding your |
| | | percentile.</b> <font color=##333333>Compared to the national |
| | | population, your FICO&reg; score is in the 63rd percentile. This |
| | | means that roughly 63% of consumers have scores lower than or |
| | | equal to your own score, and 37% have scores which are |
| | | higher.</b></font></blockquote> |
| Percentile | 758.000000 | <img src=../images/p64.gif height=126 |
| Graph | | width=430><br><blockquote><b>Understanding your |
| | | percentile.</b> <font color=##333333>Compared to the national |
| | | population, your FICO&reg; score is in the 64th percentile. This |
| | | means that roughly 64% of consumers have scores lower than or |
| | | equal to your own score, and 36% have scores which are |
| | | higher. </b></font></blockquote> |
| Percentile | 760.000000 | <img src=../images/p65.gif height=126 |
| Graph | | width=430><br><blockquote><b>Understanding your |
| | | percentile.</b> <font color=##333333>Compared to the national |
| | | population, your FICO&reg; score is in the 65th percentile. This |
| | | means that roughly 65% of consumers have scores lower than or |
| | | equal to your own score, and 35% have scores which are |
| | | higher.</b></font></blockquote> |
| Percentile | 762.000000 | <img src=../images/p66.gif height=126 |
| Graph | | width=430><br><blockquote><b>Understanding your |
| | | percentile.</b> <font color=##333333>Compared to the national |
| | | population, your FICO&reg; score is in the 66th percentile. This |
| | | means that roughly 66% of consumers have scores lower than or |
| | | equal to your own score, and 34% have scores which are |
| | | higher.</b></font></blockquote> |
| Percentile | 763.000000 | <img src=../images/p67.gif height=126 |
| Graph | | width=430><br><blockquote><b>Understanding your |
| | | percentile.</b> <font color=##333333>Compared to the national |
| | | population, your FICO&reg; score is in the 67th percentile. This |
| | | means that roughly 67% of consumers have scores lower than or |
| | | equal to your own score, and 33% have scores which are |
| | | higher.</b></font></blockquote> |
| Percentile | 765.000000 | <img src=../images/p68.gif height=126 |
| Graph | | width=430><br><blockquote><b>Understanding your |
| | | percentile.</b> <font color=##333333>Compared to the national |
| | | population, your FICO&reg; score is in the 68th percentile. This |
| | | means that roughly 68% of consumers have scores lower than or |
| | | equal to your own score, and 32% have scores which are |
| | | higher.</b></font></blockquote> |
| Percentile | 767.000000 | <img src=../images/p69.gif height=126 |
| Graph | | width=430><br><blockquote><b>Understanding your |
| | | percentile.</b> <font color=##333333>Compared to the national |
| | | population, your FICO&reg; score is in the 69th percentile. This |
| | | means that roughly 69% of consumers have scores lower than or |
| | | equal to your own score, and 31% have scores which are |
| | | higher.</b></font></blockquote> |
| Percentile | 769.000000 | <img src=../images/p70.gif height=126 |
| Graph | | width=430><br><blockquote><b>Understanding your |
| | | percentile.</b> <font color=##333333>Compared to the national |
| | | population, your FICO&reg; score is in the 70th percentile. This |
| | | means that roughly 70% of consumers have scores lower than or |
| | | equal to your own score, and 30% have scores which are |
| | | higher.</b></font></blockquote> |
| Percentile | 771.000000 | <img src=../images/p71.gif height=126 |
| Graph | | width=430><br><blockquote><b>Understanding your |
| | | percentile.</b> <font color=##333333>Compared to the national |
| | | population, your FICO&reg; score is in the 71st percentile. This |
| | | means that roughly 71% of consumers have scores lower than or |
| | | equal to your own score, and 29% have scores which are |
| | | higher.</b></font></blockquote> |
| Percentile | 772.000000 | <img src=../images/p72.gif height=126 |
| Graph | | width=430><br><blockquote><b>Understanding your |
| | | percentile.</b> <font color=##333333>Compared to the national |
| | | population, your FICO&reg; score is in the 72nd percentile. This |
| | | means that roughly 72% of consumers have scores lower than or |
| | | equal to your own score, and 28% have scores which are |
| | | higher.</b></font></blockquote> |
| Percentile | 774.000000 | <img src=../images/p73.gif height=126 |
| Graph | | width=430><br><blockquote><b>Understanding your |
| | | percentile.</b> <font color=##333333>Compared to the national |
| | | population, your FICO&reg; score is in the 73rd percentile. This |
| | | means that roughly 73% of consumers have scores lower than or |
| | | equal to your own score, and 27% have scores which are |
| | | higher.</b></font></blockquote> |
| Percentile | 776.000000 | <img src=../images/p74.gif height=126 |
| Graph | | width=430><br><blockquote><b>Understanding your |
| | | percentile.</b> <font color=##333333>Compared to the national |
| | | population, your FICO&reg; score is in the 74th percentile. This |
| | | means that roughly 74% of consumers have scores lower than or |
| | | equal to your own score, and 26% have scores which are |
| | | higher.</b></font></blockquote> |
| Percentile | 778.000000 | <img src=../images/p75.gif height=126 |
| Graph | | width=430><br><blockquote><b>Understanding your |
| | | percentile.</b> <font color=##333333>Compared to the national |
| | | population, your FICO&reg; score is in the 75th percentile. This |
| | | means that roughly 75% of consumers have scores lower than or |
| | | equal to your own score, and 25% have scores which are |
| | | higher.</b></font></blockquote> |
| Percentile | 780.000000 | <img src=../images/p76.gif height=126 |
| Graph | | width=430><br><blockquote><b>Understanding your |
| | | percentile.</b> <font color=##333333>Compared to the national |
| | | population, your FICO&reg; score is in the 76th percentile. This |
| | | means that roughly 76% of consumers have scores lower than or |
| | | equal to your own score, and 24% have scores which are |
| | | higher.</b></font></blockquote> |
| Percentile | 781.000000 | <img src=../images/p77.gif height=126 |
| Graph | | width=430><br><blockquote><b>Understanding your |
| | | percentile.</b> <font color=##333333>Compared to the national |
| | | population, your FICO&reg; score is in the 77th percentile. This |
| | | means that roughly 77% of consumers have scores lower than or |
| | | equal to your own score, and 23% have scores which are |
| | | higher.</b></font></blockquote> |
| Percentile | 783.000000 | <img src=../images/p78.gif height=126 |
| Graph | | width=430><br><blockquote><b>Understanding your |
| | | percentile.</b> <font color=##333333>Compared to the national |
| | | population, your FICO&reg; score is in the 78th percentile. This |
| | | means that roughly 78% of consumers have scores lower than or |
| | | equal to your own score, and 22% have scores which are |
| | | higher.</b></font></blockquote> |
| Percentile | 784.000000 | <img src=../images/p79.gif height=126 |
| Graph | | width=430><br><blockquote><b>Understanding your |
| | | percentile.</b> <font color=##333333>Compared to the national |
| | | population, your FICO&reg; score is in the 79th percentile. This |
| | | means that roughly 79% of consumers have scores lower than or |
| | | equal to your own score, and 21% have scores which are |
| | | higher.</b></font></blockquote> |
| Percentile | 786.000000 | <img src=../images/p80.gif height=126 |
| Graph | | width=430><br><blockquote><b>Understanding your |
| | | percentile.</b> <font color=##333333>Compared to the national |
| | | population, your FICO&reg; score is in the 80th percentile. This |
| | | means that roughly 80% of consumers have scores lower than or |
| | | equal to your own score, and 20% have scores which are |
| | | higher.</b></font></blockquote> |
| Percentile | 788.000000 | <img src=../images/p81.gif height=126 |
| Graph | | width=430><br><blockquote><b>Understanding your |
| | | percentile.</b> <font color=##333333>Compared to the national |
| | | population, your FICO&reg; score is in the 81st percentile. This |
| | | means that roughly 81% of consumers have scores lower than or |
| | | equal to your own score, and 19% have scores which are |
| | | higher.</b></font></blockquote> |
| Percentile | 789.000000 | <img src=../images/p82.gif height=126 |
| Graph | | width=430><br><blockquote><b>Understanding your |
| | | percentile.</b> <font color=##333333>Compared to the national |
| | | population, your FICO&reg; score is in the 82nd percentile. This |
| | | means that roughly 82% of consumers have scores lower than or |
| | | equal to your own score, and 18% have scores which are |
| | | higher.</b></font></blockquote> |
| Percentile | 791.000000 | <img src=../images/p83.gif height=126 |
| Graph | | width=430><br><blockquote><b>Understanding your |
| | | percentile.</b> <font color=##333333>Compared to the national |
| | | population, your FICO&reg; score is in the 83rd percentile. This |
| | | means that roughly 83% of consumers have scores lower than or |
| | | equal to your own score, and 17% have scores which are |
| | | higher.</b></font></blockquote> |
| Percentile | 792.000000 | <img src=../images/p84.gif height=126 |
| Graph | | width=430><br><blockquote><b>Understanding your |
| | | percentile.</b> <font color=##333333>Compared to the national |
| | | population, your FICO&reg; score is in the 84th percentile. This |
| | | means that roughly 84% of consumers have scores lower than or |
| | | equal to your own score, and 16% have scores which are |
| | | higher.</b></font></blockquote> |
| Percentile | 794.000000 | <img src=../images/p85.gif height=126 |
| Graph | | width=430><br><blockquote><b>Understanding your |
| | | percentile.</b> <font color=##333333>Compared to the national |
| | | population, your FICO&reg; score is in the 85th percentile. This |
| | | means that roughly 85% of consumers have scores lower than or |
| | | equal to your own score, and 15% have scores which are |
| | | higher.</b></font></blockquote> |
| Percentile | 795.000000 | <img src=../images/p86.gif height=126 |
| Graph | | width=430><br><blockquote><b>Understanding your |
| | | percentile.</b> <font color=##333333>Compared to the national |
| | | population, your FICO&reg; score is in the 86th percentile. This |
| | | means that roughly 86% of consumers have scores lower than or |
| | | equal to your own score, and 14% have scores which are |
| | | higher.</b></font></blockquote> |
| Percentile | 797.000000 | <img src=../images/p87.gif height=126 |
| Graph | | width=430><br><blockquote><b>Understanding your |
| | | percentile.</b> <font color=##333333>Compared to the national |
| | | population, your FICO&reg; score is in the 87th percentile. This |
| | | means that roughly 87% of consumers have scores lower than or |
| | | equal to your own score, and 13% have scores which are |
| | | higher.</b></font></blockquote> |
| Percentile | 799.000000 | <img src=../images/p88.gif height=126 |
| Graph | | width=430><br><blockquote><b>Understanding your |
| | | percentile.</b> <font color=##333333>Compared to the national |
| | | population, your FICO&reg; score is in the 88th percentile. This |
| | | means that roughly 88% of consumers have scores lower than or |
| | | equal to your own score, and 12% have scores which are |
| | | higher.</b></font></blockquote> |
| Percentile | 800.000000 | <img src=../images/p89.gif height=126 |
| Graph | | width=430><br><blockquote><b>Understanding your |
| | | percentile.</b> <font color=##333333>Compared to the national |
| | | population, your FICO&reg; score is in the 89th percentile. This |
| | | means that roughly 89% of consumers have scores lower than or |
| | | equal to your own score, and 11% have scores which are |
| | | higher.</b></font></blockquote> |
| Percentile | 802.000000 | <img src=../images/p90.gif height=126 |
| Graph | | width=430><br><blockquote><b>Understanding your |
| | | percentile.</b> <font color=##333333>Compared to the national |
| | | population, your FICO&reg; score is in the 90th percentile. This |
| | | means that roughly 90% of consumers have scores lower than or |
| | | equal to your own score, and 10% have scores which are |
| | | higher.</b></font></blockquote> |
| Percentile | 803.000000 | <img src=../images/p91.gif height=126 |
| Graph | | width=430><br><blockquote><b>Understanding your |
| | | percentile.</b> <font color=##333333>Compared to the national |
| | | population, your FICO&reg; score is in the 91st percentile. This |
| | | means that roughly 91% of consumers have scores lower than or |
| | | equal to your own score, and 9% have scores which are |
| | | higher.</b></font></blockquote> |
| Percentile | 805.000000 | <img src=../images/p92.gif height=126 |
| Graph | | width=430><br><blockquote><b>Understanding your |
| | | percentile.</b> <font color=##333333>Compared to the national |
| | | population, your FICO&reg; score is in the 92nd percentile. This |
| | | means that roughly 92% of consumers have scores lower than or |
| | | equal to your own score, and 8% have scores which are |
| | | higher.</b></font></blockquote> |
| Percentile | 807.000000 | <img src=../images/p93.gif height=126 |
| Graph | | width=430><br><blockquote><b>Understanding your |
| | | percentile.</b> <font color=##333333>Compared to the national |
| | | population, your FICO&reg; score is in the 93rd percentile. This |
| | | means that roughly 93% of consumers have scores lower than or |
| | | equal to your own score, and 7% have scores which are |
| | | higher.</b></font></blockquote> |
| Percentile | 809.000000 | <img src=../images/p94.gif height=126 |
| Graph | | width=430><br><blockquote><b>Understanding your |
| | | percentile.</b> <font color=##333333>Compared to the national |
| | | population, your FICO&reg; score is in the 94th percentile. This |
| | | means that roughly 94% of consumers have scores lower than or |
| | | equal to your own score, and 6% have scores which are |
| | | higher.</b></font></blockquote> |
| Percentile | 811.000000 | <img src=../images/p95.gif height=126 |
| Graph | | width=430><br><blockquote><b>Understanding your |
| | | percentile.</b> <font color=##333333>Compared to the national |
| | | population, your FICO&reg; score is in the 95th percentile. This |
| | | means that roughly 95% of consumers have scores lower than or |
| | | equal to your own score, and 5% have scores which are |
| | | higher.</b></font></blockquote> |
| Percentile | 814.000000 | <img src=../images/p96.gif height=126 |
| Graph | | width=430><br><blockquote><b>Understanding your |
| | | percentile.</b> <font color=##333333>Compared to the national |
| | | population, your FICO&reg; score is in the 96th percentile. This |
| | | means that roughly 96% of consumers have scores lower than or |
| | | equal to your own score, and 4% have scores which are |
| | | higher.</b></font></blockquote> |
| Percentile | 817.000000 | <img src=../images/p97.gif height=126 |
| Graph | | width=430><br><blockquote><b>Understanding your |
| | | percentile.</b> <font color=##333333>Compared to the national |
| | | population, your FICO&reg; score is in the 97th percentile. This |
| | | means that roughly 97% of consumers have scores lower than or |
| | | equal to your own score, and 3% have scores which are |
| | | higher.</b></font></blockquote> |
| Percentile | 820.000000 | <img src=../images/p98.gif height=126 |
| Graph | | width=430><br><blockquote><b>Understanding your |
| | | percentile.</b> <font color=##333333>Compared to the national |
| | | population, your FICO&reg; score is in the 98th percentile. This |
| | | means that roughly 98% of consumers have scores lower than or |
| | | equal to your own score, and 2% have scores which are |
| | | higher. </b></font></blockquote> |
| Percentile | 826.000000 | <img src=../images/p99.gif height=126 |
| Graph | | width=430><br><blockquote><b>Understanding your |
| | | percentile.</b> <font color=##333333>Compared to the national |
| | | population, your FICO&reg; score is in the 99th percentile. This |
| | | means that roughly 99% of consumers have scores lower than or |
| | | equal to your own score, and 1% have scores which are |
| | | higher.</b></font></blockquote> |
| Percentile | 843.000000 | <img src=../images/p100.gif height=126 |
| Graph | | width=430><br><blockquote><b>Understanding your |
| | | percentile.</b> <font color=##333333>Compared to the national |
| | | population, your FICO&reg; score is in the 100th percentile. This |
| | | means that roughly 100% of consumers have scores lower than or |
| | | equal to your own score, and 0% have scores which are |
| | | higher.</b></font></blockquote> |
| Reason Set | 0.000000 | Typically, a FICO score is returned with up to four uniquereason |
| | | codes, that indicate the most significant factors on the credit |
| | | bureau report affecting an individual's score.Sometimes, |
| | | particularly when the FICO score is quite high, there may be only |
| | | a few such factors, and only two or three reasons are returned. |
| | | Even more rare is to receive just one reason code.<br><br>In your |
| | | case, you have received no reason codes at all. This may be |
| | | because your score is exceptionally high, and there is literally |
| | | nothing that can be done to improve it, or because the vendor |
| | | providing your credit report has failed to include the reasons with |
| | | the FICO score. {No Code |
| | | Kick}<br><br><b>Summary</b><br>{Score Group |
| | | Summary}<br><br>Because no reason codes accompany your |
| | | FICO score, we can provide no specific recommendations on how |
| | | you might improve it.<br><br> |
| Reason Set | 1.000000 | <b>Factors affecting your score.</b><br>In addition to the score, |
| | | you received one reason code, which indicates the only factor on |
| | | your credit bureau report that received less than the maximum |
| | | possible points. Receiving just one code is exceptionally rare, and |
| | | occurs only on very high-scoring files. It is conceivable that by |
| | | understanding and acting on this one reason you can raise your |
| | | score, but there is probably no practical need to do so. |
| | | <br><br><i>First Reason Code: #CODE1#</i> The only |
| | | reason code cited with your score is #CODE1#, “#REASON1#”. |
| | | #FRIENDLY1# <br><br><b>Summary</b><br>{Score Group |
| | | Summary}<br><ul><li>#ACTION1#</ul> |
| Reason Set | 2.000000 | <b>Factors affecting your score.</b><br>In addition to the score, |
| | | you received two reason codes. These represent the top two |
| | | reasons your score was not higher. The order in which these codes |
| | | were returned to you is significant. The first code represents the |
| | | factor with the strongest negative impact on your score; the second |
| | | code had less impact. The best way to understand how you scored |
| | | and what you can do to improve your score over time is to |
| | | consider these reasons.<br><br><i>First Reason Code: |
| | | #CODE1#</i> Your first reason code is #CODE1#, |
| | | “#REASON1#”. This is the single most important factor |
| | | affecting your score. #FRIENDLY1# <br><br><i>Second Reason Code: |
| | | #CODE2#</i> Your second reason code is #CODE2#, |
| | | “#REASON2#”. #FRIENDLY2# |
| | | <br><br><b>Summary</b><br>{Score Group |
| | | Summary}<br><ul><li>#ACTION1#<br><br> |
| | | <li>#ACTION2#</ul> |
| Reason Set | 3.000000 | <b>Factors affecting your score. </b><br>In addition to the score, |
| | | you received three reason codes. These represent the top three |
| | | reasons your score was not higher. The order in which these codes |
| | | were returned to you is significant: the first code represents the |
| | | factor with the strongest negative impact on your score, the second |
| | | code had the next strongest impact, and so on. The best way to |
| | | understand how you scored and what you can do to improve your |
| | | score over time is to consider these top reasons.<br><br><i>First |
| | | Reason Code: #CODE1#</i> Your first reason code is #CODE1#, |
| | | “#REASON1#”. This is the single most important factor affecting |
| | | your score. #FRIENDLY1# <br><br><i>Second Reason Code: |
| | | #CODE2#</i> Your second reason code is #CODE2#, |
| | | “#REASON2#”. #FRIENDLY2# <br><br><i>Third Reason |
| | | Code: #CODE3#</i> Your third reason code is #CODE3#, |
| | | “#REASON3#”. #FRIENDLY3# |
| | | <br><br><b>Summary</b><br>{Score Group |
| | | Summary}<br><ul><li>#ACTION1#<br><br> |
| | | <li>#ACTION2#<br><br> <li>#ACTION3#</ul> |
| Reason Set | 4.000000 | <b>Factors affecting your score.</b><br>In addition to the score, |
| | | you received four reason codes. These represent the top four |
| | | reasons your score was not higher. The order in which these codes |
| | | were returned to you is significant: the first code represents the |
| | | factor with the strongest negative impact on your score, the second |
| | | code had the next strongest impact, and so on. The best way to |
| | | understand how you scored and what you can do to improve your |
| | | score over time is to consider these top reasons.<br><br><i>First |
| | | Reason Code: #CODE1#</i> Your first reason code is #CODE1#, |
| | | “#REASON1#”. This is the single most important factor affecting |
| | | your score. #FRIENDLY1# <br><br><i>Second Reason Code: |
| | | #CODE2#</i> Your second reason code is #CODE2#, |
| | | “#REASON2#”. This is the second most important factor affecting |
| | | your score. #FRIENDLY2# <br><br><i>Third Reason Code: |
| | | #CODE3#</i> Your third reason code is #CODE3#, |
| | | “#REASON3#”. #FRIENDLY3# <br><br><i>Fourth Reason |
| | | Code: #CODE4#</i> Your fourth reason code is #CODE4#, |
| | | “#REASON4#”. #FRIENDLY4# |
| | | <br><br><b>Summary</b><br>{Score Group |
| | | Summary}<br><ul><li>#ACTION1#<br><br> |
| | | <li>#ACTION2#<br><br> <li>#ACTION3#<br><br> |
| | | <li>#ACTION4#</ul> |
| Risk | 0.000000 | Studies show that for consumers with scores similar to yours, the |
| Likelihood | | odds of becoming seriously delinquent (90+ days past due) on one |
| | | or more credit accounts are {Odds Worse} times higher than for |
| | | people with an average score. |
| Risk | 722.000000 | Scores this close to the national average indicate a neutral level |
| Likelihood | | of credit risk. For people with scores similar to yours, the odds |
| | | of successfully repaying all credit accounts are equal to the odds |
| | | for the nation's borrowers as a whole. |
| Risk | 736.000000 | Studies show that for consumers with scores similar to yours, the |
| Likelihood | | odds of successfully repaying all their credit accounts are {Odds |
| | | Better} times better than for people with an average score. |
| Score | 0.000000 | Lenders may view consumers with a score of #SCORE# as high |
| Group Intro | | risk. But that does not mean that you will be turned down for |
| | | every loan you apply for. While the types of credit available may |
| | | be limited, there are lenders who may approve loan applicants |
| | | with a score of #SCORE# but at higher rates and with more |
| | | restrictive terms. Other factors such as your income may also |
| | | affect a lender's willingness to extend credit to you. |
| Score | 620.000000 | Lenders may view consumers with a score of #SCORE# as a |
| Group Intro | | slightly higher risk. Usually, lenders will evaluate other factors |
| | | besides the score in their review of your application for credit. |
| | | The factors will likely differ from one lender to the next, as each |
| | | creditor has its own decision strategies, credit policies, and |
| | | customer focus. While there are many lenders who approve loan |
| | | applicants with a score of #SCORE#, they may do so with higher |
| | | rates or more restrictive terms. |
| Score | 680.000000 | Most lenders will view consumers with a score of #SCORE# as an |
| Group Intro | | acceptable risk. This is generally recognized as a good score, and |
| | | a wide array of loans and credit products will likely be available |
| | | to you, often at attractive rates. Even so, remember that lenders |
| | | often incorporate other information into their decision process, in |
| | | addition to the FICO score, so you might be offered different rates |
| | | or terms by different lenders. Nonetheless, most lenders agree that |
| | | scores around #SCORE# indicate an acceptable level of risk. |
| Score | 720.000000 | Your score of #SCORE# is very high. As a result credit will likely |
| Group Intro | | be readily available to you, often at attractive rates. It is unlikely |
| | | that your credit application would be denied based on this score |
| | | alone.<br><br>The fact that you have received such a high score |
| | | implies that you scored the maximum (or very near the maximum) |
| | | possible points for many of the aspects that are evaluated by the |
| | | FICO score. As such, you should <i>not</i> consider the factors |
| | | discussed later in this analysis to be any serious flaws with your |
| | | credit history. They simply indicate the few factors on which you |
| | | did not score the absolute maximum possible points. And while |
| | | the guidelines associated with the first few reasons may help you |
| | | improve your score by a few points over time, you should already |
| | | have a wide array of credit products available to you.<br><br> |
| Score | 760.000000 | Based on your score of #SCORE#, you will likely have your |
| Group Intro | | choice of credit. Your score is excellent, and a wide array of loans |
| | | and credit cards will likely be available to you, often at attractive |
| | | rates. It is unlikely that your credit application would be denied |
| | | based on this score alone.<br><br>The fact that you have received |
| | | such a high score implies that you scored the maximum (or very |
| | | near the maximum) possible points for many of the aspects that |
| | | are evaluated by the FICO score. As such, you should <i>not</i> |
| | | consider the factors discussed later in this analysis to be any |
| | | serious flaws with your credit history. They simply indicate the |
| | | few factors on which you did not score the absolute maximum |
| | | possible points. And while the guidelines associated with the first |
| | | few reasons may help you improve your score by a few points |
| | | over time, you should already have a wide array of credit products |
| | | available to you. |
| Score | 0.000000 | While many lenders will view consumers with a score of |
| Group | | #SCORE# as high risk, that does not mean that every lender will |
| Summary | | turn down every loan with a score of #SCORE#. Some lenders |
| | | may be willing to approve loan applicants with a score of |
| | | #SCORE#, but typically at higher rates and with more restrictive |
| | | terms. Other factors such as your income may also affect a |
| | | lender's willingness to extend credit to you. |
| Score | 620.000000 | Lenders may view consumers with a score of #SCORE# as a |
| Group | | slightly higher risk. Different lenders will evaluate other factors |
| Summary | | besides the score in their review of a loan application. While there |
| | | are many lenders who might approve loan applicants with a score |
| | | of #SCORE#, they may do so with higher rates or more restrictive |
| | | terms. |
| Score | 680.000000 | Most lenders view consumers with a score of #SCORE# as an |
| Group | | acceptable risk. But remember that lenders often consider other |
| Summary | | factors beyond just the score, and those factors might help or hurt |
| | | your application. Still, a score of #SCORE# is considered to be |
| | | acceptable by most lenders and would recommend you as a good |
| | | candidate for many types of credit products. |
| Score | 720.000000 | Your score of #SCORE# is very good, and suggests that you are |
| Group | | a dependable borrower. Chances are that you will have a wide array |
| Summary | | of credit available to you. The guidelines below may help you |
| | | improve your score somewhat over time, but your score is already |
| | | very strong. |
| Score | 760.000000 | Your score of #SCORE# is excellent, and suggests that you are |
| Group | | an exceptional borrower. Chances are that you will have the widest |
| Summary | | array of credit available to you. The guidelines below may help |
| | | you improve your score somewhat over time, but your score is |
| | | already very high. |
| Score Name | 1.000000 | EMPIRICA&reg; |
| Score Name | 2.000000 | BEACON&reg; |
| Score Name | 3.000000 | Experian/Fair, Isaac Risk Model |
| Score Name Article | 1.000000 | an |
| Score Name Article | 2.000000 | a |
| Score Name Article | 3.000000 | an |
| Score Name Unreg | 1.000000 | EMPIRICA |
| Score Name Unreg | 2.000000 | BEACON |
| Score Name Unreg | 3.000000 | Experian/Fair, Isaac Risk Model |
| Score Qualifier | 0.000000 | far below |
| Score Qualifier | 580.000000 | well below |
| Score Qualifier | 660.000000 | below |
| Score Qualifier | 680.000000 | somewhat below |
| Score Qualifier | 722.000000 | slightly below |
| Score Qualifier | 727.000000 | exactly |
| Score Qualifier | 729.000000 | slightly above |
| Score Qualifier | 735.000000 | above |
| Score Qualifier | 760.000000 | well above |

TABLE D
Per Bureau Reason Code Mapping

| Code | Bureau ID | Public Code |
|---|---|---|
| * | 1.00 | 22 |
| * | 2.00 | 22 |
| * | 3.00 | 22 |
| * | 3.00 | X |
| A0 | 1.00 | 07 |
| A0 | 1.00 | 7 |
| A0 | 2.00 | 07 |
| A0 | 2.00 | 7 |
| A0 | 3.00 | 07 |
| A0 | 3.00 | 7 |
| A0 | 3.00 | G |
| A3 | 1.00 | 01 |
| A3 | 1.00 | 1 |
| A3 | 2.00 | 01 |
| A3 | 2.00 | 1 |
| A3 | 3.00 | 01 |
| A3 | 3.00 | 1 |
| A3 | 3.00 | A |
| A6 | 1.00 | 31 |
| A6 | 2.00 | 34 |
| A6 | 3.00 | 34 |
| B5 | 1.00 | 11 |
| B5 | 2.00 | 11 |
| B5 | 3.00 | 11 |
| B5 | 3.00 | L |
| B6 | 1.00 | 21 |
| B6 | 2.00 | 21 |
| B6 | 3.00 | 21 |
| B6 | 3.00 | W |
| D1 | 1.00 | 19 |
| D4 | 1.00 | 40 |
| D4 | 2.00 | 40 |
| D4 | 3.00 | 40 |
| D6 | 1.00 | 02 |
| D6 | 1.00 | 2 |
| D6 | 2.00 | 02 |
| D6 | 2.00 | 2 |
| D6 | 3.00 | 02 |
| D6 | 3.00 | 2 |
| D6 | 3.00 | B |
| D7 | 1.00 | 39 |
| D7 | 2.00 | 39 |
| D7 | 3.00 | 39 |
| D8 | 1.00 | 38 |
| D8 | 2.00 | 38 |
| D8 | 3.00 | 38 |
| F3 | 2.00 | 98 |
| F4 | 1.00 | 97 |
| F4 | 3.00 | 98 |
| F5 | 1.00 | 15 |
| F5 | 2.00 | 15 |
| F5 | 3.00 | 15 |
| F5 | 3.00 | P |
| F6 | 1.00 | 99 |
| F6 | 2.00 | 99 |
| F6 | 3.00 | 99 |
| F7 | 1.00 | 04 |
| F7 | 1.00 | 4 |
| F7 | 2.00 | 32 |
| F7 | 3.00 | 32 |
| F7 | 3.00 | Y |
| G1 | 1.00 | 16 |
| G1 | 2.00 | 16 |
| G1 | 3.00 | 16 |
| G1 | 3.00 | Q |
| G3 | 1.00 | 29 |
| G3 | 3.00 | 29 |
| G4 | 1.00 | 17 |
| G4 | 2.00 | 17 |
| G4 | 3.00 | 17 |
| G4 | 3.00 | R |
| G6 | 1.00 | 24 |
| G6 | 2.00 | 24 |
| G6 | 3.00 | 24 |
| G6 | 3.00 | U |
| J0 | 1.00 | 14 |
| J0 | 2.00 | 14 |
| J0 | 3.00 | 14 |
| J0 | 3.00 | O |
| J3 | 1.00 | 98 |
| J4 | 2.00 | 25 |
| J4 | 3.00 | 25 |
| J6 | 3.00 | 36 |
| J8 | 1.00 | 12 |
| J8 | 2.00 | 12 |
| J8 | 3.00 | 12 |
| J8 | 3.00 | M |
| K0 | 1.00 | 13 |
| K0 | 2.00 | 13 |
| K0 | 3.00 | 13 |
| K0 | 3.00 | N |
| K1 | 1.00 | 20 |
| K1 | 2.00 | 20 |
| K1 | 3.00 | 20 |
| K1 | 3.00 | V |
| K2 | 1.00 | 30 |
| K2 | 2.00 | 30 |
| K2 | 3.00 | 30 |
| K2 | 3.00 | Z |
| M1 | 1.00 | 18 |
| M1 | 2.00 | 18 |
| M1 | 3.00 | 18 |
| M1 | 3.00 | S |
| M6 | 2.00 | 23 |
| M6 | 3.00 | 23 |
| M8 | 1.00 | 26 |
| N0 | 3.00 | 37 |
| N2 | 1.00 | 28 |
| N2 | 2.00 | 28 |
| N2 | 3.00 | 28 |
| N7 | 2.00 | 26 |
| N7 | 3.00 | 26 |
| P5 | 1.00 | 10 |
| P5 | 2.00 | 10 |
| P5 | 3.00 | 10 |
| P5 | 3.00 | K |
| P9 | 1.00 | 03 |
| P9 | 1.00 | 3 |
| P9 | 2.00 | 33 |
| P9 | 3.00 | 33 |
| P9 | 3.00 | I |
| R0 | 1.00 | 27 |
| R0 | 2.00 | 19 |
| R0 | 3.00 | 19 |
| R0 | 3.00 | T |
| R2 | 2.00 | 31 |
| R2 | 3.00 | 31 |
| R4 | 2.00 | 03 |
| R4 | 2.00 | 3 |
| R4 | 3.00 | 03 |
| R4 | 3.00 | 3 |
| R4 | 3.00 | C |
| T0 | 1.00 | 09 |
| T0 | 1.00 | 9 |
| T0 | 2.00 | 09 |
| T0 | 2.00 | 9 |
| T0 | 3.00 | 09 |
| T0 | 3.00 | 9 |
| T0 | 3.00 | J |
| T1 | 1.00 | 05 |
| T1 | 1.00 | 5 |
| T1 | 2.00 | 05 |
| T1 | 2.00 | 5 |
| T1 | 3.00 | 05 |
| T1 | 3.00 | 5 |
| T1 | 3.00 | E |
| T2 | 2.00 | 04 |
| T2 | 2.00 | 4 |
| T2 | 3.00 | 04 |
| T2 | 3.00 | 4 |
| T2 | 3.00 | D |
| T3 | 1.00 | 06 |
| T3 | 1.00 | 6 |
| T3 | 2.00 | 06 |
| T3 | 2.00 | 6 |
| T3 | 3.00 | 06 |
| T3 | 3.00 | 6 |
| T3 | 3.00 | F |
| T5 | 1.00 | 08 |
| T5 | 1.00 | 8 |
| T5 | 2.00 | 08 |
| T5 | 2.00 | 8 |
| T5 | 3.00 | 08 |
| T5 | 3.00 | 8 |
| T5 | 3.00 | H |
| X0 | 3.00 | 46 |

TABLE E
Expanded Reason Explanations

| Code | Reason | Friendly Reason Text | Action Text | 1st | Act |
|---|---|---|---|---|---|
| * | Serious | This reason occurs when there is a derogatory | It will take time | y | n |
| | delinquency, | public record, collection agency reference, or | for your score to | | |
| | derogatory | serious delinquency (late payment on a credit | improve if the | | |
| | public record, | account) on your credit bureau report. | derogatory public | | |
| | or collection | Analysis reveals that consumers with previous | record, collection | | |
| | filed | late payments are much more likely to pay | item, or serious | | |
| | | late in the future. There is no “quick” fix to | credit account | | |
| | | improve the score if the derogatory public | delinquency | | |
| | | record, collection item, or serious credit | appearing on your | | |
| | | account delinquency appearing on your credit | credit bureau | | |
| | | report is valid. However, as these age and fall | report is valid. | | |
| | | off the credit bureau report, their impact on | However, as these | | |
| | | the score will gradually decrease. | age and fall off | | |
| | | (Derogatory public records, collection items, | the credit report, | | |
| | | and credit account delinquencies stay on your | their impact on | | |
| | | report for up to seven years; there are items | the score will | | |
| | | that could remain longer.) Note that satisfying | gradually decrease. | | |
| | | or paying off a collection item or derogatory | | | |
| | | public record will not remove this information | | | |
| | | from your credit bureau report. The fact that | | | |
| | | it occurred is still predictive of future | | | |
| | | repayment risk, and thus it will still be | | | |
| | | considered by the score. | | | |
| A0 | Account payment | This reason occurs when none of the credit | Your credit score | n | n |
| | history is too | accounts in your credit bureau report have | should rise as | | |
| | new to rate | enough history for the score to consider. The | your credit | | |
| | | FICO score needs information on payments of | history lengthens | | |
| | | recently active credit accounts in order to | and includes enough | | |
| | | evaluate the likelihood of future payments | information for | | |
| | | being made on time. Each of the accounts in | the FICO score to | | |
| | | your file fall into one of four categories: the | evaluate. | | |
| | | account has just a few months of history, it is | | | |
| | | in dispute, the current status is missing, or the | | | |
| | | status indicates the account is “too new too | | | |
| | | rate.” Consumers who have no rateable | | | |
| | | accounts on file are, as a group, riskier than | | | |
| | | consumers with accounts in current status | | | |
| | | being reported to the bureau. Your credit | | | |
| | | score should rise as your credit history | | | |
| | | lengthens and includes enough information | | | |
| | | for the FICO score to evaluate. | | | |
| A3 | Amount owed | The score measures how much you owe on | Paying off your | n | y |
| | on accounts | the accounts (revolving and installment) that | debts should | | |
| | is too high | are listed on your credit bureau report. (For | improve your | | |
| | | credit cards, the total outstanding balance on | credit score. | | |
| | | your last statement is generally the amount | Consolidating or | | |
| | | that will show in your credit bureau report. | moving your debt | | |
| | | Note that even if you pay off your credit cards | around from one | | |
| | | in full each and every month, your credit | account to another | | |
| | | bureau report may show the last billing | will not, however, | | |
| | | statement balance on those accounts.) | raise your score, | | |
| | | Research reveals that consumers owing larger | since the same | | |
| | | amounts on their credit accounts have greater | amount is still | | |
| | | future repayment risk than those who owe | owed. | | |
| | | less. You can improve your credit score by | | | |
| | | paying off your debts. Consolidating or | | | |
| | | moving your debt around from one account to | | | |
| | | another will not, however, raise your score, | | | |
| | | since the same amount is still owed. The best | | | |
| | | advice is to pay off your debts as quickly as | | | |
| | | you can. | | | |
| A4 | Amount owed on | The score measures how much you owe on | Paying off your | n | n |
| | bank/national | the bank/national revolving accounts that are | debts may help to | | |
| | revolving | listed on your credit bureau report. (For | improve your | | |
| | accounts | credit cards, the total outstanding balance on | credit score. | | |
| | | your last statement is generally the amount | | | |
| | | that will show in your credit bureau report. | | | |
| | | Note that even if you pay off your credit cards | | | |
| | | in full each and every month, your credit | | | |
| | | bureau report may show the last billing | | | |
| | | statement balance on those accounts.) | | | |
| | | Research has shown that consumers owing | | | |
| | | larger amounts on their revolving credit | | | |
| | | accounts have greater future repayment risk | | | |
| | | than those who owe less. You can improve | | | |
| | | your credit rating by paying off your debts. | | | |
| | | Consolidating or moving your debt around | | | |
| | | from one account to another will not, | | | |
| | | however, raise your score, since the same | | | |
| | | amount is still owed. The best advice is to | | | |
| | | pay off your debts as quickly as you can. | | | |
| A6 | Amount owed on | This reason appears when there is evidence of | It will take time | n | n |
| | delinquent | recently missed payments on your credit | to improve your | | |
| | accounts | bureau report. Late payments are a very | score. You need | | |
| | | powerful predictor of future repayment risk. | to get caught up | | |
| | | Research shows that the greater the balances | on back payments | | |
| | | on past due accounts, the higher the risk. In | and make future | | |
| | | order to improve your credit rating you need | payments on time. | | |
| | | to pay your bills on time. If you have missed | The longer you pay | | |
| | | payments, get caught up on back payments | your bills on time, | | |
| | | and stay current. The longer you pay your | the better your | | |
| | | bills on time, the better your score. Note that | score. | | |
| | | closing an account on which a past due | | | |
| | | balance is still owed does not make it | | | |
| | | disappear from your credit report. | | | |
| B5 | Amount owed on | The score measures how much you owe on | Improve your | n | y |
| | revolving | the revolving accounts that are listed on your | credit score by | | |
| | accounts is | credit bureau report. (For credit cards, the | paying off your | | |
| | too high | total outstanding balance on your last | debts as quickly | | |
| | | statement is generally the amount that will | as you can. | | |
| | | show in your credit bureau report. Note that | | | |
| | | even if you pay off your credit cards in full | | | |
| | | each and every month, your credit bureau | | | |
| | | report may show the last statement balance on | | | |
| | | those accounts.) Research has shown that | | | |
| | | consumers owing larger amounts on their | | | |
| | | revolving credit accounts have greater future | | | |
| | | repayment risk than those who owe less. You | | | |
| | | can improve your credit score by paying off | | | |
| | | your debts. Consolidating or moving your | | | |
| | | debt around from one account to another will | | | |
| | | not, however, raise your score, since the same | | | |
| | | amount is still owed. The best advice is to | | | |
| | | pay off your debts as quickly as you can. | | | |
| B6 | Amount past due | This reason appears when there is evidence of | To improve your | n | y |
| | on accounts | recently missed payments on your credit | score if you have | | |
| | | bureau report. If one of your accounts is being | missed payments, | | |
| | | reported in delinquent status, the amount past | get caught up on | | |
| | | due on the account is indicated on your credit | back payments | | |
| | | bureau report. Research demonstrates that the | and make future | | |
| | | greater the past due amount, the higher the | payments on time. | | |
| | | risk. In order to improve your credit rating | | | |
| | | you need to pay your bills on time. If you | | | |
| | | have missed payments, get caught up on back | | | |
| | | payments and stay current. The longer you | | | |
| | | pay your bills on time, the better your score. | | | |
| | | Closing an account on which a past due | | | |
| | | amount is still owed does not make it | | | |
| | | disappear from your credit bureau report. | | | |
| D1 | Date of last | This reason appears when your credit bureau | To improve your | n | n |
| | inquiry too | report contains recent inquiries posted as a | score over time | | |
| | recent | result of your applying for credit. Research | apply for credit | | |
| | | shows that consumers who are seeking | only when you | | |
| | | several new credit accounts are riskier than | need it. | | |
| | | consumers who are not seeking credit. | | | |
| | | Inquiries are the only information lenders | | | |
| | | have that indicates a consumer is actively | | | |
| | | seeking credit. There are different types of | | | |
| | | inquiries that reside on your credit bureau | | | |
| | | report. The score only considers those | | | |
| | | inquiries that were posted as a result of you | | | |
| | | applying for credit. Other types of inquiries, | | | |
| | | such as promotional inquiries (where a lender | | | |
| | | has pre-approved you for a credit offer) or | | | |
| | | consumer disclosure inquiries (where you | | | |
| | | have requested a copy of your own report) are | | | |
| | | not considered by the score.<br><br>The | | | |
| | | scores can identify “rate shopping” in the | | | |
| | | mortgage and auto-lending environment, so | | | |
| | | that one credit search involving multiple | | | |
| | | inquiries is usually only counted as a single | | | |
| | | inquiry.<br><br>Typically, the presence of | | | |
| | | inquiries on your credit file has only a small | | | |
| | | impact on FICO scores, carrying much less | | | |
| | | importance than late payments, the amount | | | |
| | | you owe, and the length of time you have | | | |
| | | used credit. This reason rarely appears as a | | | |
| | | primary or secondary reason except in high- | | | |
| | | scoring files. As time passes the age of your | | | |
| | | most recent inquiry will increase, and your | | | |
| | | score will rise as a result, provided you do not | | | |
| | | apply for additional credit in the meantime. | | | |
| | | Typically inquiries are purged from the credit | | | |
| | | bureau files after two years.<br><br>A | | | |
| | | common misperception is that every single | | | |
| | | inquiry will drop your score a certain number | | | |
| | | of points. This is not true. The impact of | | | |
| | | inquiries on your score will vary - depending | | | |
| | | on your overall credit profile. Inquiries will | | | |
| | | usually have a larger impact on the score for | | | |
| | | consumers with limited credit history and on | | | |
| | | consumers with previous late payments. The | | | |
| | | most prudent action to raise your score over | | | |
| | | time is by applying for credit <i>only</i> | | | |
| | | when you need it. | | | |
| D4 | Derogatory | This reason appears whenever there is | There is no | y | n |
| | public record | derogatory public record or collection agency | “quick” fix to | | |
| | or collection | reference on your credit bureau report. | improve the score | | |
| | filed | Studies reveal that consumers with previous | if the derogatory | | |
| | | missed payments are much more likely to | public record or | | |
| | | miss payments in the future. There is no | collection item on | | |
| | | “quick” fix to improve the score if the | your credit bureau | | |
| | | derogatory public record or collection item on | report is valid. | | |
| | | your credit bureau report is valid. However, | However, as these | | |
| | | as these age and fall off the credit bureau | age and fall off | | |
| | | report, their impact on the score will | the credit report, | | |
| | | gradually decrease. (Derogatory public | their impact on | | |
| | | records and collection items stay on your | the score will | | |
| | | report for up to seven years; there are other | gradually decrease. | | |
| | | items that could remain longer.) Note that | | | |
| | | satisfying or paying off the collection item or | | | |
| | | derogatory public record will not remove this | | | |
| | | information from your credit bureau report. | | | |
| | | The fact that it occurred is still predictive of | | | |
| | | future repayment risk, and thus it will still be | | | |
| | | considered by the score. | | | |
| D6 | Level of | Research reveals that consumers with | Paying your bills | n | n |
| | delinquency | previous late payments are much more likely | on time is the best | | |
| | on accounts | to pay late in the future. The score evaluates | way to improve | | |
| | | not only the presence of previous late | your credit rating. | | |
| | | payments, but also how late the payments | As time passes | | |
| | | were. For example, a payment that was 90 | the importance of | | |
| | | days late represents greater risk than a | previous late | | |
| | | payment that was 30 days late, if they | payments will | | |
| | | occurred around the same time. But even a | gradually lessen | | |
| | | 30 day late payment represents much greater | and the score will | | |
| | | risk than a spotless payment history. There is | increase - as long | | |
| | | no “quick” fix to raise your score if the late | as you make your | | |
| | | payment on your credit bureau report is valid. | payments on time | | |
| | | In order to improve your credit rating over | on all of your | | |
| | | time, you need to pay your bills on time. The | credit obligations, | | |
| | | longer you pay your bills on time, the better | while maintaining | | |
| | | the score. If you have late payments, get | a low-to-moderate | | |
| | | caught up on back payments and stay current. | amount of out- | | |
| | | As time passes the importance of these | standing debt. | | |
| | | previous late payments will <i>gradually</i> | | | |
| | | lessen and the score will increase - as long as | | | |
| | | you make your payments on time on all of | | | |
| | | your credit obligations, and use your available | | | |
| | | credit responsibly. | | | |
| D7 | Serious | This reason appears when your credit bureau | It will take time | y | n |
| | delinquency | report shows one or more serious | to improve the | | |
| | | delinquencies on your credit accounts. | score if the | | |
| | | Studies reveal that consumers with previous | serious delinquency | | |
| | | late payments are much more likely to pay | indicated on your | | |
| | | late in the future. There is no “quick” fix to | credit bureau | | |
| | | improve the score if the serious delinquency | report is valid. As | | |
| | | indicated on your credit bureau report is valid. | these reference | | |
| | | However, as these age and fall off the credit | age and fall off | | |
| | | bureau report (credit account delinquencies | the credit report, | | |
| | | stay on your report for up to seven years), | their impact on | | |
| | | their impact on the score will gradually | the score will | | |
| | | decrease. | gradually decrease. | | |
| D8 | Serious | This reason occurs when there is a derogatory | There is no | y | n |
| | delinquency, | public record or collection agency reference, | “quick” fix to | | |
| | and public | as well as one or more serious delinquencies | improve the score | | |
| | record or | on your credit accounts, appearing on your | if the derogatory | | |
| | collection | credit bureau report. Studies reveal that | public record, | | |
| | filed | consumers with previous late payments are | collection item, or | | |
| | | much more likely to pay late in the future. | serious credit | | |
| | | There is no “quick” fix to improve the score if | account delinquency | | |
| | | the derogatory public record, collection item, | appearing on your | | |
| | | or serious credit account delinquency | credit bureau | | |
| | | appearing on your credit bureau report is | report is valid. | | |
| | | valid. However, as these age and fall off the | However, as these | | |
| | | credit bureau report, their impact on the score | age and fall off | | |
| | | will gradually decrease. (Derogatory public | the credit report, | | |
| | | records, collection items, and credit account | their impact on | | |
| | | delinquencies stay on your report for up to | the score will | | |
| | | seven years; there are items that could remain | gradually decrease. | | |
| | | longer.) Note that satisfying or paying off the | | | |
| | | collection item or derogatory public record | | | |
| | | will not remove this information from your | | | |
| | | credit bureau report. The fact that it occurred | | | |
| | | is still predictive of future repayment risk, and | | | |
| | | thus it will still be considered by the score. | | | |
| F3 | Lack of recent | This reason appears when a lender is using a | To improve your | n | n |
| | auto finance | score for auto financing and when no auto | score you need to | | |
| | loan information | finance company loans (loans with lenders | establish a credit | | |
| | | such as GMAC, Ford Motor Credit, Chrysler | history and | | |
| | | Financial Corp., etc.) are found on the credit | demonstrate that | | |
| | | bureau report, or all such accounts are closed, | you can manage | | |
| | | or are no longer being reported by the lender. | credit responsibly. | | |
| | | The score evaluates the types of credit in your | | | |
| | | credit history, and will consider your mix of | | | |
| | | credit cards, retail accounts, installment loans, | | | |
| | | finance company accounts and mortgage | | | |
| | | loans. It is not necessary to have one of each, | | | |
| | | and it is not a good idea to open credit | | | |
| | | accounts you have no need for, or don't intend | | | |
| | | to use. New loans and the associated | | | |
| | | inquiries may lower your score in the short- | | | |
| | | term. To improve your score you need to | | | |
| | | establish a credit history and demonstrate that | | | |
| | | you can manage credit responsibly. | | | |
| F4 | Lack of recent | This reason appears when you are working | To improve your | n | n |
| | auto loan | with a lender in auto financing and when no | score you need to | | |
| | information | auto loans are found on the credit bureau | establish a credit | | |
| | | report, or all such accounts are closed, or are | history and | | |
| | | no longer being reported by the lender. | demonstrate that | | |
| | | (Some banks or credit unions may not | you can manage | | |
| | | indicate “auto loan” on such loans when they | credit responsibly. | | |
| | | report to the credit reporting agencies.) The | | | |
| | | score evaluates the types of credit in your | | | |
| | | credit history, and will consider your mix of | | | |
| | | credit cards, retail accounts, installment loans, | | | |
| | | finance company accounts and mortgage | | | |
| | | loans. It is not necessary to have one of each, | | | |
| | | and it is not a good idea to open credit | | | |
| | | accounts you have no need for, or don't intend | | | |
| | | to use. New loans and the associated | | | |
| | | inquiries may lower your score in the short- | | | |
| | | term. Over time you will build a history | | | |
| | | which demonstrates your ability to manage | | | |
| | | different types of credit. | | | |
| F5 | Lack of recent | This reason appears when no bankcard | To improve your | n | n |
| | bank/national | accounts (Visa, MasterCard, Discover, | score you need to | | |
| | revolving | American Express, Diners Club, etc.) appear | establish a credit | | |
| | information | on the credit bureau report, or all such | history and | | |
| | | accounts are closed, or are no longer being | demonstrate that | | |
| | | reported by the lender. The score evaluates | you can manage | | |
| | | the types of credit in your credit history and | credit responsibly. | | |
| | | will consider your mix of credit cards, retail | | | |
| | | accounts, installment loans, finance company | | | |
| | | accounts and mortgage loans. It is not | | | |
| | | necessary to have one of each, and it is not a | | | |
| | | good idea to open credit accounts you have no | | | |
| | | need for, or don't intend to use. Opening a | | | |
| | | bankcard account might be a long-term | | | |
| | | strategy to improve your score and | | | |
| | | demonstrate that you can manage credit | | | |
| | | responsibly. However, new account openings | | | |
| | | and the associated inquiries may lower your | | | |
| | | score in the short term. To improve your | | | |
| | | score you need to establish a credit history | | | |
| | | with several types of loan or account | | | |
| | | relationships and demonstrate that you can | | | |
| | | manage credit responsibly. Over time you | | | |
| | | will build a history which demonstrates your | | | |
| | | ability to manage different types of credit. | | | |
| F7 | Lack of recent | This reason appears when no installment loan | To improve your | n | n |
| | installment | accounts appear on the credit bureau report, | score you need to | | |
| | loan information | or all such accounts are closed, or are no | establish a credit | | |
| | | longer being reported by the lender. The score | history and | | |
| | | evaluates the types of credit in your credit | demonstrate that | | |
| | | history and will consider your mix of credit | you can manage | | |
| | | cards, retail accounts, installment loans, | credit responsibly. | | |
| | | finance company accounts and mortgage | | | |
| | | loans. It is not necessary to have one of each, | | | |
| | | and it is not a good idea to open credit | | | |
| | | accounts you have no need for, or don't intend | | | |
| | | to use. Establishing a new loan might be a | | | |
| | | long-term strategy to improve your score and | | | |
| | | demonstrate that you can manage credit | | | |
| | | responsibly. However the new loan and the | | | |
| | | associated inquiries may lower your score in | | | |
| | | the short-term. Over time you will build a | | | |
| | | history which demonstrates your ability to | | | |
| | | manage different types of credit. | | | |
| G1 | Lack of recent | This reason appears when no revolving | To improve your | n | n |
| | revolving | accounts (such as retail credit cards, bank or | score it will take | | |
| | account | national credit cards, etc.) appear on the credit | time to establish a | | |
| | information | bureau report, or all such accounts are closed, | credit history with | | |
| | | or are no longer being reported by the lender. | several types of | | |
| | | The score evaluates the types of credit in your | loan or account | | |
| | | credit history and will consider your mix of | relationships and | | |
| | | credit cards, retail accounts, installment loans, | demonstrate that | | |
| | | finance company accounts and mortgage | you can manage | | |
| | | loans. It is not necessary to have one of each, | credit responsibly. | | |
| | | and it is not a good idea to open credit | | | |
| | | accounts you have no need for, or don't intend | | | |
| | | to use. To improve your score you need to | | | |
| | | establish a credit history with several types of | | | |
| | | loan or account relationships and demonstrate | | | |
| | | that you can manage credit responsibly. | | | |
| | | Opening a revolving account might be a long- | | | |
| | | term strategy to improve your score and | | | |
| | | demonstrate that you can manage credit | | | |
| | | responsibly. However, new account openings | | | |
| | | and the associated inquiries may lower your | | | |
| | | score in the short term. Over time you will | | | |
| | | build a history which demonstrates your | | | |
| | | ability to manage different types of credit. | | | |
| G3 | No recent | The score evaluates the types of credit | Demonstrating | n | n |
| | bank/national | currently in use, or that you have used in the | the ability to | | |
| | revolving | past, and will consider the mix of retail cards, | moderately and | | |
| | balances | bankcards, and installment loans appearing on | responsibly use | | |
| | | your credit bureau report. In general, | bank or national | | |
| | | moderate and responsible use of bank or | revolving accounts | | |
| | | national revolving accounts (Visa, | (Visa, MasterCard, | | |
| | | MasterCard, Discover, American Express, | Discover, American | | |
| | | Diner's Club, etc.) will boost the score | Express, Diner's | | |
| | | slightly. Research shows that consumers with | Club, etc.) may | | |
| | | very moderate usage of bankcard accounts | boost the score | | |
| | | (charging low balances and repaying them on | slightly. | | |
| | | time) have slightly better repayment risk than | | | |
| | | those who do not use bankcard credit at all. | | | |
| G4 | No recent | This reason occurs when all credit accounts | Use of other types | n | n |
| | non-mortgage | (except possibly a mortgage loan) appearing | of credit may | | |
| | balance | on the credit bureau report, are closed, or are | improve your score. | | |
| | information | no longer being reported by the lender. | | | |
| | | Research shows that consumers who use | | | |
| | | credit very moderately (and make all their | | | |
| | | payments on time) have slightly better | | | |
| | | repayment risk on new accounts than those | | | |
| | | who have not been using credit at all for some | | | |
| | | time. Note that it is not a good idea to open | | | |
| | | credit accounts you have no need for, or don't | | | |
| | | intend to use. Opening an account might be a | | | |
| | | long-term strategy to improve your score and | | | |
| | | demonstrate that you can manage credit | | | |
| | | responsibly. However, new account openings | | | |
| | | and the associated inquiries may lower your | | | |
| | | score in the short term. | | | |
| G6 | No recent | The score evaluates the types of credit | Demonstrating | n | n |
| | revolving | currently in use, or that you have used in the | the ability to | | |
| | balances | past, and will consider the mix of retail cards, | moderately and | | |
| | | bankcards, and installment loans appearing on | responsibly use | | |
| | | your credit bureau report. In general, | revolving credit | | |
| | | moderate and responsible use of revolving | accounts may boost | | |
| | | credit accounts will boost the score slightly. | the score slightly. | | |
| | | Research shows that consumers with very | | | |
| | | moderate usage of revolving credit accounts | | | |
| | | (charging low balances and repaying them on | | | |
| | | time) have slightly better repayment risk than | | | |
| | | those who do not use revolving credit at all. | | | |
| J0 | Length of time | This reason is based on the age of the | Your score should | n | n |
| | accounts | accounts on your credit bureau report (the age | improve as your | | |
| | have been | of the oldest account, the average age of | credit history ages. | | |
| | established | accounts, or both). Research shows that | | | |
| | | consumers with longer credit histories have | | | |
| | | better repayment risk than those with shorter | | | |
| | | credit histories. Also, consumers who | | | |
| | | frequently open new accounts have greater | | | |
| | | repayment risk than those who do not. | | | |
| | | Therefore, only apply for needed credit and | | | |
| | | wait before you apply for more. All other | | | |
| | | factors being equal, your score is likely to | | | |
| | | improve as your credit history ages. | | | |
| J3 | Length of time | This reason is based on the age of the finance | It will take time | n | n |
| | consumer finance | company loan accounts on your credit bureau | for your score to | | |
| | company loans | report (the age of the oldest finance company | improve. You | | |
| | have been | loan, the average age of finance company | score should | | |
| | established | loans, or both). Research shows that | improve as your | | |
| | | consumers with longer credit histories have | credit history ages. | | |
| | | better repayment risk than those with shorter | | | |
| | | credit histories. All other factors being equal, | | | |
| | | your score is likely to improve as your credit | | | |
| | | history ages. | | | |
| J4 | Length of time | This reason is based on the age of the | Your score should | n | n |
| | installment | installment loan accounts on your credit | improve as your | | |
| | loans have been | bureau report (the age of the oldest loan, the | credit history ages. | | |
| | established | average age of installment loans, or both). | | | |
| | | Research shows that consumers with longer | | | |
| | | credit histories have better repayment risk | | | |
| | | than those with shorter credit histories. All | | | |
| | | other factors being equal, your score is likely | | | |
| | | to improve as your credit history ages. | | | |
| J6 | Length of time | This reason is based on the age of the open | Your score should | n | n |
| | open installment | installment loan accounts on your credit | improve as your | | |
| | loans have been | bureau report (the age of the oldest open loan, | credit history ages. | | |
| | established | the average age of open installment loans, or | | | |
| | | both). Research shows that consumers with | | | |
| | | longer credit histories have better repayment | | | |
| | | risk than those with shorter credit histories. | | | |
| | | Only apply for needed credit and wait before | | | |
| | | you apply for more. All other factors being | | | |
| | | equal, your score is likely to improve as your | | | |
| | | credit history ages. | | | |
| J8 | Length of time | This reason is based on the age of the | Only apply for | n | n |
| | revolving | revolving accounts on your credit bureau | needed credit. | | |
| | accounts | report (the age of the oldest account, the | Maintain low-to- | | |
| | have been | average age of accounts, or both). Research | moderate balances | | |
| | established | shows that consumers with longer credit | and make your | | |
| | | histories have better repayment risk than | payments on time | | |
| | | those with shorter credit histories. Also, | and your score | | |
| | | consumers who frequently open new accounts | should improve as | | |
| | | have greater repayment risk than those who | your credit | | |
| | | do not. Therefore, only apply for needed | history ages. | | |
| | | credit and wait before you apply for more. | | | |
| | | All other factors being equal, your score is | | | |
| | | likely to improve as your credit history ages. | | | |
| K0 | Time since | Analysis of consumer credit histories shows | Over time the | n | n |
| | delinquency | that consumers with previous late payments | importance of | | |
| | is too recent | are much more likely to pay late in the future. | previous late | | |
| | or unknown | The FICO score evaluates not only the | payments will | | |
| | | presence of previous late payments, but also | lessen. If you | | |
| | | how recently the missed payments occurred. | have late payments, | | |
| | | In general, the more recently a payment was | get caught up on | | |
| | | missed, the greater the risk, and the lower the | back payments and | | |
| | | score. There is no “quick” fix to raise your | stay current. | | |
| | | score if the late payment on your credit | | | |
| | | bureau report is valid. (Credit account | | | |
| | | delinquencies stay on your report for up to | | | |
| | | seven years. Note that closing an account on | | | |
| | | which you had previously missed a payment | | | |
| | | does not make the late payment disappear | | | |
| | | from your credit bureau report.) In order to | | | |
| | | improve your credit score over time, you need | | | |
| | | to pay your bills on time. The longer you pay | | | |
| | | your bills on time, the better the score. If you | | | |
| | | have late payments, get caught up on back | | | |
| | | payments and stay current. As time passes | | | |
| | | the importance of these previous late | | | |
| | | payments will <i>gradually</i> lessen and | | | |
| | | the score will increase - as long as you make | | | |
| | | your payments on time on all of your credit | | | |
| | | obligations, and use your available credit | | | |
| | | responsibly.<br><br>In rare cases, evidence | | | |
| | | of a past missed payment on a credit account | | | |
| | | is present on the credit report, but the date of | | | |
| | | the late payment cannot be determined | | | |
| | | exactly. An “undateable” credit account | | | |
| | | delinquency on a credit report still represents | | | |
| | | greater risk than never having missed a | | | |
| | | payment at all, and thus it will still affect the | | | |
| | | score. | | | |
| K1 | Time since | For consumers with derogatory public records | Improving your | n | n |
| | derogatory | or collection agency references on their credit | credit score will | | |
| | public record | bureau reports, a strong predictor of future | take time. Get | | |
| | or collection | repayment risk is the recency of the item. All | caught up on back | | |
| | is too short | other factors being equal, your FICO score | payments and stay | | |
| | | will improve with time as your derogatory | current on all | | |
| | | public record or collection item becomes | of your credit | | |
| | | older. There is no “quick” fix to raise your | obligations. The | | |
| | | score if the derogatory item on your credit | longer you pay your | | |
| | | bureau report is valid. Your best course of | bills on time, the | | |
| | | action to improve your credit rating is to get | better your score. | | |
| | | caught up on back payments and stay current | | | |
| | | on all of your credit obligations. The longer | | | |
| | | you pay your bills on time, the better your | | | |
| | | score. Federal law requires that derogatory | | | |
| | | public records and collection items remain on | | | |
| | | your credit bureau report for no more than | | | |
| | | seven years (there are items which could | | | |
| | | remain longer). Note that satisfying or paying | | | |
| | | off a collection item or derogatory public | | | |
| | | record does not make it disappear from your | | | |
| | | credit report. Research shows that the fact | | | |
| | | that it occurred is still predictive of future | | | |
| | | repayment risk, and thus it will still be | | | |
| | | considered by the score. | | | |
| K2 | Time since | Research shows that consumers who have | To improve your | n | n |
| | most recent | recently opened new credit accounts are | score, open new | | |
| | account opening | slightly more likely to miss payments than | credit accounts | | |
| | is too short | those who have not. This is not an especially | only when necessary. | | |
| | | strong risk factor, and therefore usually means | | | |
| | | the difference of no more than a few points in | | | |
| | | a consumer's FICO score. As with many | | | |
| | | other elements of the FICO score, this | | | |
| | | component of the score will improve with | | | |
| | | time. To improve your score, avoid opening | | | |
| | | new credit accounts unless necessary. It is | | | |
| | | possible that opening additional new accounts | | | |
| | | may lower your score. | | | |
| M1 | Number of | The appearance of this reason indicates that | It is important to | n | n |
| | accounts with | there is past or present evidence of late | pay all your credit | | |
| | delinquency | payments on one or more of your credit | obligations on | | |
| | | obligations. Late payments are a very | time. Additional | | |
| | | powerful predictor of future repayment risk. | missed payments | | |
| | | There is no “quick” fix to improve the score if | may lower your score. | | |
| | | these reported late payments are valid. | | | |
| | | However, as these missed payments age and | | | |
| | | fall off the credit bureau report (late payments | | | |
| | | stay on your report for up to seven years), | | | |
| | | their impact on the score will gradually | | | |
| | | decrease. In the meantime, it is important to | | | |
| | | pay all your credit obligations on time. | | | |
| | | Additional missed payments may lower your | | | |
| | | score. | | | |
| M6 | Number of | A bank or national revolving account includes | In order to | n | y |
| | bank/national | Visa, MasterCard, American Express, | improve your | | |
| | revolving | Discover, Diner's Club, and similar accounts. | credit score, pay | | |
| | accounts | Research shows that carrying balances on too | down your credit | | |
| | with balances | many bankcards at once is a predictor of | card balances. In | | |
| | | future repayment risk. (Note that even if you | the future, keep | | |
| | | pay off your balance in full every month, your | your balances | | |
| | | credit bureau report may show a balance on | lower on credit | | |
| | | those cards. The total balance on your last | cards and other | | |
| | | statement is generally the amount that will | “revolving” debt. | | |
| | | show in your credit bureau report.) In order | | | |
| | | to improve your credit rating, pay down those | | | |
| | | credit card balances. And once they are paid | | | |
| | | down, keep your balances lower on credit | | | |
| | | cards and other “revolving” debt. Note that | | | |
| | | consolidating your debt by transferring | | | |
| | | balances from many cards onto fewer cards | | | |
| | | will not necessarily raise your score, because | | | |
| | | the same total amount is still owed. Paying | | | |
| | | off your debt is the best way to raise your | | | |
| | | score. | | | |
| M8 | Number of | If this reason is appearing, most likely your | Continue to | n | n |
| | bank/national | score is fairly high, in which case you should | manage your | | |
| | revolving or | have an excellent chance of being approved | revolving credit | | |
| | other revolving | for credit, and receiving favorable terms. You | accounts responsibly. | | |
| | accounts | have slightly fewer bank or national credit | | | |
| | | card accounts (e.g. Visa, MasterCard, | | | |
| | | Discover, American Express, Diner's Club, | | | |
| | | etc.) appearing on your credit bureau report | | | |
| | | than other consumers with relatively high | | | |
| | | scores. | | | |
| N0 | Number of | This reason is based on a measurement of the | Over time your | n | n |
| | consumer finance | frequency at which you have opened new | score should | | |
| | company accounts | finance company loan accounts since your | improve if you | | |
| | established | first finance company account was opened. | apply for new | | |
| | relative to | (If only one finance company loan appears on | credit only when | | |
| | length of | your credit bureau report, then this reason is | you need it. | | |
| | consumer finance | based on how recently that account was | | | |
| | history | opened.) Research shows that consumers | | | |
| | | who frequently open new accounts have | | | |
| | | greater repayment risk than those who do not. | | | |
| | | Therefore, only apply for needed credit and | | | |
| | | wait before you apply for more. | | | |
| N2 | Number of | This reason may appear with credit bureau | Avoid applying | n | n |
| | established | reports with relatively short credit histories, | credit you don't | | |
| | accounts | but which have an unusually high number of | need, or don't | | |
| | | credit accounts for such a young file. This | intend to use. | | |
| | | reason may also appear with older credit files | Improve your credit | | |
| | | which have an unusually high number of | score by managing | | |
| | | credit accounts on file. Studies demonstrate | your accounts | | |
| | | that consumers with a relatively large number | responsibly, and | | |
| | | of credit accounts appearing on their credit | make your payments | | |
| | | bureau report represent higher risk than | on time. | | |
| | | consumers with fewer credit accounts. | | | |
| | | Therefore, avoid applying for credit you don't | | | |
| | | need, or don't intend to use. (Note that | | | |
| | | closing your existing accounts will not make | | | |
| | | them disappear from your credit bureau report | | | |
| | | immediately.) The best way to improve your | | | |
| | | credit rating is by managing <i>all</i> of | | | |
| | | your accounts responsibly, and not missing | | | |
| | | any payments. | | | |
| P5 | Proportion of | Analysis of consumer credit behavior | Paying down your | n | y |
| | balances to | repeatedly finds that owing a substantial | revolving account | | |
| | credit limits | balance on revolving accounts relative to the | balances may | | |
| | on | amount of revolving credit available to you | increase your score. | | |
| | bank/national | represents increased risk. In fact, the level of | | | |
| | revolving or | revolving debt is one of the most important | | | |
| | other revolving | factors in the FICO score. The score | | | |
| | accounts is | evaluates your total balances in relation to | | | |
| | too high | your total available credit on revolving | | | |
| | | accounts, as well as on individual revolving | | | |
| | | accounts. For a given amount of revolving | | | |
| | | credit available, a greater amount owed | | | |
| | | indicates a greater risk, and lowers the score. | | | |
| | | (For credit cards, the total outstanding balance | | | |
| | | on your last statement is generally the amount | | | |
| | | that will show in your credit bureau report. | | | |
| | | Note that even if you pay off your credit cards | | | |
| | | in full each and every month, your credit | | | |
| | | bureau report may show the last billing | | | |
| | | statement balance on those | | | |
| | | accounts.)<br><br>Paying down your | | | |
| | | revolving account balances is a good sign that | | | |
| | | you are able and willing to manage and repay | | | |
| | | your debt, and this will increase your score. | | | |
| | | On the other hand, shifting balances among | | | |
| | | revolving accounts, opening up new revolving | | | |
| | | accounts, and closing down other revolving | | | |
| | | accounts will not necessarily improve your | | | |
| | | score, and could possibly decrease your score. | | | |
| P9 | Proportion of | Simply having installment loans and owing | Paying down your | n | y |
| | loan balances | money on them does not mean you are a high- | installment loan | | |
| | to loan amounts | risk borrower. To the contrary, paying down | or loans as quickly | | |
| | is too high | installment loans is a good sign that you are | as possible may | | |
| | | able and willing to manage and repay debt, | help improve your | | |
| | | and evidence of successful repayment weighs | score. | | |
| | | favorably on your credit rating. The FICO | | | |
| | | score examines many aspects of your current | | | |
| | | installment loan and revolving balances. One | | | |
| | | measurement is to compare the total | | | |
| | | outstanding installment balances against the | | | |
| | | total original loan amounts. Generally, the | | | |
| | | closer the loans are to being fully paid off, the | | | |
| | | better the score. Compared to other | | | |
| | | measurements of indebtedness, however, this | | | |
| | | has limited influence on the FICO score. | | | |
| | | Your best strategy to improve your score is to | | | |
| | | pay down your installment loan or loans as | | | |
| | | quickly as possible. | | | |
| R0 | Too few accounts | There are two possible reasons why this code | Pay your bills on | n | n |
| | currently paid | appears with a score. The <i>first</i> | time. The longer | | |
| | as agreed | possibility is if one or more of your accounts | you pay your bills | | |
| | | is presently being reported in delinquent | on time, the better | | |
| | | status, or your report shows evidence of | your score. | | |
| | | missed payments in the past. If you have | | | |
| | | missed payments, get caught up on back | | | |
| | | payments and stay current. The longer you | | | |
| | | pay your bills on time, the better your score. | | | |
| | | <i>Second</i>, if no missed payments appear | | | |
| | | on your credit bureau report, and this reason | | | |
| | | appears with your score, then your score | | | |
| | | would be improved by adding more | | | |
| | | successful repayment history to your record. | | | |
| | | Research shows that consumers with a | | | |
| | | moderate number of successfully paid | | | |
| | | accounts appearing on their credit bureau | | | |
| | | report have better future repayment risk than | | | |
| | | consumers with just a few credit accounts on | | | |
| | | file. | | | |
| R2 | Too few accounts | This reason may appear when the credit | To improve your | n | n |
| | with recent | bureau report shows a relative lack of credit | credit score over | | |
| | payment | repayment experience (i.e., credit history is | time you need to | | |
| | information | short, or the number of successfully paid | demonstrate that | | |
| | | credit accounts is low). Research shows that | you pay your bills | | |
| | | consumers with more credit experience have | on time. If you | | |
| | | better repayment risk than those with less | have missed payments, | | |
| | | experience. This reason may also appear | get caught up on | | |
| | | when there is a derogatory public record, | these and make | | |
| | | collection agency reference, or serious credit | future payments | | |
| | | account delinquency on your report, and the | before the due date. | | |
| | | number of credit accounts with recent activity | | | |
| | | being reported is low. In this case, in order to | | | |
| | | improve your credit rating you need to pay | | | |
| | | your bills on time. If you have missed | | | |
| | | payments, get caught up on back payments | | | |
| | | and stay current. The longer you pay your | | | |
| | | bills on time, the better your score. | | | |
| R4 | Too few | You have slightly fewer bankcard accounts | To improve your | n | n |
| | bank/national | (such as Visa, MasterCard, Discover, | score it will take | | |
| | revolving | American Express, Diners Club, etc.) | time to establish a | | |
| | accounts | appearing on your credit bureau report than | credit history with | | |
| | | other consumers with credit histories of | several types of | | |
| | | similar length. Opening a bankcard account | loan or account | | |
| | | might be a long-term strategy to improve your | relationships and | | |
| | | score and demonstrate that you can manage | demonstrate that | | |
| | | credit responsibly. However new account | you can manage | | |
| | | openings and the associated inquiries may | credit responsibly. | | |
| | | lower your score in the short-term. Over time | | | |
| | | you will build a history which demonstrates | | | |
| | | your ability to manage different types of | | | |
| | | credit. | | | |
| T0 | Too many accounts | Analysis repeatedly finds that opening several | Avoid opening more | n | n |
| | recently opened | credit accounts in a short period of time | accounts at this time. | | |
| | | represents increased risk for future | | | |
| | | repayment-- especially for consumers who do | | | |
| | | not have a long credit history. Therefore, | | | |
| | | only apply for needed credit and wait before | | | |
| | | you apply for more. The best way to improve | | | |
| | | your credit rating is by responsibly managing | | | |
| | | all of your accounts, including newly opened | | | |
| | | accounts, and not missing any payments. | | | |
| T1 | Too many accounts | Analysis repeatedly finds that carrying | Paying off your | n | y |
| | with balances | balances on too many credit accounts at once | debt on one or more | | |
| | | is a predictor of future repayment risk. (For | accounts can raise | | |
| | | credit cards, note that even if you pay off your | your score. | | |
| | | balance in full every month, your credit | | | |
| | | bureau report may show a balance on those | | | |
| | | cards. The total balance on your last | | | |
| | | statement is generally the amount that will | | | |
| | | show in your credit bureau report.) In order | | | |
| | | to improve your credit score, pay down the | | | |
| | | balances on your credit obligations. For | | | |
| | | revolving accounts, once they are paid down | | | |
| | | keep your balances low. Note that | | | |
| | | consolidating your debt by transferring | | | |
| | | balances from many accounts onto fewer | | | |
| | | accounts will not necessarily raise your score, | | | |
| | | because the same total amount is still owed. | | | |
| T2 | Too many | Your credit bureau report shows more | Avoid applying | n | n |
| | bank/national | bankcard accounts (Visa, MasterCard, | for credit you | | |
| | revolving | Discover, American Express, Diners Club, | don't need, or | | |
| | accounts | etc.) than other consumers with credit | don't intend to use. | | |
| | | histories of similar length. Research has | | | |
| | | shown that consumers with a relatively large | | | |
| | | number of bankcard accounts appearing on | | | |
| | | their credit bureau report represent higher risk | | | |
| | | than consumers with fewer bankcard | | | |
| | | accounts. Therefore, avoid applying for | | | |
| | | credit you don't need, or don't intend to use. | | | |
| | | (Note that closing your existing bankcard | | | |
| | | accounts will not make them disappear from | | | |
| | | your credit bureau report immediately; | | | |
| | | therefore, closing many or all of your | | | |
| | | bankcard accounts will probably not increase | | | |
| | | the score.) | | | |
| T3 | Too many consumer | Research shows that consumers with | Improve your | n | n |
| | finance company | consumer finance company loans appearing | credit score by | | |
| | accounts | on their credit report represent higher risk | managing all of | | |
| | | than those with no consumer finance loans. | your accounts | | |
| | | The best way to improve your credit rating is | responsibly, | | |
| | | by managing all of your accounts responsibly, | making all payments | | |
| | | not missing any payments, and not opening | on time, and avoid | | |
| | | new credit accounts you don't need. (Note | opening new credit | | |
| | | that after a consumer finance company | accounts you don't | | |
| | | account is closed, it will not disappear from | need. | | |
| | | the credit report immediately. Research | | | |
| | | shows that the presence of consumer finance | | | |
| | | company accounts on the credit report, | | | |
| | | whether open or closed, is still predictive of | | | |
| | | future repayment risk; thus they will still be | | | |
| | | considered by the score.) | | | |
| T5 | Too many | This reason appears when your credit bureau | To improve your | n | n |
| | inquiries last | report contains a large number of inquiries | score over time, | | |
| | 12 months | posted as a result of your applying for credit. | apply for credit | | |
| | | Research shows that consumers who are | only when you need it. | | |
| | | seeking several new credit accounts are | | | |
| | | riskier than consumers who are not seeking | | | |
| | | credit. Inquiries are the only information | | | |
| | | lenders have that indicates a consumer is | | | |
| | | actively seeking credit. There are different | | | |
| | | types of inquiries that reside on your credit | | | |
| | | bureau report. The score only considers those | | | |
| | | inquiries that were posted as a result of you | | | |
| | | applying for credit. Other types of inquiries, | | | |
| | | such as promotional inquiries (where a lender | | | |
| | | has pre-approved you for a credit offer) or | | | |
| | | consumer disclosure inquiries (where you | | | |
| | | have requested a copy of your own report) are | | | |
| | | not considered by the score.<br><br>The | | | |
| | | scores can identify “rate shopping” in the | | | |
| | | mortgage- and auto-lending environment, so | | | |
| | | that one credit search involving multiple | | | |
| | | inquiries is usually only counted as a single | | | |
| | | inquiry. <br><br>Typically, the presence of | | | |
| | | inquiries on your credit file has only a small | | | |
| | | impact on FICO scores, carrying much less | | | |
| | | importance than late payments, the amount | | | |
| | | you owe, and the length of time you have | | | |
| | | used credit. This reason rarely appears as a | | | |
| | | primary or secondary reason except in high- | | | |
| | | scoring files. As time passes the age of your | | | |
| | | most recent inquiry will increase, and your | | | |
| | | score will rise as a result, provided you do not | | | |
| | | apply for additional credit in the meantime. | | | |
| | | Typically inquiries are purged from the credit | | | |
| | | bureau files after two years.<br><br>A | | | |
| | | common misperception is that every single | | | |
| | | inquiry will drop your score a certain number | | | |
| | | of points. This is not true. The impact of | | | |
| | | inquiries on your score will vary - depending | | | |
| | | on your overall credit profile. Inquiries will | | | |
| | | usually have a larger impact on the score for | | | |
| | | consumers with limited credit history and on | | | |
| | | consumers with previous late payments. The | | | |
| | | most prudent action to raise your score over | | | |
| | | time is by applying for credit <i>only</i> | | | |
| | | when you need it. | | | |
| X0 | Payments due | The score measures the payments due on the | The best advice is | n | y |
| | on accounts | accounts (revolving and installment) that are | to pay off your | | |
| | | listed on your credit bureau report. (For | debts as quickly | | |
| | | credit cards, the minimum payment due on | as you can. | | |
| | | your last statement is generally the amount | Consolidating or | | |
| | | that will show in your credit bureau report. | moving your debt | | |
| | | Note that even if you pay off your credit cards | around from one | | |
| | | in full each and every month, your credit | account to another | | |
| | | bureau report may show the last billing | will not, however, | | |
| | | statement's minimum payment due on those | raise your score, | | |
| | | accounts.) Analytic studies have shown that | since the same | | |
| | | consumers with larger payments due on their | amount is still owed. | | |
| | | credit accounts have greater future repayment | | | |
| | | risk than those with lower payments due. | | | |
| | | You can improve your credit score by paying | | | |
| | | off your debts. Consolidating or moving your | | | |
| | | debt around from one account to another will | | | |
| | | not, however, raise your score, since the same | | | |
| | | amount is still owed. | | | |

Although the invention is described herein with reference to the preferred embodiment, one skilled in the art will readily appreciate that other applications may be substituted for those set forth herein without departing from the spirit and scope of the present invention. Accordingly, the invention should only be limited by the claims included below.

1. A method for explaining credit scores, comprising the steps of:
providing a Web site that contains informative resources, said Web site comprising any of for-pay services and extranet/Internet functions;
offering consumers access to information contained in said informative resources, both general and personal, about practices of collection, storing, reporting, and evaluating consumer credit data;
accepting consumer credit scores and reason codes from individual consumers or third parties, in interactive or batch modes; and
providing an explanation report to said individual consumers based upon the individual consumers' credit scores and reason codes.

2. A credit score explanation service, comprising:
a Web site that contains informative resources, said Web site comprising any of for-pay services and extranet/Internet functions;
said Web site offering any of consumers and said third parties access to information contained in said informative resources, both general and personal, about practices of collection, storing, reporting, and evaluating consumer credit data;
a display screen for accepting consumer credit scores and reason codes from any of individual consumers and said third parties; and
a report form generator for providing an explanation report to any of said individual consumers and said third parties based upon the individual consumers' credit score and reason codes.

3. The service of claim 2, wherein said service provides said individual consumers with on-demand receipt of credit scores.

4. The service of claim 2, wherein said service provides said individual consumers with any of registration in an opt-in/opt-out database, ability to initiate requests for credit investigations, ability to link to consumer credit counseling services should scores be low and represent high risk, and ability to access multiple reports from different repositories upon request.

5. The service of claim 2, wherein said service provides said individual consumers with their credit score and, if that score is sufficient to pass cutoff scores of specific brokers or lenders, a credit scoring developer passes said individual consumers' name, application, and credit score on to a lender for consideration.

6. The service of claim 2, wherein said service allows a credit scoring developer to build broker networks to refer credit applicants to lenders who would approve them.

7. The service of claim 2, wherein said service links credit applicants' email addresses to credit companies who wish to pre-approve and solicit said individual consumers based on their credit score.

8. The service of claim 2, wherein said service requires said credit score and a plurality of reason codes as input from said individual consumers.

9. The service of claim 2, wherein said service furnishes suggestions about how an individual consumer's credit standing can be improved over time.

10. The service of claim 2, further comprising:
a credit bureau risk score development database for developing benchmark characteristics, which may include any of score and other credit report attributes, to provide a national/regional basis upon which to compare individual score and attribute information.

11. The service of claim 2, further comprising:
a score, report, and explanation delivery service which comprises a bundled service offering providing a credit score, a credit report from which said score was calculated, and a score explanation service which identifies specific information on a consumer credit profile that gave rise to said score and that provides more precise actions for improving a credit risk profile and said credit score over time.

12. The service of claim 2, further comprising:
a score, report, and explanation delivery service from multiple credit reports which comprises a bundled service offering providing a credit score from all credit repositories, credit reports from all credit repositories, score explanations for all scores, and a discussion about why said scores are different across credit repositories and optionally sources of those differences.

13. The service of claim 2, wherein said service processes on-line requests to initiate investigations of credit report data elements.

14. The service of claim 2, wherein said service provides links to consumer credit counseling and/or to lenders.

15. The service of claim 2, wherein said service provides explanations and delivery of any of insurance bureau scores and other developer scores.

16. The service of claim 2, further comprising:
means for verifying an individual's identity prior to their request for a credit report and credit score to prevent fraudulent use of said service.

17. The service of claim 2, further comprising:
means for providing fast access to an individual consumer's credit file and score.

18. The service of claim 2, further comprising:
means for providing access to one or more consumer support representatives, to respond individually to consumer questions about their credit reports and credit scores.

19. The service of claim 2, further comprising:
means for delivering an actual credit report used to calculate said credit score for examining and explaining said credit score with greater precision.

20. A method for processing credit score explanation inputs and presentation of output in a credit score presentation service, comprising the steps of:
pre-processing user-supplied inputs;
verifying input data;
providing reason code pop-up menu for reason code search;
if there are errors or warnings, returning messages to a user along with a pre-filled form, containing said user's post-pre-processed responses;
if no warnings or errors are detected, presenting a checkout screen to said user;
if no errors are detected, but one or more warnings are produced, presenting said one or more warning messages on a data entry screen and offering said user a chance to revise entries; and
if said user re-submits said form and the same warnings are repeated, allow said user to bypass said warnings presenting a checkout screen to said user.

21. The method of claim 20, wherein said step of presenting a checkout screen to said user reiterates said user's inputs in a canonized, non-editable form, details charges for said service, displaying a name and partial account number of a credit card to be charged, and a submit button.

22. The method of claim 21, wherein when said user hits said submit button, said service passes all verified, canonized user input fields and calculated fields to explanation generation functions, which functions return a report in a browser window.

23. The method of claim 22, further comprising the step of:
presenting said user with reasonable next step options which may include any of requesting another report, closing an open display window, going to a score explainer home page, going to a score explainer help/FAQ page, and going to the credit scoring developer's home page.

24. The method of claim 20, wherein said user-supplied inputs comprise any of:
score;
bureau/score; and
one or more reason codes.

25. The method of claim 20, wherein said preprocessing step comprises the steps of:
stripping leading zeros and any blanks from said score;
stripping leading zeros and any blanks from said reason codes, wherein if arguments consists of digits, then canonizing said arguments to a two-byte, leading zero format; and wherein if said arguments are alphabetic, then stripping leading and trailing blanks to produce a single-byte character converted to uppercase; and
migrating, without permuting their order, non-blank responses upward and shifting blank values downward to the end of said array.

26. The method of claim 20, further comprising the step of applying the following validation rules:
HTTP_REFERRER (IP number or domain name of a page containing a form just submitted) must be a member of list Valid Hosts;
login state == verified user, they have logged in with username/password;
score [a] is non-blank, numeric, and within range low score to high score;
score is within typical range [WARNING];
bureau ID is non-blank, and one of three possible values (1, 2, or 3);
number of non-blank Reason Codes is 2, 3, or 4. [WARNING];
reason code 1 is blank, or a member of All Codes in Use;
reason code 2 is blank, or a member of possible codes 2-4;
reason code 3 is blank, or a member of possible codes 2-4;
reason code 4 is blank, or a member of possible codes 2-4;
no two non-blank reason codes are allowed to be identical; and
all reason codes must be two numeral digits, or be one-byte alphabetic codes.

27. The method of claim 26, further comprising, in event of validation failures, the step of returning the following messages as appropriate:
unauthorized access/access denied page;
please enter a score between Low Score and High Score;
[WARNING] “Most consumers score in the range Typical Range. The score you have entered is possible, but unusually high or low. Please confirm that you have not mistyped the score before requesting an explanation report.”;
Please select a bureau from the pull-down menu;
[WARNING] “You have entered fewer than two reason codes, which is exceptionally rare for all but the very highest scoring borrowers. Please ensure that you have entered all the reason codes that were returned with the score, in the proper order. The score explanation report will be inaccurate without all of the reason codes. See the FAQ for more information.”;
not a valid reason code;
reason codes may not be repeated; AND
reason codes should be either all numeric or all alphabetic.

28. The method of claim 21, further comprising the step of:
adding a transaction entry to a transactions table each time a user hits said submit button on said checkout screen.

29. The method of claim 28, wherein each transaction record comprises any of:
a transaction ID comprising a unique system-generated key;
a user session ID;
a date and time of transaction;
a user ID which may comprise a login name or unique user ID number;
a user's host domain name or IP address;
an HTTP_REFERRER which is a URL of a page containing a submitted form;
browser identification;
an access mode which may be one of {H,S}, where H=entered by hand, S=system-to-system);
a transaction status code;
a score;
a bureau ID; and
one or more reason codes.

30. A method for delivering a credit score and its associated explanation to a consumer, comprising the steps of:
providing a Web site that contains informative resources, said Web site comprising any of for-pay services and extranet/Internet functions;
providing a non-interactive hyperlink encoding of all necessary credit information, responsive to said consumer, for delivering said credit score and its associated explanation, said encoding accessing said Web Site and offering consumers access to information contained in said informative resources;
accepting said encoding from said consumer; and
delivering a credit score and its associated explanation to said consumer.
